(19) United States
(12) Patent Application Publication
(10) Pub. No.: US 2019/0352194 A1
(43) Pub. Date: Nov. 21, 2019

(54) WATER TREATMENT AND DESALINATION

(71) Applicant: Sylvan Source, Inc., San Carlos, CA (US)

(72) Inventors: Eugene Thiers, San Mateo, CA (US); Gary Lum, San Jose, CA (US); Jordi Perez Mariano, Redwood City, CA (US); Douglas Karlson, Palo Alto, CA (US); Laura Demmons, Redwood City, CA (US); Brian Bayley, Los Altos, CA (US)

(21) Appl. No.: 16/483,436

(22) PCT Filed: Feb. 7, 2018
(86) PCT No.: PCT/US2018/017170

§ 371 Date: Aug. 5, 2019

Related U.S. Application Data
(60) Provisional application No. 62/468,819, filed on Mar. 8, 2017.
(60) Provisional application No. 62/456,064, filed on Feb. 7, 2017.

(51) Int. Cl. C02F 1/04; C02F 1/20; C02F 1/28; C02F 1/22; C02F 1/26; C02F 1/44; C02F 1/52; B01D 1/06; B01D 1/04; B01D 1/00

(52) U.S. Cl. CPC C02F 1/045; C02F 2103/04; C02F 1/28; C02F 1/22; C02F 1/265; C02F 1/441; C02F 1/442; C02F 1/444; C02F 1/445; C02F 1/447; C02F 1/52; B01D 1/06; B01D 1/04; B01D 1/0058; C02F 2303/22; C02F 1/20

(57) ABSTRACT

Embodiments of the invention provide systems and methods for water treatment and/or desalination.

### CROSS-REFERENCE TO RELATED APPLICATION

This application claims priority to U.S. Provisional Patent Application No. 62/456,064, filed Feb. 7. 2017, and U S. Provisional Patent Application 62/468,819, filed Mar. 8, 2017, and the entire disclosures of which are hereby incorporated by reference herein.

### BACKGROUND

Water purification technology is rapidly becoming an essential aspect of modern life as conventional water resources become increasingly scarce, municipal distribution systems for potable water deteriorate with age, and increased water usage depletes wells and reservoirs, causing saline water contamination. Additionally, further contamination of water sources is occurring from a variety of activities, which include, for example, intensive agriculture, gasoline additives, and heavy toxic metals. These issues are leading to increasing and objectionable levels of germs, bacteria, salts, MTBE, chlorates, perchlorates, arsenic, mercury, and even the chemicals used to disinfect potable water, in the water system.

Conventional desalination and water treatment technologies, such as, for example, filtration systems such as reverse osmosis (RO), and forward osmosis (FO), and thermal distillation systems such as multiple-effect distillation (MED), multiple-stage flash distillation (MSF), membrane distillation, or vapor compression distillation (VC), are rarely able to handle the diverse range of water contaminants found in saline and other various industrial and municipal environments. Additionally, even though they are commercially available, they often require multiple treatment stages or combination of various technologies to achieve acceptable water quality. Accordingly, a sophisticated distillation system that is continuous in operation, that resists corrosion, that is compact, that can recover a major fraction of the input feedwater, that is relatively inexpensive, and that requires low-maintenance would be the best long-term option to resolve increasing water contamination problems and water scarcity, worldwide. There is a further need for industrial and municipal desalination and water treatment systems with the aforementioned features that can also produce a highly concentrated waste brine/concentrate/solution that crystallizes into a slurry or a solid salt cake for disposal or for recovery of the solids.

### SUMMARY

The present invention relates to the use of heat pipes, or other similar phase change devices such as thermosiphons, heat plates, loop heat pipes, pulsed heat pipes, etc., or a combination of such devices, as the basic elements of heat transfer in distillation, water purification, feedwater concentration and steam generation systems. When referring to the system in this specification, the term “distillation system” is used and can include all of the aforementioned types of systems.

Embodiments of the present invention cost effectively produce water that is pure enough to be used for significantly more beneficial re-use applications (e.g. high pressure boilers, agriculture, etc.) than many conventional technologies. While the capacity of any system to remove contaminants from inlet feedwater is to some extent a function of the total impurity levels in the inlet feedwater, systems of the invention are particularly well suited to remove a plurality of different contaminants of widely different types from a single feed stream, producing water that is comparable to distilled water from conventional technologies and is in some cases comparable to ultrapure water.

Embodiments of the present invention can produce concentrated brines or valuable concentrated chemical solutions, or both for use in food, commercial, industrial and other applications.

Embodiments of the present invention can also produce concentrates that can be recycled or disposed of much more easily and less expensively than the more dilute solutions from which they come.

Embodiments of the present invention can produce crystallized solids either for disposal or for recovery in cases where the solids have value.

Embodiments of the present invention can produce steam for a wide range of industrial and commercial applications, such as heating, other HVAC, food processing and canning, cleaning, electricity generation, paper manufacturing, enhanced oil recovery, beer production, brick production, reagent production for chemical industry, and or the like.

The energy source for the systems of the invention can be any available energy source or combination of energy sources including but not limited to any one of, or any combination of steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes, alcohol burners, incinerators, hydrocarbon burners, and waste heat from industrial or other processes.

The feed solution coming into the embodiments of the present invention can be an aqueous solution with contaminants to be purified. It can also be an aqueous solution to be concentrated where the final product of the system is the final concentrate instead of, or in addition to, the purified water. The feed solution can also be non-aqueous. The term feedwater in this disclosure can include all of these cases.

In water purification applications, the system can be capable of removing, from a contaminated water sample, one or a plurality of contaminant types including microbiological contaminants, radiological contaminants, metals, salts, volatile organics, suspended solids, non-volatile organics, and/or the like.

Embodiments of the invention relate to a water purification and/or desalination system including a plurality of fluid-process components, heat-transfer components, in at least one stage, and a control system. In some embodiments, the fluid-process components of the at least one stage can define a fluid-process pathway of fluid flow from a water inlet, or inlets, to at least one outlet for at least one product and at least one product for at least one waste. In some embodiments, each component along the fluid-process pathway can be in fluid communication with at least one adjacent fluid-process component, and the fluid-process components can include, in order of fluid flow: a water inlet, an evaporation chamber, a purified water condenser chamber, and said outlets. In operation, the heat transfer components can provide distillation energy. The heat transfer components can include at least one of heat pipes, heat plates, heat spreaders, loop heat pipes, or pulsed heat pipes, or a combination of these devices, and wherein the heat transfer components define a heat recovery mechanism. The system can further include at least one additional feature selected from (a) a process variation; (b) a hardware configuration in a stage; (c) an adaptation for scale prevention, cleaning or maintenance, (d) an adjunct purification scheme, and (e) any combination thereof.

In sonic embodiments, the process variation can be selected from the group of: application of vacuum, steam recompression, product water feedback, single stage core, vapor compression evaporation, and/or any combination thereof.

In some embodiments, the hardware configuration can be in at least one stage In some embodiments, the configuration can be selected from the group consisting of: water spray, loop heat pipes, horizontal orientation, orientation at an angle between horizontal and vertical or along an axis that is distinct from horizontal and vertical axes, heat pipes of unequal heights, heat pipes of unequal placement in at least one chamber of the stage, steam jet variations, heat pipe mounting scheme, heat pipes configured as plates, heat plates as chamber walls, and any combination thereof.

In some embodiments, the adaptation for scale prevention, cleaning, or maintenance can be selected from the group consisting of softening by ultrafiltration or nanofiltration, softening by ion exchange, softening by precipitation, removal from service of one stage, chemical treatment, double degassers, thermal shock, robot cleaning, coatings, electrical bias on heat pipes, and any combination thereof.

In some embodiments, the adjunct purification scheme can be selected from the group consisting of multiple-effect distillation (MED), multiple-stage flash distillation (MSP), freezing, membrane distillation, reverse osmosis, forward osmosis, and any combination thereof.

In some embodiments, the system can comprise at least two additional features. In some embodiments, the at least two additional features can be selected from the same group. In some embodiments, the at least two additional features can be selected from different groups.

In some embodiments, the system can include at least one additional feature from each group, for a system that is to be used in purifying water, operation of the system can be such that water purified in the system has levels of all contaminant types below the levels shown in the MCL Column of Table 1, when the contaminated water has levels of the contaminant types that are up to 25 times greater, or more than the levels shown in the MCL Column of Table 1. However, when the system is used with industrial waste streams or to desalinate seawater, for example, the feedwater contaminant levels can be significantly higher than those shown in Table 1, while the purified water contaminant levels after processing by the system can be similar to those shown.

While the capacity of any system to remove contaminants from inlet water is to some extent a function of the total impurity levels in the inlet water, systems of the invention can be particularly well suited to remove a plurality of different contaminants, of widely different types, from a single feed stream, producing water that is comparable to distilled water from conventional technologies and is in some cases comparable to ultrapure water. It should be noted that the “Challenge Water” column in Table 1 contains concentration levels for contaminants in water used in EPA tests. Embodiments of water purification systems of the invention typically can remove much greater amounts of initial contaminants than the amounts listed in this column Contaminant levels corresponding to those mentioned in the “Challenge Water” column are likewise well within the scope of the capabilities of embodiments of the invention.

TABLE 1
EPA TEST WATER

| | | | | Challenge |
|---|---|---|---|---|
| | Units | Protocol | MCL | Water |
| Metals | | | | |
| Aluminum | ppm | | 0.200 | 0.600 |
| Antimony | ppm | | 0.006 | 0.100 |
| Arsenic | ppm | | 0.010 | 0.100 |
| Beryllium | ppm | | 0.004 | 0.100 |
| Boron | ppb | | | 20.000 |
| Chromium | ppm | | 0.100 | 0.100 |
| Copper | ppm | | 1.300 | 1.300 |
| Iron | ppm | | 0.300 | 8.000 |
| Lead | ppm | | 0.015 | 0.100 |
| Manganese | ppm | | 0.050 | 1.000 |
| Mercury | ppm | | 0.002 | 0.100 |
| Molybdenum | ppm | | | 0.010 |
| Nickel | ppm | | | 0.020 |
| Silver | ppm | | 0.100 | 0.200 |
| Thallium | ppm | | 0.002 | 0.010 |
| Vanadium | ppm | | | 0.100 |
| Zinc | ppm | | 5.000 | 5.000 |
| Subtotal of entire mix | | | | 36.840 |
| Inorganic salts | | | | |
| Bromide | ppm | | | 0.5 |
| Chloride | ppm | | 250 | 350 |
| Cyanide | ppm | | 0.2 | 0.4 |
| Fluoride | ppm | | 4 | 8 |
| Nitrate, as N03 | ppm | | 10 | 90 |
| Nitrite as N2 | ppm | | 1 | 2 |
| Sulfate | ppm | | 250 | 350 |
| Subtotal of entire mix | | | | 800.9 |
| Fourth Group: 2 Highly | | | | |
| volatile VOCs + | | | | |
| non-volatiles | | | | |
| Heptachlor | ppm | EPA525.2 | 0.0004 | 0.04 |
| Tetrachloroethylene-PCE | ppm | EPA524.2 | 0.00006 | 0.02 |
| Epichlorohydrin | ppm | | 0.07 | 0.2 |
| Pentachlorophenol | ppm | EPA515.4 | 0.001 | 0.1 |
| Subtotal of entire mix | | | | 0.36 |
| Fifth Group: 2 Highly | | | | |
| volatile VOCs + | | | | |
| 2 non-volatiles | Units | | | |
| Carbon tetrachloride | ppm | EPA524.2 | 0.005 | 0.01 |
| m,p-Xylenes | ppm | EPA524.2 | 10 | 120 |
| Di(2-ethylhexyl) adipate | ppm | EPA525.2 | 0.4 | 0.8 |
| Trichloro acetic acid | ppm | SM6251B | 0.06 | 0.12 |
| Subtotal of entire mix | | | | 21.29 |
| Sixth Group: 3 Highly | | | | |
| volatile VOCs + | | | | |
| 3 non-volatiles | | | | |
| 1,1-dichloroethylene | ppm | | 0.007 | 0.15 |
| Ethylbenzene | ppm | EP524.2 | 0.7 | 1.5 |
| Aldrin | ppm | EPA505 | 0.005 | 0.1 |
| Dalapon (2,2,- | ppm | EPA515.4 | 0.2 | 0.4 |
| Dichloropropionic acid) | | | | |
| Carbofuran (Furadan) | ppm | EPA531.2 | 0.04 | 0.1 |
| 2,4,5-TP (silvex) | ppm | EPA515.4 | 0.05 | 0.1 |
| Subtotal of entire mix | | | | 2.35 |
| Seventh Group: 3 Highly | | | | |
| volatile VOCs + | | | | |
| 3 non-volatiles | | | | |
| Trichloroethylene-TCE | ppm | EPA524.2 | 0.005 | 0.1 |
| Toluene | ppm | EPA524.2 | 1 | 2 |
| 1,2,4 Trichlorobenzene | ppm | EPA524.2 | 0.07 | 0.15 |
| 2,4-D | ppm | EPA515.4 | 0.07 | 0.15 |
| Alachlor (Alanex) | ppm | 525.2 | 0.002 | 0.1 |
| Simazine | ppm | EPA525.2 | 0.004 | 0.1 |
| Subtotal of entire mix | | | | 2.6 |
| Eighth Group: 3 Highly | | | | |
| volatile VOCs + | | | | |
| 3 non-volatiles | | | | |
| Vinylchloride (chloroethene) | ppm | EPA524.2 | 0.002 | 0.1 |
| 1,2-dichlorobenzene | ppm | EPA524.2 | 0.6 | 1 |
| (1,2 DCB) | | | | |
| Chlorobenzene | ppm | EPA524.2 | 0.1 | 0.2 |
| Atrazine | ppm | 525.2 | 0.003 | 0.1 |
| Endothal | ppm | EPA548.1 | 0.01 | 0.2 |
| Oxamyl (Vydate) | ppm | EPA531.2 | 0.2 | 0.4 |
| Subtotal of entire mix | | | | 2 |
| Ninth Group: 3 Highly | | | | |
| volatile VOCs + | | | | |
| 3 non-volatiles | | | | |
| Styrene | ppm | EPA524.2 | 0.1 | 1 |
| Benzene | ppm | EPA524.2 | 0.005 | 0.2 |
| Methoxychlor | ppm | 525.2/505 | 0.04 | 0.1 |
| Glyphosate | ppm | EPA547 | 0.7 | 1.5 |
| Pichloram | ppm | EPA515.4 | 0.5 | 1 |
| 1,3-dichlorobenzene | ppm | EPA524.2 | 0.075 | 0.15 |
| (1,3 DCB) | | | | |
| Subtotal of entire mix | | | | 3.95 |
| Tenth Group: 3 Highly | | | | |
| volatile VOCs + | | | | |
| 3 non-volatiles | | | | |
| 1,2-dichloropropane (DCP) | ppm | EPA524.2 | 0.005 | 0.1 |
| Chloroform | ppm | EPA524.2 | 80 | 0.1 |
| Bromomethane (methyl | ppm | EPA524.2 | | 0.1 |
| bromide) | | | | |
| PCB1242 Arochlor | ppb | EPA 505 | 0.5 | 1 |
| Chlordane | ppm | 525.2/505 | 0.002 | 0.2 |
| MEK—Methylehtylketone | ppb | EPA524.2 | | 0.2 |
| (2-butanone) | | | | |
| Subtotal of entire mix | | | | 1.7 |
| Eleventh Group: | | | | |
| 4 volatile VOCs + | | | | |
| 5 non-volatile PCBs | | | | |
| 2,4-DDE (dichlorodiphenyl | | | | |
| dichloroethylene) | ppm | EPA525.2 | | 0.1 |
| Bromodichloromethane | ppb | EPA524.2 | 80 | 0.1 |
| 1,1,1-Trichloroethane (TCA) | ppm | EPA524.2 | 0.2 | 0.4 |
| Bromoform | ppm | EPA524.2 | 80 | 0.1 |
| PCB 1221 Arochlor | ppm | EPA 505 | 0.5 | 0.05 |
| PCB1260 Arochlor | ppm | EPA 505 | 0.5 | 0.05 |
| PCB 1232 Arochlor | ppm | EPA 505 | 0.5 | 0.05 |
| PCB 1254 Arochlor | ppm | EPA 505 | 0.5 | 0.05 |
| PCB 1016 Arochlor | ppm | EPA 505 | 0.5 | 0.05 |
| Subtotal of entire mix | | | | 0.95 |
| Group No 12: 5 volatile | | | | |
| VOCs + 5 non-volatile | | | | |
| PCBs dichloromethane | | | | |
| (DCM) | | | | |
| Methylenechloride | ppm | EPA524.2 | 0.005 | 0.1 |
| 1,2-dichloroethane | ppm | | 0.005 | 0.1 |
| Lindane (gamma BHC) | ppm | EPA525.2 | 0.0002 | 0.05 |
| Benzo(a) pyrene | ppm | EPA525.2 | 0.0002 | 0.05 |
| Endrin | ppm | 525.2/505 | 0.002 | 0.05 |
| 1,1,2-Trichloroethane (TCA) | ppm | EPA524.2 | 0.005 | 0.05 |
| MTBE | ppm | EPA524.2 | | 0.05 |
| Ethylene dibromide--EDB | ppm | EPA504.1 | 0.00005 | 0.05 |
| Dinoseb | ppm | 515.4 | 0.007 | 0.05 |
| Di(2-ethylhexyl) phthalate | ppm | EPA525.2 | 0.006 | 0.05 |
| (DEHP) | | | | |
| Subtotal of entire mix | | | | 0.5 |
| Group No 13: Balance of | | | | |
| 6 VOCs | | | | |
| Chloromethane (methyl | ppm | EPA524.2 | | 0.1 |
| chloride) | | | | |
| Toxaphene | ppm | EPA 505 | 0.003 | 0.1 |
| trans-1,2-dichloroethylene | ppm | EPA524.2 | 0.1 | 0.2 |
| Dibromochloromethane | ppm | EPA524.2 | 80 | 0.05 |
| cis-1,2-dichloroethylene | ppm | EPA524.2 | 0.07 | 0.05 |
| 1,2-Dibromo-3-Chloro | ppm | 504.1 | 0.0002 | 0.05 |
| propane | | | | |

Determination of water purity and/or efficiency of purification performance can be based upon the ability of a system to remove a broad range of contaminants. For many biological contaminants, the objective is to remove substantially all live contaminants Table 2 lists additional common contaminants of source water and standard protocols for testing levels of the contaminants. The protocols listed in Tables 1 and 2, are publicly available at the United States Environmental Protection Agency website (http://www.epa.gov/safewater/mcl.html #nicls) for common water contaminants; Methods for the Determination of Organic Compounds in Drinking Water, EPA/600/4-88-039, December 1988, Revised, July 1991. Methods 547, 550 and 550.1 are in Methods for the Determination of Organic Compounds in Drinking Water-Supplement I. EPA/600-4-90-020, July 1990 Methods 548.1, 549.1, 552.1 and 555 are in Methods for the Determination of Organic Compounds in Drinking Water Supplement II, HPA/600/R-92-129, August 1992 Methods 502.2, 504.1, 505, 506, 507, 508, 508.1, 515.2, 524.2 525.2, 531.1, 551.1 and 552.2 are in Methods for the Determination of Organic Compounds in Drinking Water—Supplement III. EPA/600/R-95-131. August 1995. Method 1613 is titled “Tetra-through OctaChlorinated Dioxins and Furans by Isotope—Dilution HRGC/HRMS”, EPA/821-B-94-005, October 1994 Each of the foregoing is incorporated herein by reference in its entirety.

TABLE 2
ADDITIONAL COMMON CONTAMINANTS

| | Protocol |
|---|---|
| 1. Metals & Inorganics | |
| Asbestos | EPA 100.2 |
| Free Cyanide | SM 4500CN-F |
| Metals - Al, Sb, Be, B, Fe, Mn, Mo, Ni, Ag, Tl, V, Zn | EPA 200.7/200.8 |
| Anions - N0₃- N, NO₂- N, Cl, SO_{4,} | EPA 300.0A |
| Total Nitrate/Nitrite | |
| Bromide | EPA 300.0/300.1 |
| Turbidity | EPA 180.1 |
| 2. Organics | |
| Volatile Organics - VOASDWA list + Nitrozbenzene | EPA 524.2 |
| EDB & DBCP | EPA 504.1 |
| Semivolatile Organics - ML525 list + EPTC | EPA 525.2 |
| Pesticides and PCBs | EPA 505 |
| Herbicides - Regulated/Unregulated compounds | EPA 515.4 |
| Carbamates | EPA 531.2 |
| Glyphosate | EPA 547 |
| Diquat | EPA 549.2 |
| Dioxin | EPA 1613b |
| 1,4-Dioxane | EPA 8270m |
| NDMA - 2 ppt MRL | EPA 1625 |
| 3. Radiologicals | |
| Gross Alpha & Beta | EPA 900.0 |
| Radium 226 | EPA 903.1 |
| Uranium | EPA 200.8 |
| 4. Disinfection By-Products | |
| THMs/HANs/HKs | EPA 551.1 |
| HAAs | EPA 6251B |
| Aldehydes | SM 6252m |
| Chloral Hydrate | EPA 551.1 |
| Chloramines | SM 4500 |
| Cyanogen Chloride | EPA 524.2m |

Embodiments of the system can produce a volume of purified water which can he between about 10% and about 99% of a volume of feedwater.

Where the system is used to concentrate feedwater streams, the feedwater can be concentrated from less than a percent concentration to 50% or more concentration depending on the system operating configuration and the solute or solids species involved.

The system can be configured in a vertical stack arrangement, a lateral arrangement, a combination of vertically stacked and lateral arrangements, or a horizontal arrangement of evaporation chambers, condenser chambers, and preheaters all in fixed or mobile installations of any system size from less than 5 gallons per day to several hundred million gallons per day, or more of feedwater processed.

### Component Parts of a System

By using heat pipes or other phase change thermal transfer elements (e.g. thermosiphons, heat plates, loop heat pipes, etc.), embodiments of the present invention provide water purification systems and feedwater concentration systems that include combinations of some or all of the components selected from the list of: a pretreatment system, one or multiple degassers, one or multiple preheaters, one or multiple evaporation chambers, one or multiple demisters, one or multiple product condenser chambers, one or multiple energy input vessels, one or multiple inlets and outlets for liquids, solids and gas streams, a control system, one or more heat recovery units, and one or multiple sources of energy. The system can also include one or multiple heat exchangers for capturing and reusing the heat contained in various internal concentrate streams, steam flows, and purified water streams. The system can also include one or multiple sources of cooling water and heat exchange systems for supplying that cooling water to some or all of the heated concentrate, steam flows, or purified water streams.

The objective of a pretreatment system can be to reduce scale-forming compounds to a level at which they will not interfere with the system's performance by forming scale in subsequent treatment and desalination equipment, or to reduce the effects of the scale forming compounds during desalination. Water hardness is normally defined as the amount of calcium (Ca++), magnesium (Mg++), and other divalent ions that are present in the water and is normally expressed m parts per million (ppm) of these ions or their equivalent as calcium carbonate (CaC03). In certain environments, scale forms because water dissolves carbon dioxide from the atmosphere, and such carbon dioxide provides carbonate ions that combine to form both calcium and magnesium carbonates. Upon heating, the solubility of calcium and magnesium carbonates markedly decreases, and they precipitate as scale. In reality, scale comprises any chemical compound that precipitates from solution. Thus, iron phosphates and calcium sulfate (gypsum) also produce scale. The following table (Table 3) lists a number of chemical compounds that exhibit low solubility in water and can thus form scale. In this context, low solubility is defined by the solubility product, that is, by the product of the ionic concentration of cations and anions of a particular chemical; solubility is usually expressed in moles per liter (mol/L)

TABLE 3
SOLUBILITY PRODUCTS OF VARIOUS COMPOUNDS

| Compound | Formula | Kₛₚ (25° C.) |
|---|---|---|
| Aluminum hydroxide | Al(OH)₃ | 3 × 10⁻³⁴ |
| Aluminum phosphate | AlPO₄ | 9.84 × 10⁻²¹ |
| Barium bromate | Ba(BrO₃)₂ | 2.43 × 10⁻⁴ |
| Barium carbonate | BaCO₃ | 2.58 × 10⁻⁹ |
| Barium chromate | BaCrO₄ | 1.17 × 10⁻¹⁰ |
| Barium fluoride | BaF₂ | 1.84 × 10⁻⁷ |
| Barium hydroxide octahydrate | Ba(OH)₂ × 8H₂O | 2.55 × 10⁻⁴ |
| Barium iodate | Ba(IO₃)₂ | 4.01 × 10⁻⁹ |
| Barium iodate monohydrate | Ba(IO₃)₂ × H₂O | 1.67 × 10⁻⁹ |
| Barium molybdate | BaMoO₄ | 3.54 × 10⁻⁸ |
| Barium nitrate | Ba(NO₃)₂ | 4.64 × 10⁻³ |
| Barium selenate | BaSeO₄ | 3.40 × 10⁻⁸ |
| Barium sulfate | BaSO₄ | 1.08 × 10⁻¹⁰ |
| Barium sulfite | BaSO₃ | 5.0 × 10⁻¹⁰ |
| Beryllium hydroxide | Be(OH)₂ | 6.92 × 10⁻²² |
| Bismuth arsenate | BiAsO₄ | 4.43 × 10⁻¹⁰ |
| Bismuth iodide | BiI | 7.71 × 10⁻¹⁹ |
| Cadmium arsenate | Cd₃(AsO₄)₂ | 2.2 × 10⁻³³ |
| Cadmium carbonate | CdCO₃ | 1.0 × 10⁻¹² |
| Cadmium fluoride | CdF₂ | 6.44 × 10⁻³ |
| Cadmium hydroxide | Cd(OH)₂ | 7.2 × 10⁻¹⁵ |
| Cadmium iodate | Cd(IO₃)₂ | 2.5 × 10⁻⁸ |
| Cadmium oxalate trihydrate | CdC₂O₄ × 3H₂O | 1.42 × 10⁻⁸ |
| Cadmium phosphate | Cd₃(PO₄)₂ | 2.53 × 10⁻³³ |
| Cadmium sulfide | CdS | 1 × 10⁻²⁷ |
| Cesium perchlorate | CsC10₄ | 3.95 × 10⁻³ |
| Cesium periodate | CsI0₄ | 5.16 × 10⁻⁶ |
| Calcium carbonate (calcite) | CaC0₃ | 3.36 × 10⁻ [symbol] |
| Calcium carbonate (aragonite) | CaC0₃ | 6.0 × 10⁻ [symbol] |
| Calcium fluoride | CaF₂ | 3.45 × 10⁻¹¹ |
| Calcium hydroxide | Ca(OH)₂ | 5.02 × 10⁻⁶ |
| Calcium iodate | Ca(I0₃)₂ | 6.47 × 10⁻⁶ |
| Calcium iodate hexahydrate | Ca(I0₃)₂ × 6H₂0 | 7.10 × 10⁻ [symbol] |
| Calcium molybdate | CaMoO | 1.46 × 10⁻⁸ |
| Calcium oxalate monohydrate | CaC₂0₄ × H₂0 | 2.32 × 10⁻ [symbol] |
| Calcium phosphate | Ca₃(P0₄)₂ | 2.07 × 10⁻³³ |
| Calcium sulfate | CaS0₄ | 4.93 × 10⁻ [symbol] |
| Calcium sulfate dihydrate | CaS0₄ × 2H₂0 | 3.14 × 10⁻⁵ |
| Calcium sulfate hemihydrate | CaS0₄ × 0.5H₂O | 3.1 × 10⁻ [symbol] |
| Cobalt(II) arsenate | Co₃(As0₄)₂ | 6.80 × 10⁻² [symbol] |
| Cobalt(II) carbonate | CoC0₃ | 1.0 × 10⁻¹⁰ |
| Cobalt(II) hydroxide (blue) | Co(OH)₂ | 5.92 × 10⁻ [symbol] |
| Cobalt(II) iodate dihydrate | Co(I0₃)₂ × 2H₂0 | 1.21 × 10⁻² |
| Cobalt(II) phosphate | Co₃(P0₄)₂ | 2.05 × 10⁻³ [symbol] |
| Cobalt(II) sulfide (alpha) | CoS | 5 × 10⁻²² |
| Cobalt(II) sulfide (beta) | CoS | 3 × 10⁻²⁶ |
| Copper(I) bromide | CuBr | 6.27 × 10⁻ [symbol] |
| Copper(I) chloride | CuCl | 1.72 × 10⁻ [symbol] |
| Copper(I) cyanide | CuCN | 3.47 × 10⁻²⁰ |
| Copper(I) hydroxide | Cu₂0 | 2 × 10⁻¹⁵ |
| Copper(I) iodide | Cul | 1.27 × 10⁻ [symbol] 2 |
| Copper(I) thiocyanate | CuSCN | 1.77 × 10⁻¹³ |
| Copper(II) arsenate | Cu₃(As0₄)₂ | 7.95 × 10⁻³⁶ |
| Copper(II) hydroxide | Cu(OH)₂ | 4.8 × 10⁻²⁰ |
| Copper(II) iodate monohydrate | Cu(I0₃)₂ × H₂0 | 6.94 × 10⁻⁸ |
| Copper(II) oxalate | CuC₂0₄ | 4.43 × 10⁻¹⁰ |
| Copper(II) phosphate | Cu₃(P0₄)₂ | 1.40 × 10⁻³⁷ |
| Copper(II) sulfide | CuS | 8 × 10⁻³⁷ |
| Europium(III) hydroxide | Eu(OH)₃ | 9.38 × 10⁻² [symbol] |
| Gallium(III) hydroxide | Ga(OH)₃ | 7.28 × 10⁻³⁶ |
| Iron(II) carbonate | FeC0₃ | 3.13 × 10⁻¹¹ |
| Iron(II) fluoride | FeF₂ | 2.36 × 10⁻⁶ |
| Iron(II) hydroxide | Fe(OH)₂ | 4.87 × 10⁻ [symbol] |
| Iron(II) sulfide | FeS | 8 × 10⁻¹ [symbol] |
| Iron(III) hydroxide | Fe(OH)₃ | 2.79 × 10⁻³ [symbol] |
| Iron(III) phosphate dihydrate | FeP0₄ × 2H₂0 | 9.91 × 10⁻¹⁶ |
| Lanthanum iodate | La(I0₃)₃ | 7.50 × 10⁻ [symbol] 2 |
| Lead(II) bromide | PbBr₂ | 6.60 × 10⁻⁶ |
| Lead(II) carbonate | PbC0₃ | 7.40 × 10⁻ [symbol] |
| Lead(II) chloride | PbCl₂ | 1.70 × 10⁻ [symbol] |
| Lead(II) chromate | PbCr0₄ | 3 × 10⁻¹³ |
| Lead(II) fluoride | PbF₂ | 3.3 × 10⁻⁸ |
| Lead(II) hydroxide | Pb(OH)₂ | 1.43 × 10⁻²⁰ |
| Lead(II) iodate | Pb(I0₃)₂ | 3.69 × 10⁻¹³ |
| Lead(II) iodide | Pbl₂ | 9.8 × 10⁻ [symbol] |
| Lead(II) oxalate | PbC₂0₄ | 8.5 × 10⁻ [symbol] |
| Lead(II) selenate | PbSe0₄ | 1.37 × 10⁻ [symbol] |
| Lead(II) sulfate | PbS0₄ | 2.53 × 10⁻⁸ |
| Lead(II) sulfide | PbS | 3 × 10⁻²⁸ |
| Lithium carbonate | Li₂C0₃ | 8.15 × 10⁻* |
| Lithium fluoride | LiF | 1.84 × 10⁻³ |
| Lithium phosphate | L13PO4 | 2.37 × 10⁻* |
| Magnesium ammonium phosphate | MgNH₄P0₄ | 3 × 10⁻¹³ |
| Magnesium carbonate | MgC0₃ | 6.82 × 10⁻⁶ |
| Magnesium carbonate trihydrate | MgC0₃ × 3H₂0 | 2.38 × 10⁻⁶ |
| Magnesium carbonate pentahydrate | MgC0₃ × 5H₂0 | 3.79 × 10⁻⁶ |
| Magnesium fluoride | MgF₂ | 5.16 × 10⁻¹¹ |
| Magnesium hydroxide | Mg(OH)₂ | 5.61 × 10⁻¹² |
| Magnesium oxalate dihydrate | MgC₂0₄ × 2H₂0 | 4.83 × 10⁻⁶ |
| Magnesium phosphate | Mg₃(P0₄)₂ | 1.04 × 10−2* |
| Manganese(II) carbonate | MnC0₃ | 2.24 × 10⁻¹¹ |
| Manganese(II) iodate | Mn(I0₃)₂ | 4.37 × 10⁻ [symbol] |
| Manganese(II) hydroxide | Mn(OH)₂ | 2 × 10⁻¹³ |
| Manganese(II) oxalate dihydrate | MnC₂0₄ × 2H₂0 | 1.70 × 10⁻ [symbol] |
| Manganese(II) sulfide (pink) | MnS | 3 × 10⁻¹¹ |
| Manganese(II) sulfide (green) | MnS | 3 × 10⁻¹⁴ |
| Mercury(I) bromide | Hg₂Br₂ | 6.40 × 10⁻²³ |
| Mercury(I) carbonate | Hg₂C0₃ | 3.6 × 10⁻ [symbol] |
| Mercury(I) chloride | Hg₂Cl₂ | 1.43 × 10⁻¹⁸ |
| Mercury(I) fluoride | Hg₂F₂ | 3.10 × 10⁻⁶ |
| Mercury(I) iodide | Hg₂I₂ | 5.2 × 10⁻ [symbol] |
| Mercury(I) oxalate | Hg₂C₂0₄ | 1.75 × 10⁻¹³ |
| Mercury(I) sulfate | Hg₂S0₄ | 6.5 × 10⁻ [symbol] |
| Mercury(I) thiocyanate | Hg₂(SCN)₂ | 3.2 × 10⁻²⁰ |
| Mercury(II) bromide | HgBr₂ | 6.2 × 10⁻²⁰ |
| Mercury(II) hydroxide | HgO | 3.6 × 10⁻²⁶ |
| Mercury(II) iodide | Hgl₂ | 2.9 × 10⁻ [symbol] |
| Mercury(II) sulfide (black) | HgS | 2 × 10⁻⁵³ |
| Mercury(II) sulfide (red) | HgS | 2 × 10− [symbol] |
| Neodymium carbonate | Nd₂(C0₃)₃ | 1.08 × 10⁻³³ |
| Nickel(II) carbonate | NiC0₃ | 1.42 × 10⁻ [symbol] |
| Nickel(II) hydroxide | Ni(OH)₂ | 5.48 × 10⁻¹⁶ |
| Nickel(II) iodate | Ni(I0₃)₂ | 4.71 × 10⁻ [symbol] |
| Nickel(II) phosphate | Ni₃(P0₄)₂ | 4.74 × 10⁻³² |
| Nickel(II) sulfide (alpha) | NiS | 4 × 10⁻²⁰ |
| Nickel(II) sulfide (beta) | NiS | 1.3 × 10⁻ [symbol] |
| Palladium(II) thiocyanate | Pd(SCN)₂ | 4.39 × 10⁻²³ |
| Potassium hexachloroplatinate | K₂PtCl₆ | 7.48 × 10⁻⁶ |
| Potassium perchlorate | KCIO4 | 1.05 × 10⁻² |
| Potassium periodate | KIO4 | 3.71 × 10⁻⁴ |
| Praseodymium hydroxide | Pr(OH)₃ | 3.39 × 10⁻²⁴ |
| Radium iodate | Ra(I0₃)₂ | 1.16 × 10⁻ [symbol] |
| Radium sulfate | RaS0₄ | 3.66 × 10⁻¹¹ |
| Rubidium perchlorate | RuC10₄ | 3.00 × 10⁻³ |
| Scandium fluoride | ScF₃ | 5.81 × 10⁻²⁴ |
| Scandium hydroxide | Sc(OH)₃ | 2.22 × 10⁻³¹ |
| Silver(I) acetate | AgCH₃COO | 1.94 × 10⁻³ |
| Silver(I) arsenate | Ag₃As0₄ | 1.03 × 10⁻²² |
| Silver(I) bromate | AgBr0₃ | 5.38 × 10⁻⁵ |
| Silver(I) bromide | AgBr | 5.35 × 10⁻¹³ |
| Silver(I) carbonate | Ag₂C0₃ | 8.46 × 10⁻¹² |
| Silver(I) chloride | AgCl | 1.77 × 10⁻¹⁰ |
| Silver(I) chromate | Ag₂Cr0₄ | 1.12 × 10⁻¹² |
| Silver(I) cyanide | AgCN | 5.97 × 10⁻¹⁷ |
| Silver(I) iodate | AgI0₃ | 3.17 × 10⁻⁸ |
| Silver(I) iodide | Agl | 8.52 × 10−¹⁷ |
| Silver(I) oxalate | Ag₂C₂0₄ | 5.40 × 10⁻¹² |
| Silver(I) phosphate | Ag₃P0₄ | 8.89 × 10⁻¹ [symbol] |
| Silver(I) sulfate | Ag₂S0₄ | 1.20 × 10⁻⁵ |
| Siiver(I) sulfite | Ag₂S0₃ | 1.50 × 10⁻¹⁴ |
| Siiver(I) sulfide | Ag₂S | 8 × 10⁻⁵¹ |
| Silver(I) thiocyanate | AgSCN | 1.03 × 10⁻¹² |
| Strontium arsenate | Sr₃(As0₄)₂ | 4.29 × 10⁻ [symbol] |
| Strontium carbonate | SrC0₃ | 5.60 × 10⁻¹⁰ |
| Strontium fluoride | SrF₂ | 4.33 × 10⁻ [symbol] |
| Strontium iodate | Sr(IO₃)₂ | 1.14 × 10⁻ [symbol] |
| Strontium iodate monohydrate | Sr(I0₃)₂ × H₂0 | 3.77 × 10⁻ [symbol] |
| Strontium iodate hexahydrate | Sr(I0₃)₂ × 6H₂0 | 4.55 × 10⁻ [symbol] |
| Strontium oxalate | SrC₂0₄ | 5 × 10⁻⁸ |
| Stroritium sulfate | SrS0₄ | 3.44 × 10⁻ [symbol] |
| Thallium(I) bromate | TIBr0₃ | 1.10 × 10⁻⁴ |
| Thallium(I) bromide | TIBr | 3.71 × 10⁻⁶ |
| Thallium(I) chloride | TlCl | 1.86 × 10⁻⁴ |
| Thallium(I) chromate | Tl₂Cr0₄ | 8.67 × 10⁻¹³ |
| Thallium(I) hydroxide | Tl(OH)₃ | 1.68 × 10⁻⁴⁴ |
| Thallium(I) iodate | TlI0₃ | 3.12 × 10⁻⁶ |
| Thallium(I) iodide | Til | 5.54 × 10⁻⁸ |
| Thallium(I) thiocyanate | TlSCN | 1.57 × 10⁻⁴ |
| Thallium(I) sulfide | Tl₂S | 6 × 10⁻²² |
| Tin(II) hydroxide | Sn(OH)₂ | 5.45 × 10⁻² [symbol] |
| Yttrium carbonate | Y₂(C0₃)₃ | 1.03 × 10⁻³¹ |
| Yttrium fluoride | YF₃ | 8.62 × 10⁻²¹ |
| Yttrium hydroxide | Y(OH)₃ | 1.00 × 10⁻²² |
| Yttrium iodate | Y(I0₃)₃ | 1.12 × 10⁻¹⁰ |
| Zinc arsenate | Zn₃(As0₄)₂ | 2.8 × 10⁻ [symbol] |
| Zinc carbonate | ZnC0₃ | 1.46 × 10⁻¹⁰ |
| Zinc carbonate monohydrate | ZnC0₃ × H₂0 | 5.42 × 10⁻¹¹ |
| Zinc fluoride | ZnF | 3.04 × 10⁻² |
| Zinc hydroxide | Zn(OH)₂ | 3 × 10−¹⁷ |
| Zinc iodate dihydrate | Zn(I0₃)₂ × 2H₂0 | 4.1 × 10⁻⁶ |
| Zinc oxalate dihydrate | ZnC₂0₄ × 2H₂0 | 1.38 × 10⁻ [symbol] |
| Zinc selenide | ZnSe | 3.6 × 10⁻ [symbol] |
| Zinc selenite monohydrate | ZnSexH₂0 | 1.59 × 10⁻⁷ |
| Zinc sulfide (alpha) | ZnS | 2 × 10⁻ [symbol] |
| Zinc sulfide (beta) | ZnS | 3 × 10⁻ [symbol] |

[symbol]

indicates data missing or illegible when filed

Embodiments the system can include either all or only some of the components from the previous component list. As an example, when the water to be treated does not contain volatile organic compounds, a degasser may not be needed. As a further example, when the water to be treated is already at elevated temperature, a preheater may not be needed. As a further example, the product water can be directed back to previous stages and collected to a single product outlet instead of multiple outlets. There are many other examples where only some of the components previous listed would be needed. The basics of the system, however, include at least one evaporation chamber and one heat pipe or set of heat pipes.

### BRIEF DESCRIPTION OF DRAWINGS

Embodiments of the invention are disclosed herein, in some cases in exemplary form or by reference to one or more figures. However, any such disclosure of a particular embodiment is exemplary only, and is not indicative of the full scope of the invention.

FIG. 1 is a schematic of typical embodiment of a purification or feedwater concentration system.

FIG. 2 shows a general configuration for a purification system.

FIG. 3 is a schematic view of a water purification or feedwater concentration system having two purified water producing stages.

FIG. 4 is a schematic view of a water purification or feedwater concentration system stage.

FIG. 5 is a schematic view of a water purification or feedwater concentration system having five purified water producing stages.

FIG. 6 is a schematic view of a water purification or feedwater concentration system having two purified water producing stages with purified water feedback.

FIG. 7 is a diagram of a perforated plate.

FIG. 8 is a diagram of a water purification or feedwater concentration system stage with a downcomer tube.

FIG. 9 shows an elevation view of a purification or feedwater concentration system with a stacked arrangement of stages.

FIG. 10 shows an elevation view of a purification or feedwater concentration system operating in a counter flow mode and with a stacked arrangement of stages.

FIG. 11 is a schematic flowsheet of a pretreatment process.

FIG. 12 is a schematic diagram of a feedwater preheating chamber in a purification or feedwater concentration system.

FIG. 13 is a schematic diagram of a feedwater degasser in a purification or feedwater concentration system.

FIG. 14 shows a cross-section view of a feedwater degasser in a purification or feedwater concentration system.

FIG. 15 is a schematic diagram of an evaporation chamber with a degasser in a purification or feedwater concentration system.

FIG. 16 is a schematic diagram of an evaporation chamber without a degasser in a purification or feedwater concentration system.

FIG. 17 shows a demister arrangement with a baffle guard, grooves and a pad demister.

FIG. 18 is a schematic diagram of an evaporation chamber.

FIG. 19 is a schematic diagram of a cyclone demister.

FIG. 20 is a schematic diagram of a condenser chamber with spiral vanes.

FIG. 21 is a schematic top view of a condenser chamber with spiral vanes.

FIG. 22 is a schematic diagram of a conventional heat pipe.

FIG. 23 is a schematic diagram of a high-performance heat pipe.

FIG. 24 is a diagram of the control circuitry in a purification or feedwater concentration system.

FIG. 25 shows several energy input configurations

FIG. 26 shows a schematic view of a purification or feedwater concentration system operating under vacuum and using thermal vapor compression.

FIG. 27 show's a schematic view of a purification or concentration system operating under vacuum and using mechanical vapor compression.

FIG. 28 shows a schematic view of a purification or concentration system with single water producing evaporation chamber.

FIG. 29 shows a schematic view of a purification or concentration system using heat pipes and mechanical vapor compression.

FIG. 30 shows a schematic view of a purification or concentration system operating in a horizontal configuration.

FIG. 31 is a schematic diagram of an evaporation chamber with spraying of feedwater or intermediate concentrate on the surface of heat pipes.

FIG. 32 shows a schematic view of a purification or concentration system using loop heat pipes in stages and between stages.

FIG. 33 is a schematic view of water purification or feedwater concentration system stages with tilted heat pipes.

FIG. 34 is a schematic view of water purification or feedwater concentration system stages with heat pipes at different heights.

FIG. 35 is a schematic view of a water purification or feedwater concentration system stage with alternate steam injection.

FIG. 36 shows a schematic view of a heat pipe mounted on a perforated plate.

FIG. 37 shows a schematic view of a heat pipe mounted on a perforated plate with a machined recess.

FIG. 38 shows a schematic view of a heat pipe held by an insert threaded into the perforated plate.

FIG. 39 shows a schematic view of a heat pipe held by an electrically-insulating sleeve mounted on the perforated plate.

FIG. 40 shows a schematic view of a heat pipe held by another electrically-insulating sleeve mounted on the perforated plate.

FIG. 41 shows a schematic view of a heat pipe held by another sleeve mounted on the perforated plate.

FIG. 42 shows a schematic view of a heat pipe mounted on a coated perforated plate.

FIG. 43 shows a schematic view of a heat pipe mounted vertically on a perforated plate.

FIG. 44 shows a schematic view of a heat pipe mounted at an angle on a perforated plate.

FIG. 45 shows a schematic view of a heat pipe connected to a sleeve mounted on the perforated plate.

FIG. 46 shows a schematic view of a heat pipe held by a conical sleeve mounted on the perforated plate.

FIG. 47 shows a schematic view of a heat pipe held by local deformation of the perforated plate.

FIG. 48 shows a configuration for mounting a multiplicity of heat pipes on a perforated plate.

FIG. 49 shows a configuration for mounting a multiplicity of heat pipes on a perforated plate.

FIG. 50 is a schematic view of a water purification or feedwater concentration system using heat plates.

FIG. 51 is a schematic view of a water purification or feedwater concentration system stage using corrugated heat plates.

FIG. 52 shows a system for using ultrafiltration or nanofiltration processes to reduce water hardness.

FIG. 53 is a diagram illustrating a self-cleaning feature for heat pipes

FIG. 54 is a diagram showing piping and valve arrangements to take one stage of a purification or concentration system out of service for cleaning or doing maintenance work.

FIG. 55 is a diagram showing piping and valve arrangements to take one stage of a purification or concentration system out of service for cleaning or doing maintenance work.

FIG. 56 is a schematic representation of a conditioning and clean-in-place process for cleaning scale deposited on the surface of heat transfer devices.

FIG. 57 is a diagram showing piping and valve arrangements to take one degasser out of service for cleaning or doing maintenance work.

FIG. 58 is a schematic representation of a thermal shock process for cleaning scale deposited on the surface of heat transfer devices.

FIG. 59 is a schematic representation of a robot for cleaning scale deposited on the surface of heat transfer devices.

FIG. 60 is a schematic representation of an arrangement to apply electric bias on heat pipes for reducing the rate of scale formation on the surface of heat transfer devices.

FIG. 61 is another schematic representation of an arrangement to apply electric bias on heat pipes for reducing the rate of scale formation on the surface of heat transfer devices.

FIG. 62 is a schematic representation of multi-stage flash evaporators and multiple-effect distillation systems with heat pipes.

FIG. 63 is a schematic representation of a freeze-desalination process using heat pipes.

FIG. 64 is a schematic representation of a system using heat pipes as heaters for nanofiltration, ultrafiltration or reverse osmosis.

FIG. 65 is a schematic representation of a system using loop heat pipes for a flue-gas type water purification or solution concentration system.

FIG. 66 is another schematic representation of a system using loop heat pipes for a flue-gas type water purification or solution concentration system.

FIG. 67 is a schematic representation of a crystallizer with heat pipes.

FIG. 68 is a schematic representation of a crystallizer with heat pipes, liquid recirculation with heat pipe heat exchanger, and steam energy recovery to pre-heat crystallizer feed.

FIG. 69 shows a schematic representation of a heat pipe heat exchanger.

FIG. 70 is a schematic representation of a crystallizer with heat pipes, liquid recirculation with heat pipe heat exchanger, steam energy recovery to pre-heat feed water for a purification or concentration system, and a flash chamber to evaporate some water from the final concentrate of a purification or concentration system.

FIG. 71 is a schematic representation of membrane distillation configurations.

FIG. 72 shows schematic representations of two types of membranes.

FIG. 73 is a schematic representation of a rolled membrane without heat pipe.

FIG. 74 is a schematic representation of a rolled membrane with a heat pipe.

FIG. 75 is a schematic representation of a system using heat pipes in electrodialysis.

FIG. 76 is a schematic representation of a system using heat pipes in electrodialysis with injection of gas.

FIG. 77 is a schematic representation of a system using heat pipes in dewvaporation.

FIG. 78 is another schematic representation of a system using heat pipes in dewvaporation.

### DETAILED DESCRIPTION OF THE INVENTION

### Systems

### Typical System Configuration

In some embodiments of this invention, feedwater or a solution to be concentrated is sent to a preheater to bring it from ambient temperature up to near boiling temperature. From the preheater, the feedwater is sent to a degasser to remove unwanted volatile compounds. From the degasser, the feedwater is sent to the first steam producing stage of the system. In this stage, heat is applied to the feedwater using heat pipes (or other phase change heat transfer devices) until the feedwater is caused to boil. The steam produced by in this first “stage” is sent to the condenser chamber of the preheater stage where is condenses into purified water. The energy of vaporization of this steam is transferred from the steam to the feedwater in the preheater Some of the concentrate in the first boiling stage is sent to the next stage, where it is again boiled to produce steam, which is then condensed and whose energy is transferred to another volume of concentrate, and so on. The repetition of the energy transfer allows for the reuse of the original energy supplied to the system, which is what makes the invention energy efficient.

It should be noted that the feedwater can travel from stage to stage in the same direction or in the opposite direction from the energy in the heat pipes. By the same token the feedwater can be fed to the individual stages independently. The purified water can be collected from each condenser chamber separately, or it can be transferred from stage to stage to capture the heat it contains.

The concentrates and the purified product water can be transferred from stage to stage using pumps, hydrostatic pressure, or the internal pressure of higher temperature stages.

Again, it should be noted that not all systems need to have all of the components listed and some could have more. For example, a pretreatment system can be added when the feedwater contains scale-producing compounds that need to be removed prior to processing in the stages. As a second example, where the concentrate is the desired end product, demisters may not be needed. As a third example, for applications where energy efficiency and capital costs need to be balanced, the number of stages can be selected to be any number from one to twenty or more.

### Typical Embodiments

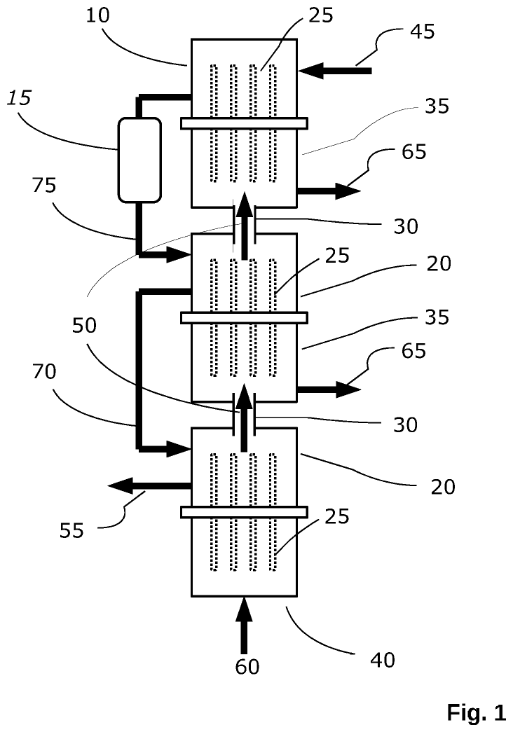

One embodiment of a water purification and desalination system is shown in FIG. 1. This embodiment consists of a preheater 10, a degasser 15, two evaporation chambers (boilers) 20, heat pipes 25, two demisters 30, two condenser chambers 35 and an energy input vessel 40, which in this case is another condenser chamber. Feedwater 45 to be purified or concentrated is introduced into the preheater 10. After preheating the feedwater 45 is sent though a degasser 15 to a first evaporation chamber 20 where heat energy transferred through heat pipes 25 from the corresponding condenser chamber 35 creates steam 50 from some of the degassed feedwater 75. The remaining feedwater (intermediate concentrate 70) is sent to the next evaporation chamber, where some of it is again transformed into steam by energy from the heat pipes coming from another corresponding condenser chamber. The feedwater and intermediate concentrate streams are concentrated in each evaporation chamber until the final concentrate stream 55 (created in the last evaporation chamber) is discharged from the system through a concentrate outlet.

Energy 60 for the system is provided to the energy input vessel 40. This energy is used to create steam from the intermediate concentrate stream 70 in the corresponding evaporation chamber 20. The steam thus created is transferred through a demister 30 to a condenser chamber 35, where the energy in the steam is recovered by the heat pipes 25 as the steam condenses. The condensed steam exits the condenser chamber as purified water 65. The heat pipes 25 in the condenser chamber transfer the energy once again to another evaporation chamber 20 where more steam is created. This process is repeated until the condenser chamber attached to the preheater transfers its condensing steam energy to the preheater to preheat the feed water.

Many other embodiments are possible. For example the feedwater can be introduced at the other end of the system to create a “forward flow” system. As another example, the feedwater can be introduced directly into each evaporation chamber instead of flowing from chamber to chamber. Many other configurations are also possible.

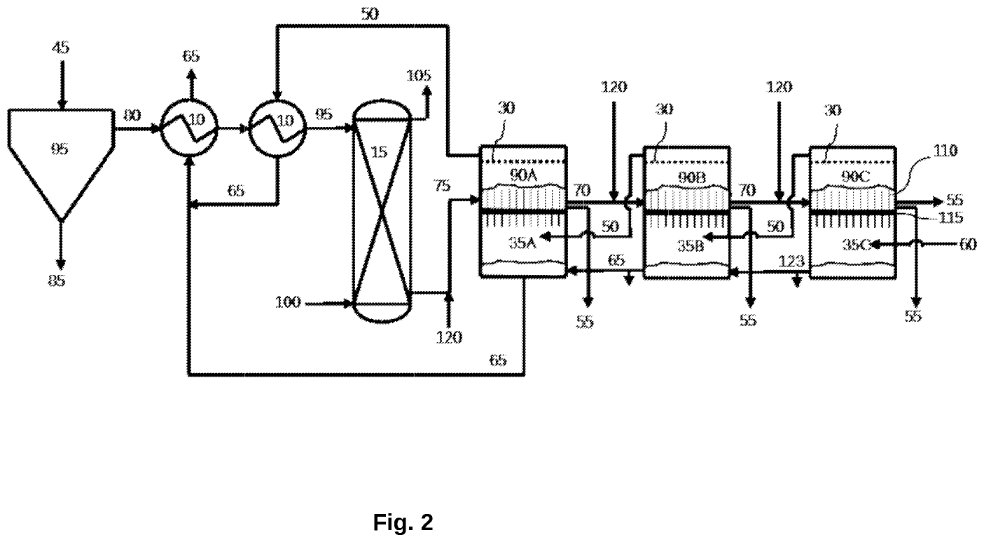

Another water purification system embodiment is shown in FIG. 2. Here the system includes a pretreatment section, a degasser, a preheater, one or multiple evaporation chambers and demisters, one or multiple product condenser chambers, inlets and outlets for liquid and gas streams, a control system, one or more heat recovery units, equipment for conditioning and clean-in-place procedures, and equipment for removal of solids. While FIG. 2 includes all these steps, as is evident to any person skilled in the art, systems without one or more of these steps are also possible.

The feedwater 45 to be purified can be fed to one or more pretreatment units 115 such as water softening by ion-exchange resins, precipitation, —either by addition of chemicals or by adjusting the pH-, filtration, coagulation, sedimentation or centrifugation. After pretreatment, the pretreated feedwater 80 is transferred to the next stage either by the action of pumps or hydrostatic pressure, while solids 85 can be removed from the unit. Pretreatment steps can be used to separate scale-forming impurities from the feedwater in order to inhibit scale formation on the internal surfaces of the units downstream of the pretreatment units, in some embodiments, the feedwater is not pretreated.

The pretreated feedwater 80 can be transferred to one or more preheater units 10. The preheater units transfer heat from process streams or external heat sources into the feed water. The preheater units can include heat exchangers, heat plates, heat pipes, tubes or rods. Some examples of heat sources are steam produced in evaporation chambers, steam produced from flashing pressurized water inside process vessels, steam from an external supply, purified water, concentrate, or combination of those. In a typical setting, feed water is preheated to a temperature between the starting temperature of the feedwater and the boiling point of the feedwater at the first evaporation chamber (including boiling point elevation caused by dissolved solids in the feedwater). In one embodiment, a first preheater is a heat exchanger with purified water 65 as energy source, and a second preheater is a vessel with heat pipes and the energy source is steam from the lowest temperature evaporation chamber 90A in the water purification system.

The preheated feedwater 95 can include chemical species with relatively low vapor pressures, such as volatile organic compounds, other organic liquids or ammonia, which can evaporate from the feedwater in the evaporation chambers simultaneously with the steam vapors, and therefore may end up contaminating the purified water produced by condensation of the gases. These species can be separated from the feedwater in one or more degassers 15, which can be packed columns, a column with multiple discrete plates, one of the stages in a multi-stage evaporator, an empty column with a showerhead or any other vessel in which a liquid stream enters in contact with a gas stream. The water to be treated 95 is fed into the vessel at one location, and a gas stream 100 is fed into the vessel at the same or another location. The gas can be water vapor (steam), air, nitrogen, argon, mixtures of these gases or any other non-condensable gas that won't condense with the product water in the evaporating chambers downstream of the degasser. The feedwater and the gas are in contact as they flow through the degasser chamber, at least for part of their path inside the degasser. The degasser has an outlet for the mixture of gases 105, which contain the species removed from the feedwater, and an outlet for the degassed feedwater 75.

The feedwater 75, after being subject to any combination of the above-mentioned pretreatment, degassing and preheating steps, or without any previous step, can be transferred to one or more evaporation chambers 90A, 90B, 90C. The evaporation chambers 90A, 90B, 90C can be enclosed vessels made out of metal, metal alloys, composites, ceramics, polymers or combinations thereof (for example, a metal alloy vessel with a polymer liner). The evaporation chambers 90A, 90B, 90C can include heat transfer devices 110 such as heat pipes, theromsiphons, heat plates, rods or combinations thereof. The heat transfer devices 110 transfer energy from an external source 60 to the intermediate concentrate 70, and the energy causes evaporation of water (a fraction of the energy can be used to heat up feed water to the boiling point at the vessel operating pressure, and another fraction corresponding to the heat of evaporation of the feedwater can be used to boil the water). The external energy source 60 can be steam condensing on the hot end of the heat transfer device 110. Said steam can come from another evaporating chamber or from an external source The evaporation chambers 90A, 90B, 90C can contain one or more demisters 30, such as screens, meshes, baffles, cyclones or combinations of them. The demisters separate liquid droplets carried away from the feedwater by the steam evolving due to evaporation. Said droplets contain the impurities present in the feedwater and, if they are not separated, they will transfer these impurities to the purified water produced by condensation of the steam 50 boiling off the evaporation chambers. After being separated from the steam, the droplets are typically returned by the action of gravity to the pool of boiling concentrate. Alternatively, they can be collected in a separate stream in the system. The feedwater and/or concentrate is transferred through a sequence of evaporation chambers 90A, 90B, 90C, and the concentration of dissolved species in the water increases at each stage due to evaporation of water. A stream of final concentrate 55 is taken out of the last evaporation chamber. Alternatively, feedwater 45 can be supplied in parallel to several or all evaporation chambers 90A, 90B, 90C, and final concentrate 55 can be taken out of several or all evaporation chambers.

The system can have one or more condenser chambers 35A, 35B, 35C. In one configuration, steam is fed into a condenser chamber 35A, 35B, 35C and it condenses on the internal surfaces, including the surface of heat transfer devices 110 such as heat pipes and others listed in the description of the evaporation chambers. The latent heat of vaporization and, to a minor extent some of the sensible heat from the steam, are transferred to the heat transfer devices and carried through them to one or more of the evaporation chambers. The condenser chambers 35A, 35B, 35C can be vessels fabricated from the same materials listed for the evaporation chambers 90A, 90B, 90C. In some configurations, the condenser chambers 35A, 35B, 35C can be adjacent to the evaporation chambers 90A, 90B, 90C. In some configurations, the condenser chambers 35A, 35B, 35C and evaporation chambers 90A, 90B, 90C can share one or more of the vessel walls. As an example, a pair of evaporation chambers and condenser chambers can be part of the same vessel and they are separated by a perforated plate 115 in which heat transfer devices are mounted, so part of said devices is in the condenser chamber and part in the evaporation chamber, while a proper seal avoids transfer of liquid or gas between the chambers. As another example, multiple evaporation chambers and condenser chambers share walls and they are stacked vertically in a column, or they are adjacent horizontally.

The system can have the feature of adding clean-in-place solution 120 at one or more evaporation chambers 90A, 90B, 90C. Addition of clean-in-place solution 120 can be accomplished by pumping it directly into the evaporation chambers 90A, 90B, 90C, or by pumping into the lines that bring intermediate concentrate 70 into the evaporation chambers 90A, 90B, 90C. As a result of the clean-in-place procedure, scale fragments are in suspension in the aqueous solution in the evaporation chambers 90A, 90B, 90C. Small fragments can be carried out with the intermediate concentrate 70 through the several stages. Larger fragments that settle can be collected at the bottom of the evaporation chambers 90A, 90B, 90C, and removed from the vessels using standard valves designed for this purpose, in a similar manner as is done in settling tanks in wastewater treatment plants. Alternatively, solids can be separated using filters in between stages.

The system can have piping that carries fluids into the system, out of the system or between different parts of the system. Fluids can be moved by the action of pumps, hydrostatic pressure or taking advantage of pressure differentials created by boiling aqueous solutions at different temperatures. As an example, feedwater 45 is pumped into a pretreatment step, next into a preheater, then into a degasser, afterwards into one evaporator, then through a sequence of evaporators, and finally out of the system through a heat recovery unit. As an example, steam is supplied to a first condenser chamber as the energy source for evaporation, steam produced in an adjacent evaporation chamber is transferred to another condenser chamber, and this is repeated through multiple sets of condensers and evaporators to re-use the energy multiple times, and obtain purified water when steam condenses into liquid water. As an example, the energy in the first or other condenser chambers is provided by a thermal fluid, a hot gas, an electrical heater, combustion of fuels, a chemical reaction or another energy source.

The system can have multiple sensors, including temperature sensors, pressure sensors, liquid level sensors, flow sensors, conductivity probes, ion selective electrodes, colorimetric sensors, spectroscopic sensors, weight scales, viscosity sensors and other typical sensors in chemical plants. The system can have valves and pumps that are manually or automatically operated. The system can have sampling ports. The system can have a control unit that operates pumps, operates valves, turns power on or off to devices in the system, and/or sends alarms to operators. The system can record data automatically.

In typical settings, the temperature in the evaporation chambers 90A, 90B, 90C can be in the range 40-200° C., for example the temperature can be 50-120° C., 60-120° C., 70-120° C., 100-200° C., 100-180° C., 100-160° C., 100-140° C., 100-120° C., 100-110° C., or about 70° C., 80° C., 90° C., 100° C., 105° C., 110° C., 120° C., 140° C., 160° C., 180° C., 200° C. The pressure in the evaporation chambers 90A, 90B, 90C can be in the range 7000-1.6-10⁶ Pa, for example the pressure can be 7000-105000 Pa, 50000-105000 Pa, 100000-1.6-10⁶ Pa, 100000-1-10⁶ Pa, 100000-800000 Pa, 100000-600000 Pa, 100000-400000 Pa, 100000-200000 Pa, or about 7000 Pa, 50000 Pa, 100000 Pa, 200000 Pa, 400000 Pa, 600000 Pa, 800000 Pa, 1-10⁶ Pa or 1-6-10⁶ Pa. The concentration of impurities in the feed water 45 can be in the range 50-250000 mg/L, for example the concentration can be 50-150000 mg/L, 50-50000 mg/L, 500-20000 mg/L, or about 50 mg/L, 500 mg/L, 5000 mg/L, 10000 mg/L, 20000 mg/L, 50000 mg/L, 100000 mg/L, 150000 mg/L, 200000 mg/L, 250000 mg/L or 300000 mg/L. The concentration of volatile species in the degassed feed water 75 can be in the range 0.01-100 mg/L, for example the concentration can be 0.1-50 mg/L, 1-50 mg/L, 1-10 mg, or about 1 mg/L, 5 mg/L, 10 mg/L, 20 mg/L, 30 mg/L, 40 mg/L, 50 mg/L. The concentration in the final concentrate 55 can be in the range 500-750000 mg/L, for example the concentration can be 5000-750000 mg/L, 25000-500000 mg/L, 50000-350000 mg/L, 100000-350000 mg/L, or about 50000 mg/L, 100000 mg/L, 150000 mg/L, 200000 mg/L, 250000 mg/L, 300000 mg/L, 350000 mg/L, 500000 mg/L. The concentration in the purified water 65 can be in the range 0.01-100 mg/L, for example the concentration can be 0.1-50 mg/L, 1-50 mg/L, 1-20 mg/L, 1-10 mg/L, or about 0.1 mg/L, 1 mg/L, 5 mg/L, 10 mg/L, 20 mg/L, 30 mg/L, 40 mg/L, 50 mg/L. The number of evaporation chambers 90A, 90B, 90C and condenser chambers 35A. 35B, 35C can be in the range 1-20, for example the number can be 1-10, 1-8, 1-6, 1-4, or about 1, 2, 3, 4, 5, 6, 7, 8, 9, 10. The feed water 113 flow can be in the range 0.5-10000 L/min, for example the flow can be 100-1000 L/min, 100-1000 L/min, or about 100 L/min, 1000 L/min, 5000 L/min, 1000 L/min. The recovery rate (percentage of feed water recovered as purified water) can be in the range 10-99%, for example the recovery rate can be 50-99%, 75-99%, 80-99%, 90-99% or about 50%, 60%, 70%, 80%, 90%, 95%, 99%. The temperature difference between a condenser chamber and the evaporation chamber (along the heat transfer device) can be in the range 2-15° C., for example the temperature difference can be 2-10° C., 2-6° C., or about 2° C., 3° C., 4° C., 5° C., 6° C., 7° C., 8° C., 9° C., 10° C. The pressure drop at the demister 30 can be in the range 100-20000 Pa, for example the pressure drop can be 100-5000 Pa, 100-1000 Pa, or about 100 Pa, 250 Pa, 500 Pa, 1000 Pa, 2000 Pa, 5000 Pa. The frequency of cleaning the surface of the heat transfer devices can be in the range 1-365 days or longer, for example the frequency can be 1-180 days, 1-120 days, 1-90 days, 1-60 days, 1-30 days, 1-15 days, 1-7 days, 1-3 days or about 1 day, 2 days, 3 days, 4 days, 7 days, 15 days, 30 days, 60 days, 90 days, 180 days, 365 days.

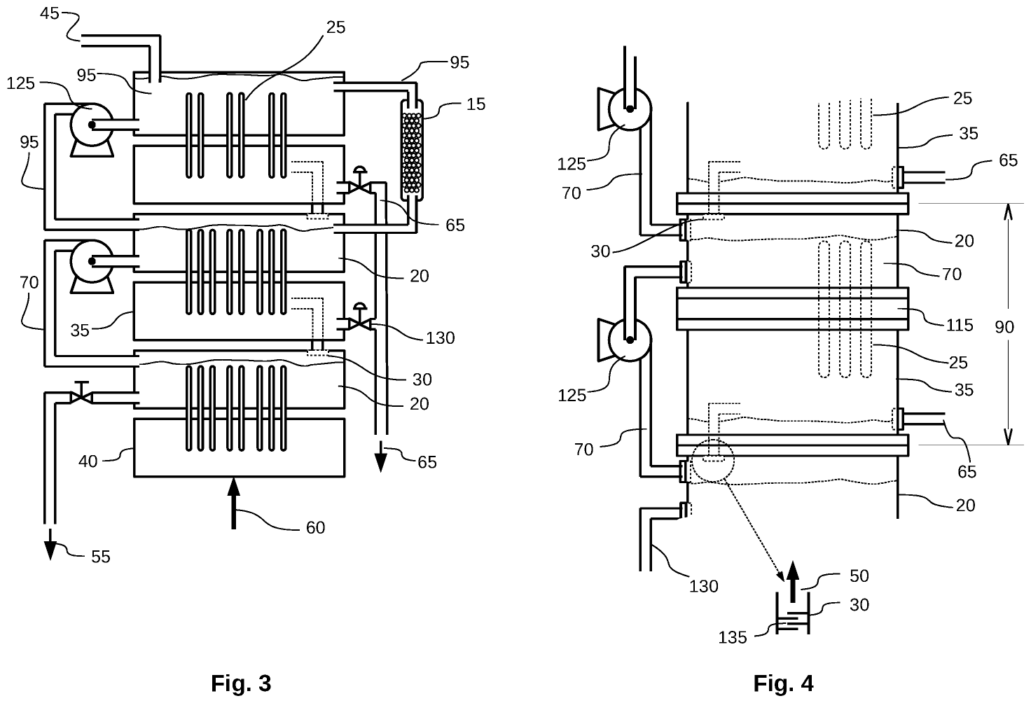

FIG. 3 shows a schematic view of a desalination system or concentration system with two stages, where a stage is defined as one evaporation chamber or preheater and one condenser chamber connected by heat transfer devices, (such as heat pipes and the like) or as an energy input vessel and an evaporation chamber. In this embodiment, the evaporation chambers 20 do not share any walls with the condenser chambers. The embodiment also does not have perforated plates containing the heat pipes as parts of the stages. The heat pipes 25 mount separately to the tops of the condenser chambers 35 and to the bottoms of the evaporation chambers 20.

In the embodiment illustrated by FIG. 3, pumps 125 move the preheated feedwater 95 and the intermediate concentrate 70 from one evaporation chamber to the next. Also in this embodiment, the demisters 50 are located inside of the evaporation chambers 20. In other embodiments, the demisters may be located outside of the evaporation chambers or may be eliminated altogether.

The streams of purified water 65 from the condenser chambers are joined together. Their flow is controlled by valves 130.

FIG. 4 shows an embodiment of a stage 90 for a water purification system or feedwater concentration system. In this embodiment, intermediate concentrate 70 from the evaporation chambers is moved from chamber to chamber using pumps 125. The purified water 65, however, exits each condenser chamber separately. The demister 30 of this embodiment consists of a tortuous path 135 created by baffle plates.

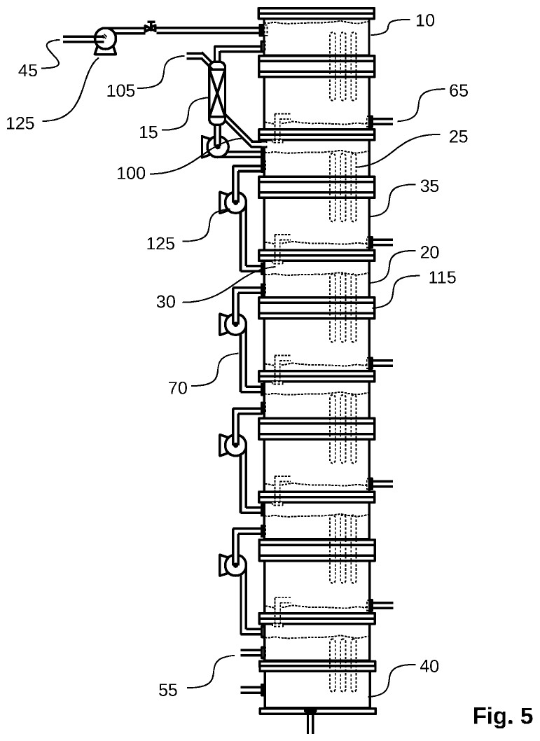

FIG. 5 shows an embodiment with five stages. Feedwater 45 is pumped 125 into the preheater 10. Steam from an evaporation chamber is used as the stripping gas 100 in the degasser 15. Intermediate concentrate is pumped from stage to stage. Purified water exits each evaporation chamber individually.

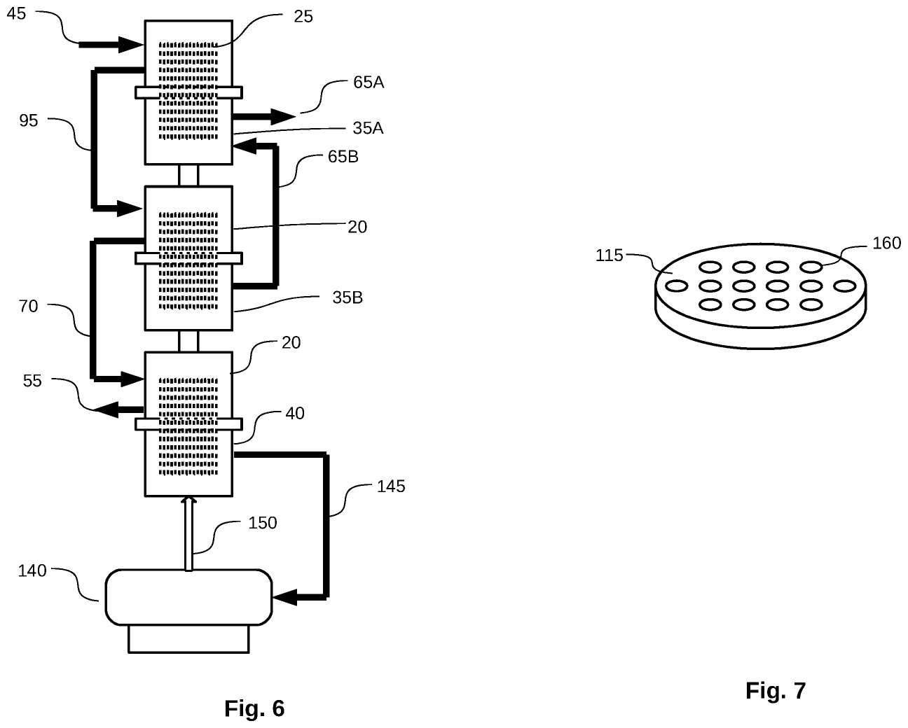

FIG. 6 shows an schematic of a two (2) water-producing stage system in which purified water 65B is fed from a hotter condenser chamber 35B to a cooler condenser chamber 35A to capture the heat in the purified water before it exits the system as the total purified water stream 65A. In this embodiment, the system is driven by steam 150 from a steam generator 140. Condensate 145 from the energy input vessel 40 is returned to the steam generator to be reused as boiler feed.

FIG. 7 shows an embodiment of a perforated plate 115. Heat pipes, or other phase-change heat transfer devices (see those listed previously) mount to the perforated plate through the heat pipe mounting holes 160. The plate also forms the wall between a condenser chamber and an evaporation chamber in configurations where the two are connected together.

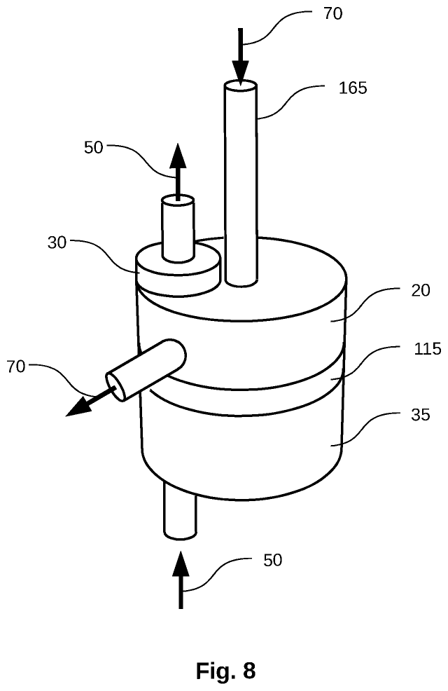

FIG. 8 shows an embodiment of a stage which uses a downcomer tube 165 to transport the intermediate concentrate 70 from one evaporation chamber to the next evaporation chamber 20 in a multi-stage system. The downcomer tube relies on gravity to flow the intermediate concentrate from one chamber to the next. In order for the flow to overcome the pressure differential between the two evaporation chambers, the chamber supplying the intermediate concentrate must be elevated with respect to the chamber accepting the concentrate. When gravity is used as the driving force for the intermediate concentrate, having the previous evaporation chamber at a sufficient height will cause a hydraulic over-pressure of several inches of water, sufficient to maintain boiling temperatures that are typically 2-25° C. higher than the previous evaporation chamber, thus ensuring efficient heat transfer between various distillation stages. FIG. 8 also shows a demister 30, steam 50 from a lower evaporation chamber, a condenser chamber 35 and a perforated plate 115.

### Outer Shell

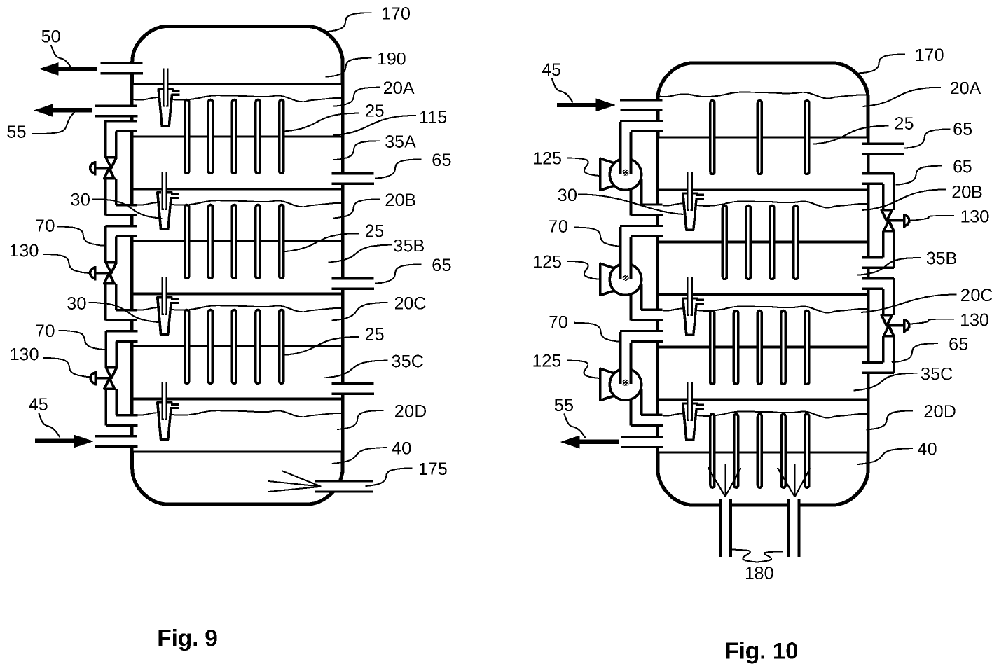

FIG. 9 illustrates an embodiment including a vertically stacked arrangement of evaporation chambers 20A, 20B, 20C, and 20D and condenser chambers 35A, 35B, 35C whereby a source of heat is provided at the bottom of the stack, a plurality of demisters 30 are provided to remove contaminated mist particles from each evaporation chamber, a single heat pipe or a plurality of heat pipes 25 are provided to recover heat from each condenser chamber and transfer such heat to an upper evaporation chamber, and an outlet is provided to remove the final concentrate 55 from the last evaporation chamber 20A. In such an embodiment, all the evaporation chambers, condenser chambers, and preheaters are encased in an outer shell 170, and the individual chambers are separated by plates, some of which are perforated plates 115 in order to accommodate the passage of heat pipes 25. In the embodiment of FIG. 9, the system is in a “concurrent flow” configuration where the feedwater 45 enters the system at the hottest evaporation chamber 20D and progresses to the coolest evaporation chamber 20A. The pressure differential between the adjacent evaporation chambers drives the intermediate concentrate from one evaporation chamber to the next. The flow is controlled by valves 130. Demisters 30 of the cyclone type are located in the evaporation chambers 20A, 20B, 20C, and 20D. The purified water 65 exits each condenser chamber individually. Energy to the system is provided to the energy input vessel 40 by a gas or oil burner 175. A chamber 190 at the top of the stack captures steam 50 from the top evaporation chamber 20A and feeds it to an external condenser (not shown).

FIG. 10 shows an embodiment similar to that of FIG. 9, except that the concentrates 70 are in a “countercurrent flow” configuration. Pumps 125 drive the intermediate concentrates 70 from the coolest evaporation chamber 20A though the other evaporation chambers 20B and 20C to the hottest evaporation chamber 20D, Purified water 65 is fed back up the system to capture its energy. Its flow is controlled by valves 130. Energy is supplied to the energy input vessel 40 in the form of steam through steam injectors 180.

For certain sizes of systems, these embodiments without shells confer cost advantages in manufacturing, and provide for simpler configurations that minimizes heat losses.

### Pretreatment System

Pretreatment systems can be used to separate scale-forming impurities from the feedwater to be treated, or to inhibit scale formation on the internal surfaces of components downstream of the pretreatment system. Pretreatment systems can include water softening by ion-exchange resins, precipitation (either by addition of chemicals or by adjusting pH), filtration, coagulation, sedimentation, centrifugation, or combinations of these methodologies. After pretreatment, the feedwater is transferred to the next section of the overall system either by the action of pumps, by hydrostatic pressure, or by the internal pressure associated with higher temperature stages.

In some embodiments, no pretreatment system is used. These embodiments are appropriate for applications where the feedwater does not contain scale-forming impurities, or where the overall purification or concentration system operates in temperature regimes where scale formation is mediated.

### Pretreatment Details

An embodiment of the present invention provides a method for removing scale-forming compounds from tap water, contaminated aqueous solutions, seawater, produced water, and saline brines, concentrates, and other contaminated water such as that resulting from municipal, agriculture/farming, mining, and other industrial processes and activities, involving the initial removal of magnesium ions by precipitating magnesium hydroxide (Mg(OH)2) at high pH, then removing the precipitate by either sedimentation or filtering. Ordinarily, Mg(OH)2 precipitates at high pH (around 11.0), although in many cases the bulk of magnesium precipitates at lower pH.

Following Mg(OH)2 precipitation, carbonate ions are added in the form of CO2 sparging, by adding soluble carbonate or bicarbonate salts in amounts so as to subsequently precipitate calcium, barium, and other divalent cations as carbonates by adjusting the pH to about 10.2 or greater. This process has the net effect of permanently sequestering CO2 from the atmosphere, and the precipitates are then removed by either sedimentation or filtering.

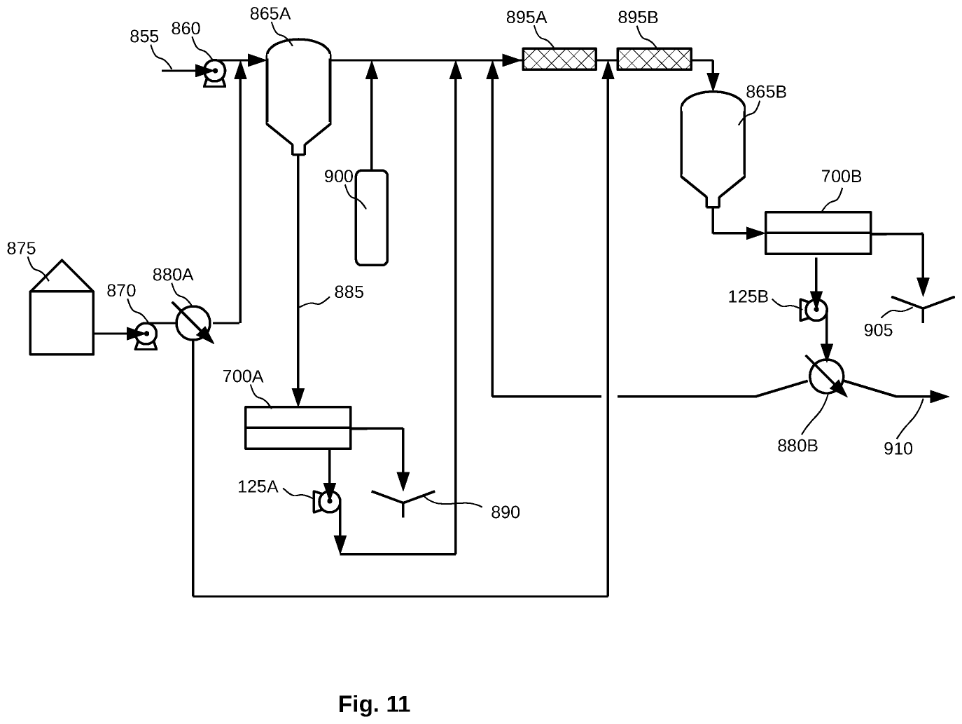

A detailed description of this pretreatment embodiment follows the flowsheet of FIG. 11 In FIG. 11, filtered and de-oiled contaminated water 855 enters the pretreatment system through a line-booster pump 860, which delivers the incoming water into a mixer-settler vessel 865A. The pH of vessel 865A is maintained at about 11 by means of continuous alkali additions, in the form of sodium hydroxide, calcium hydroxide, or similar chemical. Control of the pH in vessel 865A is achieved through a metering pump 870, which transfers caustic solution from tank 875 through a variable valve 880A. The precipitated Mg(OH)2 slurry 885 in vessel 865A sediments and exits near the bottom and is continuously filtered in filter 700A, thus yielding a filter cake 890 of magnesium hydroxide.

Following precipitation of Mg(OH)2 in vessel 865A, the clear solution exits near the top and flows into a static mixer 895A, where it is mixed with additional clear filtrate from filler 700A and pump 125A and a source of carbonate ions, which can be pressurized CO2 gas from tank 900 or a solution of soluble carbonates or bicarbonates.

The aqueous solution then flows into a second static mixer 895B, where additional caustic or alkali chemicals are added from the variable valve 870A so as to adjust the pH to about 10.2, at which point most of the divalent cations in solution precipitate as insoluble carbonates. The precipitate slurry then enters mixer-settler 865B, where the insoluble carbonates sediment and flow into filter 700B, where a second filter cake 905 is removed. The filtrate from filter 700B enters pump 125B, which feeds a variable valve 880B that allows a portion of the descaled water product 910 to recirculate back into the carbonation loop.

In a further aspect, especially when the feedwater contains excess carbonate or bicarbonate ions, calcium or magnesium can be added in order to provide the requirements for carbonate precipitation. Alternatively, calcium and magnesium can be substituted for other divalent cations, such as barium, cadmium, cobalt, iron, lead, manganese, nickel, strontium, or zinc, that have low solubility products in carbonate form.

In a further aspect, calcium or magnesium additions are substituted for trivalent cations, such as aluminum or neodymium, that have low solubility products in their carbonate or hydroxide forms.

In a further aspect, CO2 sparging is replaced by the addition of soluble bicarbonate ions, such as sodium, potassium, or ammonium bicarbonate.

In a further aspect, carbonate and scale precipitates are removed by means other than sedimentation or filtering, such as centrifuging.

In a further aspect, the permanent sequestration of CO2 from the atmosphere is achieved in conventional desalination systems, such as MSF plants, MED plants, vapor compression evaporators, membrane distillation systems, reverse osmosis, forward osmosis and other desalination systems.

In a further aspect, scale-forming salts are permanently removed from conventional desalination systems.

In a further aspect, tap water, seawater, gray water from residential systems, agricultural water, industrial process water, municipal water, or well water containing objectionable hard water constituents, such as calcium or magnesium, are descaled in water purification systems.

In a further aspect, valuable scale-forming salts, such as magnesium, barium, and other salts, are recovered.

In a further aspect, scale-forming compounds are precipitated in the form of non-adhering, easily filterable or sedimentable solids and ultimately removed.

In a further aspect, CO2 emissions from power plants and similar flue gases are permanently sequestered.

In a further aspect, scale-forming compounds are sequentially precipitated and removed, so they can be utilized and reused in downstream industrial processes.

A further embodiment of the present invention provides a method for removing a scale-forming compound from an aqueous solution, involving: adding at least one ion to the solution in an amount sufficient to cause the precipitation of a first scale-forming compound at an alkaline pH, adjusting the pH of the solution to an alkaline pH, thereby precipitating the first scale-forming compound, removing the first scale-forming compound from the solution; heating the solution to a temperature sufficient to cause the precipitation of a second scale-forming compound from the solution; and removing the second scale-forming compound from the solution.

In a further aspect, the ion is selected from the group including carbonate ions and divalent cations. In a further aspect, the carbonate ion is HC03−. In a further aspect, the divalent cation is selected from the group including Ca2+ and Mg2+.

In a further aspect, the amount is sufficient to substitute the divalent cation for a divalent cation selected from the group including barium, cadmium, cobalt, iron, lead, manganese, nickel, strontium, and zinc in the first scale-forming compound.

In a further aspect, the amount is sufficient to substitute the divalent cation for a trivalent cation selected from the group including aluminum and neodymium in the first scale-forming compound.

In a further aspect, adding at least one ion comprises sparging the solution with CO2 gas.

In a further aspect, the CO2 is atmospheric CO2.

In a further aspect, adding at least one ion comprises adding a soluble bicarbonate ion selected from the group including sodium bicarbonate, potassium bicarbonate, and ammonium bicarbonate to the solution.

In a further aspect, adding at least one ion comprises adding a compound selected from the group including CaO, Ca(OH)2, Mg(OH)2, and MgO to the solution.

In a further aspect, the alkaline pH is a pH of approximately 9.2 or greater.

In a further aspect, the first scale-forming compound is selected from the group including CaC03 and MgC03.

In a further aspect, adjusting the pH of the solution comprises adding a compound selected from the group including CaO and NaOH to the solution.

In a further aspect, removing the first scale-forming compound comprises at least one of filtration, sedimentation, and centrifuging.

### Saving the Scale-Forming Compounds

An embodiment of the present invention provides a method of obtaining scale-forming compounds, involving: providing an aqueous solution; adding alkali chemicals in amounts sufficient to cause the precipitation of a first scale-forming compound at an alkaline pH; adjusting the pH of the solution to an alkaline pH, thereby precipitating the first scale-forming compound; removing the first scale-forming compound from the solution; adding carbonate ions while maintaining an alkaline pH sufficient to cause the precipitation of a second scale-forming compound from the solution, removing the second scale-forming compound from the solution; recovering the first scale-forming compound; and recovering the second scale-forming compound.

In a further aspect, the first and second scale-forming compounds are selected from the group of compounds listed in Table 3.

### CO₂ Sequestration

An embodiment of the present invention provides a method of sequestering atmospheric CO2, involving, providing an aqueous solution containing at least one ion capable of forming a CO2-sequestering compound in the presence of carbonate ion, adding carbonate ions to the solution in an amount sufficient to cause the precipitation of the CO2-sequestering compound at an alkaline pH; adjusting the pH of the solution to an alkaline pH, thereby precipitating, the CO2-sequestering compound, and removing the CO2-sequestering compound from the solution; wherein adding carbonate ions comprises adding either atmospheric or concentrated CO2 (e.g., from a combustion flue gas) to the solution, and wherein the CO2 is sequestered in the CO2-sequestering compound.

### Sediment Trap

The system can further include a sediment trap capable of removing sediments from inlet feedwater, so as to avoid premature fouling of the system with such sediments. Various sorts of sediment traps are known in the art, and can be selected for use with the systems of the invention. Likewise, to minimize user intervention and need for cleaning, a sediment trap can itself have self-cleaning features. For example, a sediment trap can have alternating sand filters, or revolving screens, wherein rotation from a fouled screen to a new screen can be driven by a water pressure differential across the device, such that when a screen reaches a certain saturation point in terms of accumulated sediments, it is switched for a screen that is not fouled by sediments. In some embodiments, a fouled screen or sand filter can be placed into a flow path of water such that water flows across the sand filter or screen in an opposite direction from that of the original flow across the screen, thus dislodging sediments to a waste pathway or drain. Accordingly the systems disclosed herein contemplate use of conventional as well as self-cleaning sediment traps. In addition, the system can include conventional pretreatment steps such as flocculation followed by sedimentation (for instance in a clarifier tank), disinfection by chlorination, UV or other means, and adjustment of pH by addition of an acid or a base.

### Preheater

The feedwater, pretreated or not pretreated, can be transferred to one or more preheater units. The preheater units transfer heat from process streams into the feedwater. The preheater units can include heat exchangers, heat plates, heat pipes, tubes or rods. The process streams that are the heat source in the preheater can be steam produced in evaporation chambers, steam produced from flashing pressurized water inside process vessels, steam from an external supply, purified water, concentrate, or combination of those. In a typical setting, feedwater is preheated to a temperature between the starting temperature of the feedwater and the boiling point of the feedwater at the first evaporation chamber (including boiling point elevation caused by dissolved solids in the feedwater). Incoming feedwater enters the preheater, is heated until the required temperature is achieved, and exits the preheater through a downcomer tube, a pipe with a valve, or a pump that connects either with a degasser or with an evaporation chamber if there is no need for degassing.

The preheat function can be performed in numerous different ways, provided that the result is that feedwater, saline water or seawater flowing into the system arrives at the degasser at a temperature of about less than 50° to 90° C. or more. Accordingly, the preheat function can be embodied in numerous different forms, including, for example, a cylindrical tank, a rectangular tank, or different configurations of any sort with a design permitting a high ratio of surface area to internal volume, and the like.

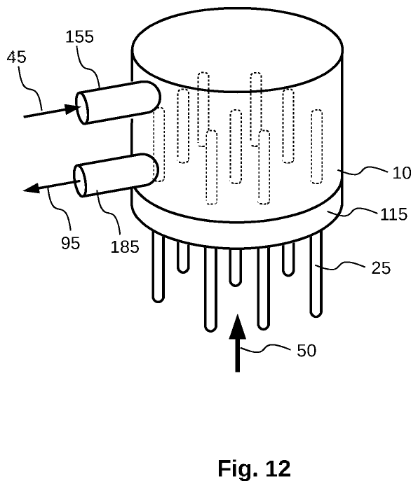

In some embodiments, such as illustrated by FIG. 12 the preheater is heated by a plurality of heat pipes 25 that penetrate the preheater through the bottom. These heat pipes transfer the heat of condensation from steam 50 entering a condenser chamber into the incoming feedwater 45. As feed water 45 enters the preheater inlet 155, it is gradually heated to near boiling temperature by the heat pipes 25. As the feedwater reaches near boiling temperature, it exits the preheater through tube 185 as preheated feedwater 95. The dimensions and configuration of the preheater are such as to allow for sufficient residence time to elevate the temperature of the water in the preheater to about less than 50° to 90° C. or more. Depending upon the scale of the system, and the capacity of the system for throughput of water, the preheating function can benefit from materials and configurations that permit efficient heat exchange. Alternatively, in some embodiments, durability of construction, space considerations, ease of maintenance, availability or expense of materials, as well as other considerations can affect the design choices in this aspect of the invention. In some embodiments, the preheater can use conventional heat exchangers, such as shell and tube configurations.

### Degasser

The feedwater to be treated can include unwanted chemical species with relatively low vapor pressures, such as volatile organic compounds, other organic liquids or ammonia. These unwanted species can evaporate in the evaporation chambers simultaneously with the steam vapors, and therefore can end up contaminating the purified water produced by condensation of the steam vapor. These species can be separated from the feedwater by passing the feedwater through one or more degasser vessels. Degasser vessels can include packed columns, a column with multiple discrete plates, one of the stages in a multi-stage evaporator, an empty column with a showerhead, or any other vessel in which a liquid stream comes into contact with a gas stream.

The feedwater to be degassed is fed into the vessel at one location, and a gas stream is fed into the vessel at the same or another location. The gas can be water vapor (steam), air, nitrogen, argon, methane, mixtures of these gases or any other non-condensable gas that won't condense with the purified water in the evaporation chambers downstream of the degasser. The feedwater and the gas are in contact as they flow through the degasser chamber, at least for part of their path inside the degasser. During the time they are in contact, the gas strips volatiles, organics, ammonia, and dissolved gases from the feedwater. The degasser has an outlet for the mixture of gases containing the species removed from the feedwater, and an outlet for the degassed feedwater.

The degasser can be in a substantially vertical orientation, having an upper end and a lower end. In one embodiment, steam from the nearest evaporation chamber (or other steam source) can enter the degasser proximate to the lower end, can strip the feedwater of the unwanted compounds, and can exit the degasser proximate to the upper end along with those compounds. Other orientations of the degasser are also possible, for example horizontal configurations, vacuum degassers, or conical spray-type configurations.

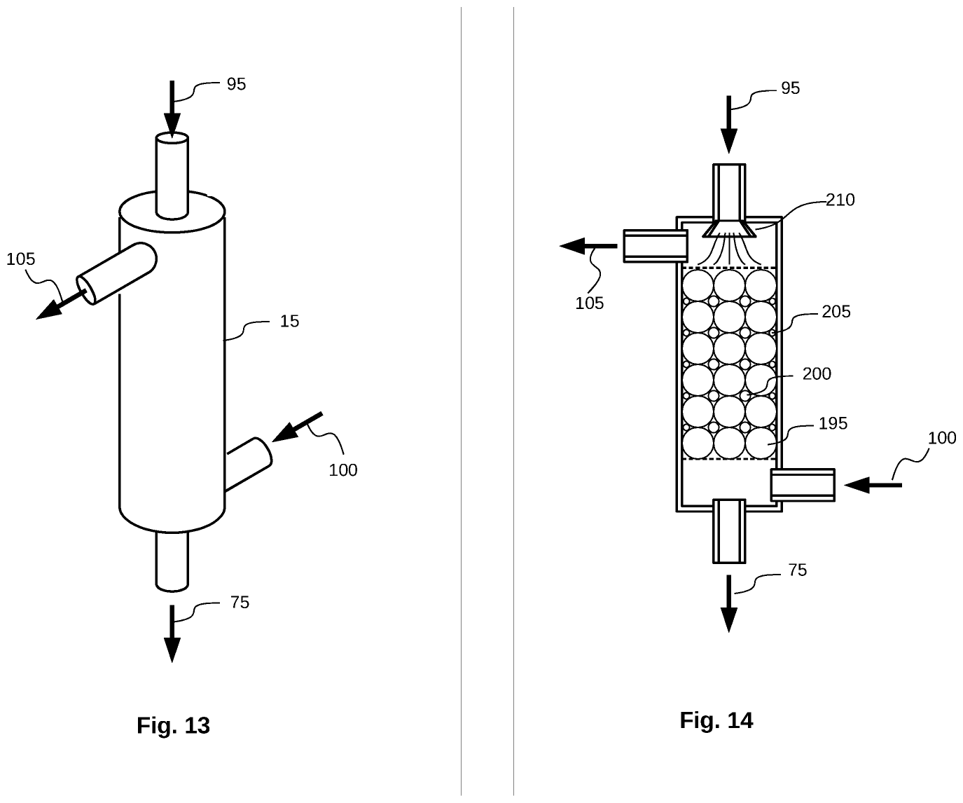

FIG. 13 shows a schematic representation of an embodiment of a degasser. In this embodiment, preheated feedwater 95 enters the top of the degasser 15. The gas stream 100 into the degasser enters near the bottom. The waste gasses 105 exit near the top. The degassed feedwater 75 exits near the bottom.

The degasser can include a matrix adapted to facilitate mixing of water and steam, stripping the inlet feedwater of essentially all organics, volatiles, and gasses by counter flowing the inlet feedwater against an opposite directional flow of a gas. The matrix can include substantially spherical particles. However, the matrix can also include non-spherical particles, rings, other mixing elements, trays and the like. The matrix can include particles having a size selected to permit uniform packing within the degasser. The matrix can also include particles of distinct sizes, and the particles can be arranged in the degasser in a size gradient to improve the interaction between the gas and the liquid. Non-condensable dissolved gases can also be removed in the first evaporation chamber using available devices designed for non-condensable gas removal. FIG. 14 shows a cross-section of one embodiment of a degasser. Preheated feedwater 95 enters the top of the degasser 15 and is dispersed by a spray head 210. This preheated feedwater travels over the packed column of particles, including larger particles 195, medium sized particles 200 and smaller particles 205. At the same time, the gas stream 100 that will strip the volatiles and organics enters from near the bottom of the degasser 15. The preheated feedwater 95 flowing over the particles 195, 200, and 205, mixes with the gas stream which strips the volatiles and organics from the preheated feedwater 95. The degassed feedwater 75 exits the degasser near the bottom. The waste gasses 105, including the volatiles and organics, exit the degasser near the top.

### Evaporation Chamber

The feedwater, after being subject to any combination of the above-mentioned pretreatment, degassing and preheating steps, can be transferred to one or more evaporation chambers. Alternatively, the feedwater can be transferred to one or more evaporation chambers without being subjected to any prior step. The evaporation chambers can be enclosed vessels made out of metal, metal alloys, composites, ceramics, polymers or combinations (for example, a metal alloy vessel with a polymer liner). The evaporation chambers can include heat transfer devices such as heat pipes, thermosiphons, loop heat pipes, heat plates, rods or combinations of them. The heat transfer devices transfer energy from an external source or from a condenser chamber to the feedwater. This energy evaporates the feedwater. A fraction of the energy is used to heat up feedwater to the boiling point at the vessel operating pressure, and a fraction corresponding to the heat of evaporation of the feedwater is used to boil the water. An evaporation chamber can include a cylindrical or rectangular tank with a perforated bottom that accommodates multiple heat pipes or other heat transfer devices. The evaporation chamber can also include an outlet for intermediate concentrate with or without a pump, or a downcomer tube, or both in fluid communication with a succeeding evaporation chamber. The intermediate concentrate outlet can be positioned in the side wall of the chamber or either on-center or off-center in the bottom of the chamber.

### Residence Time in Evaporation Chamber

The residence time of water in the evaporation chamber can vary within a range based upon the nature of the inlet feedwater and the desired performance of the system. The suitable range is determined by various factors, including whether biological contaminants are in the feedwater. Effective removal of biological contaminants can require a variable amount of time being exposed to the high temperatures in the evaporation chamber. Some biological contaminants are more quickly susceptible to high heat than are others. In many embodiments, a residence time as short as 10 minutes is sufficient to kill most biological contaminants. In other embodiments, longer residence times can be desired in order to more thoroughly eliminate a broader spectrum of biological contaminants. Where biological contaminants are not a problem, shorter residences times are appropriate. The upper end of the range of residence time in the evaporation chamber is typically dictated by efficiency considerations relating to the desired rate of generation of product water or concentrate solutions in comparison with the energy required to maintain a selected volume of water at boiling temperature. Accordingly, residence time in the evaporation chamber can be as little as about the minimal time required for water to reach boiling point and evolve as steam, to time points beneficial to removal of biological contaminants such as, for example, 10, 15, 20, 25, 30, 35, 40, 45 minutes and the like and so on. Further, higher residence times such as, for example, 50, 60, 70, 80 and 90 minutes, or more, can be selected in some embodiments.

As illustrated by FIGS, 15 and 16, the incoming feed water 45 flows into an evaporation chamber 20 by gravity, by differential chamber pressures, and/or by pumping. FIG. 15 shows a degasser 15 on the top of the evaporation chamber 20. This configuration, in which preheated feedwater 80 first flows into a degasser 15, can be used for the first evaporation chamber if the feedwater has not yet been degassed.

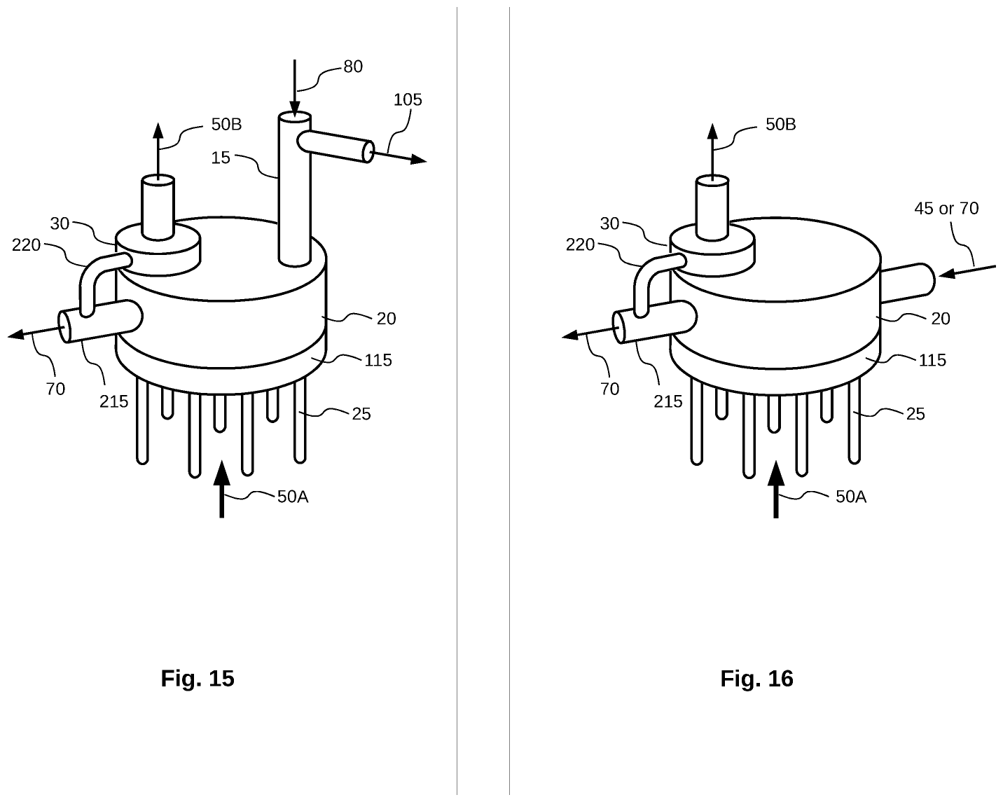

FIG. 16 shows a configuration in which feedwater 45, preheated feedwater 80, or intermediate concentrate 70 flows into the evaporation chamber. This configuration can be used in later evaporation chambers which come after degassing or where degassing is not needed.

Demisted steam 50A from a previous evaporation chamber condenses on the heat pipes 25 which transfer the heat of condensation to the intermediate concentrate in the evaporation chamber.

Demisted steam 50B flows from the demister 30 into the next condenser chamber. The waste stream 220 from the demister 30 can flow with the intermediate concentrate to the next evaporation chamber.

The evaporation chambers can be of essentially any size and configuration depending upon the desired throughput of the system and other design choices made based upon the factors affecting system design. For example, the evaporation chamber can have a volume capacity in the range of less than 10 gallons to more than 100,000 gallons or more. Because the system of the invention is completely scalable, the size of the evaporation chamber is variable and can be selected as desired. Likewise, the configuration of the evaporation chamber can be varied as desired. For example, the evaporation chamber can be cylindrical, spherical, rectangular, or any other shape. In a typical embodiment, the evaporation chamber 20 is cylindrical, includes one or a plurality of heat pipes 25 mounted in a perforated plate 115 and extending into the evaporation chamber, has an intermediate concentrate 70 discharge tube 215 that carries the intermediate concentrate 70 into the next evaporation chamber, and has a demister 30 mounted on top of the evaporation chamber. In this configuration, the degasser waste stream 105 that carries volatile constituents from the degasser is shown proximate to the top of the degasser 15.

Because the operation of the purification system is continuous, feedwater is partially concentrated by boiling, and the degree of concentration in evaporation chamber 20 is determined by the number of distillation stages and the boiling rates of the various stages. In a simple example, if two stages of distillation are being used with seawater the degree of salinity in the evaporation chamber can be kept at roughly half the value of the waste concentrate to be rejected, or about 12%. In another example, if three stages of distillation are used, the degree of salinity in evaporation chamber 20 is allowed to reach about one third of the final concentrate concentration of about 23%, or to the maximum solubility limit of the solutes in the particular feedwater being processed. As noted above, because the evaporation chambers can have significantly different boiling rates depending on, for example, the number of heat pipes they contain, or the temperature difference between condenser chamber and evaporation chamber, or feedwater flow rates, etc., these concentration numbers are only rough estimates for illustration of the concept only. They are just two examples of many different possible intermediate concentrate concentrations.

In one embodiment, the evaporation chamber drains by gravity only, through a downcomer tube. In other embodiments draining the evaporation chamber is driven by pumping devices. Continuous draining of the evaporation chamber 20 maintains a constant level of boiling fluid in the chamber, and such continuous drainage also avoids the settling of sediments, salts, and other particulates in the evaporation chamber.

### Demister

The evaporation chambers can include one or more demisters, including screens, meshes, baffles, cyclones or combinations of them. The demisters prevent liquid droplets that might be present in steam generated in an evaporation chamber from being carried with that steam into a corresponding condenser chamber, where the impurities in the droplets would contaminate the purified water created by the condensing steam. After being separated from the steam by the demister, the droplets are typically returned by the action of gravity to the pool of boiling feedwater. Alternatively, they can be collected in a separate stream in the system.

A demister can be positioned proximate to an upper surface of the evaporation chamber. Steam from the evaporation chamber can enter the demister under pressure. The demister will then separate small mist droplets from the steam flow and return the liquid droplets to the evaporation chamber.

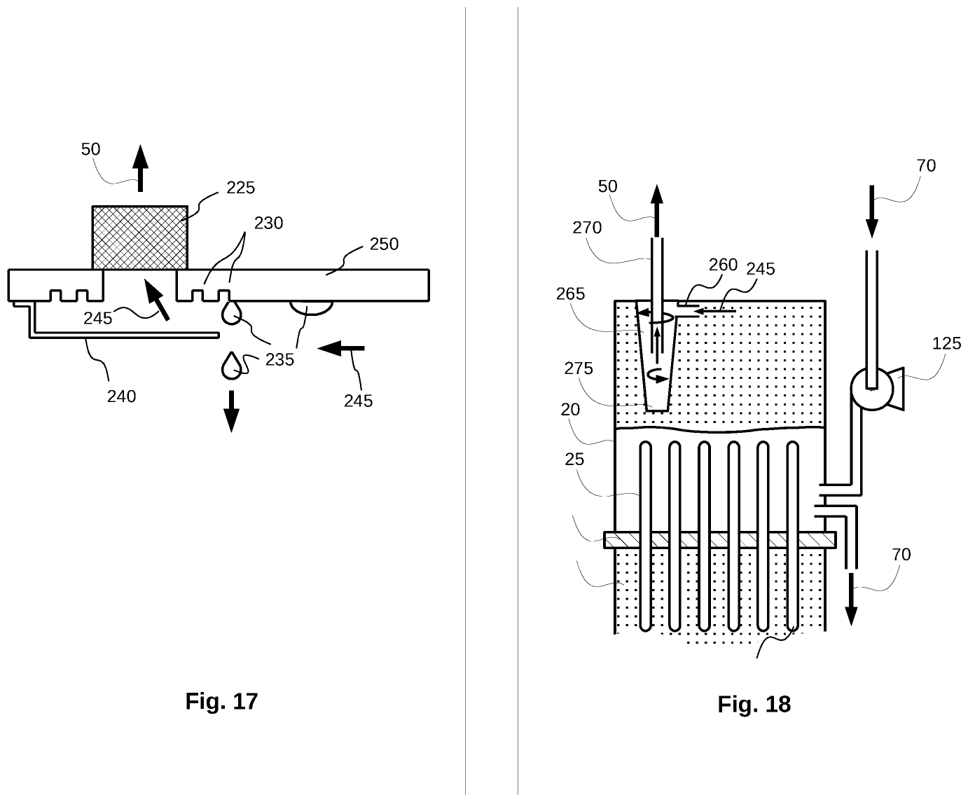

Steam can also condense into droplets on the underside of the evaporation chamber top 250, as illustrated m FIG. 17. Such droplets 235 can migrate laterally and can enter the demister device 30 with the flow of steam 245. In one embodiment, a metal groove or grooves 230 prevent such droplets from migrating and contaminating the steam flow. In addition, a baffle guard 240 can also provide a barrier to mist particles being carried by the steam. Finally, a mesh pad demister 225 can be added to the configuration to catch any final mist.

Other demister types are those that employ cyclonic action to separate steam from mist based upon differential density. Cyclones work on the principle of moving a fluid or gas at high velocities in a radial motion, exerting centrifugal force on the components of the fluid or gas. Conventional cyclones have a conical section that in some cases can aid in the angular acceleration. Key parameters controlling the efficiency of the cyclone separation are the size of the steam inlet, the size of the two outlets, for clean steam and for contaminant-laden mist, and the pressure differential between the entry point and the outlet points.

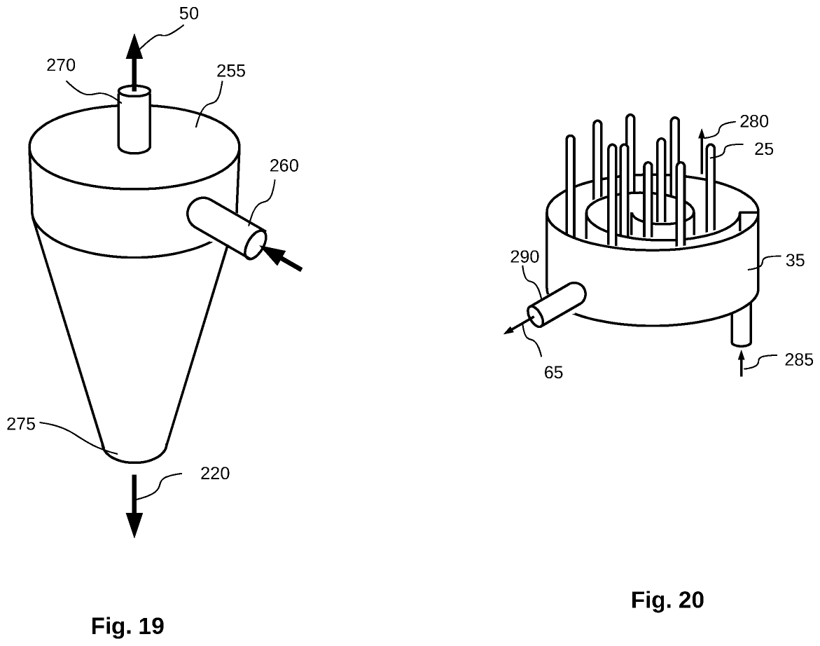

As illustrated by FIGS. 18 and 19, the demister can be positioned within, next to, or above the evaporation chamber 20, permitting steam from the chamber to enter the demister through an inlet orifice 200. Steam entering a demister through such an orifice has an initial velocity that is primarily a function of the pressure differential between the evaporation chamber and the demister, and the configuration of the orifice. Typically, the pressure differential across the demister is about 0.5 to 10 column inches of water—about 12.5 to 2500 Pa. The inlet orifice is generally designed to minimize resistance to entry of steam into the cyclone. At high velocities, such as in the cyclone cone area 265, the clean steam, relatively much less dense than the mist, migrates toward the center of the cyclone, while the mist moves toward the periphery. A clean steam outlet 270 positioned in the center of the cyclone provides an exit point for the clean steam, while a mist outlet 275 positioned near the bottom of the cyclone permits efflux of mist 220 from the demister. Clean steam passes from the demister to a condenser chamber, while mist is directed to again enter the evaporation chamber. In typical operation, clean steam-to-mist ratios are at least about 2:1; more commonly 3:1, 4:1, 5:1, or 6:1, preferably 7:1, 8:1, 9:1, or 10:1, and greater than 100:1 or more.

Demister selectivity can be adjusted based upon several factors including, for example, position and size of the clean steam exit opening, pressure differential across the demister, configuration and dimensions of the demister, and the like. Further information regarding demister design is provided in U.S. Provisional Patent Application No: 60/697107 entitled, IMPROVED CYCLONE DEMISTER, filed Jul. 6. 2005, which is incorporated herein by reference in its entirety.

In a further aspect a demister can use disengagement, for example, by increasing the cross sectional area of a vessel or pipe to separate mist droplets from clean steam.

In a further aspect, an evaporation chamber prevents condensed droplets from entering a demister by means of baffle guards and metal grooves.

In a further aspect, a ratio of clean steam to mist droplets is greater than about 10:1.

In a further aspect, steam quality includes at least one parameter selected from the group consisting of: clean steam purity, ratio of clean steam to mist droplets, and total volume of clean steam.

### Condenser

The system can have one or more condenser chambers. In a typical configuration, steam is fed into the condenser chamber where it condenses on the internal surfaces, including the surface of heat transfer devices such as heat pipes, loop heat pipes, heat plates, rods or combinations of these. The latent heat of vaporization and some of the sensible heat from the steam are transferred to the heat transfer devices and carried by them to the concentrate in one or more of the evaporation chambers.

The condenser chambers can be vessels fabricated from metal, metal alloys, composites, ceramics, polymers or combinations (for example, metal alloy vessels with a polymer liners) or from other materials suitable for handling steam. In some configurations, the condenser chambers can be adjacent to the evaporation chambers. In some configurations, the condenser chambers and evaporation chambers can share one or more of the vessel walls. As an example, an evaporation chamber and condenser chamber pair can be part of the same vessel separated by a plate in which heat transfer devices are mounted. Portions of said heat transfer devices would be in the condenser chamber and portions would be in the evaporation chamber. Proper seals avoid the transfer of liquid or gas between the chambers. As another example, multiple evaporation chambers and condenser chambers share walls and are stacked vertically in a column. In still another example the evaporation chambers and condenser chambers are adjacent horizontally.

A condenser chamber can include vanes for imparting a circular motion to the steam entering it from an evaporation chamber or external source. This circular motion would enhance the steam's velocity and would direct the steam towards the heat pipes to ensure complete steam condensation. The steam can also be injected into the condenser chamber by means of an open-end tube or by means of a steam jet configuration that would also increase the steam velocity or direct the steam to the heat transfer devices or both, for more efficient steam usage. These steam injectors can come through the bottom of the condenser chamber, the side of the condenser chamber, or the top of the condenser chamber. There could also be steam injectors coming from some or all of the above places.

The condenser chamber can be cylindrical, oval, rectangular, or other convenient shapes. Purified water can exit the condenser chamber through the purified water outlet.

In a typical embodiment, heat is removed from the condenser chamber by heat pipes, thermosiphons, or other phase change thermal transfer devices. A discussion of heat pipes for transferring heat from condensing steam to inlet feedwater is provided in U.S. Provisional Patent Application No: 60/727,106, entitled ENERGY-EFFICIENT DISTILLATION SYSTEM, filed Oct. 14. 2005, and U.S. patent application Ser. No. 12/090,248, also entitled ENERGY-EFFICIENT DISTILLATION SYSTEM, filed Sep. 9. 2008 and published as U.S. Patent Application Publication No. 2009/0218210, both of which are incorporated herein by reference in their entirety.

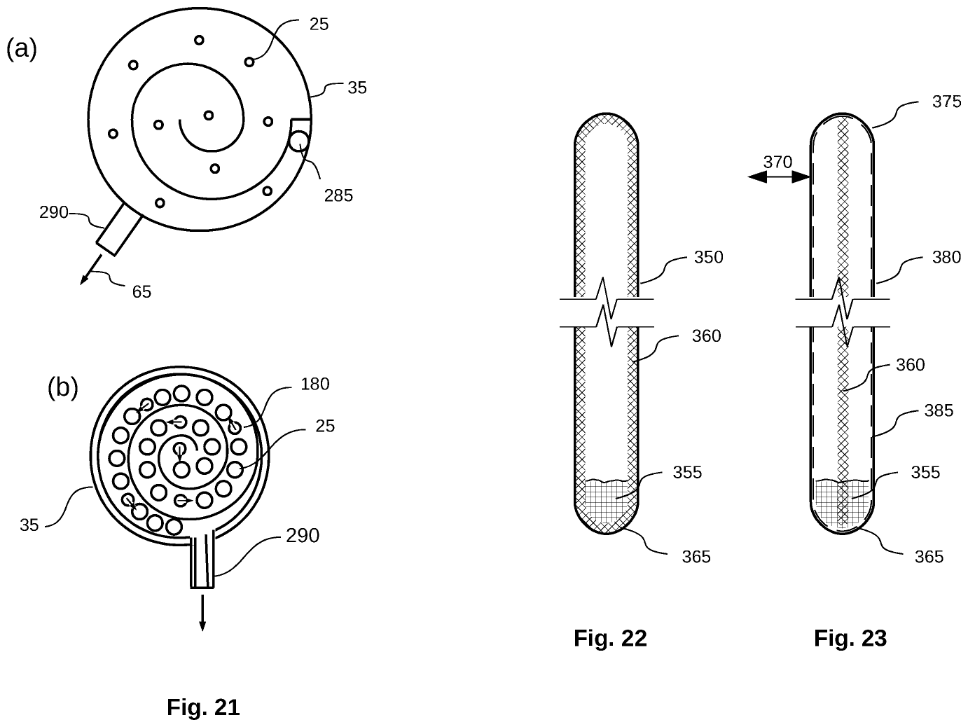

In the embodiment shown in FIGS. 20 and 21(a), clean steam enters the condenser chamber 35 via tube 285 from a demister or from an evaporation chamber. As the steam enters the condenser chamber, it rotates in a spiral fashion which increases steam velocity or directs the steam towards the heat pipes or both to render condensation most effective. The spiral motion of the steam in the condenser chamber is created by spiral vanes. Heat of condensation is removed by a plurality of heat pipes 25, mounted on so they extend partially into the condenser chamber and partially into an evaporation chamber or preheater. As heat is removed by the heat pipes and transferred to an evaporation chamber or preheater, steam condenses into purified water that exists through a purified water outlet 290. In the embodiment of FIG. 21(b), a number of steam injectors 180 are used to send steam into the spiral configuration in the condenser chamber to further increase the steam velocity and its direction towards the heat pipes 25, or other heat transfer devices in the condenser chamber.

### Heat Pipe Details

FIG. 22 illustrates the principle of operation of conventional heat pipes, one type of heat transfer device used with typical embodiments. A heat pipe consists of a sealed tube 350 under partial vacuum, partially filled with a small volume of working fluid 355. The working fluid can be water or other fluid that has a boiling temperature in the range of the overall system. The tube is also typically filled with a capillary wick 360 or capillary grooves. A heat source 365 provides energy to one end of the heat pipe which causes evaporation of all or a portion of the working fluid 355. The vapor thus created immediately fills the tube. As soon as this working fluid vapor reaches the opposite end of the heat pipe, which is at slightly lower temperature, it condenses and provides its energy in the form of heat of condensation out of the heat pipe. As the working fluid condenses into a liquid, it is adsorbed by the capillary wick 360 which carries it back to the starting point. In some cases other forms of wick, or gravity alone, provide the necessary impetus to carry the liquid back to the starting point. Because the heat of evaporation is, by definition, equal to the heat of condensation, a heat pipe transfers heat very efficiently without appreciable losses in temperature, other than heat losses through the wall. It should be noted that thermosiphons operate in the same manner, but without wicks. Other configurations of heat pipes (loop heat pipes, plate heat pipes, heat spreaders etc.) also work in a similar fashion and can be used in embodiments of the present invention as the heat transfer devices.

An embodiment of a high performance heat pipe is shown m FIG. 23. Vibrational energy 370 is provided to the heat pipe 25, either in the form of mechanical vibration, electro-mechanical vibration, or high-frequency ultrasound. This vibration is transmitted to the length of the heat pipe and disrupts the steam or fluid layer adjacent to the heat pipe. Disruption of this layer facilitates micro-turbulence in the layer, thus resulting in improved heat transfer. In addition, a hydrophobic coating 375 is provided on the outside of the heat pipe, especially in the area where external condensation occurs. The hydrophobic coating may consist of a monolayer of stearic acid or similar hydrocarbon, or it may be a thin layer of a hydrophobic chlorofluorocarbon. A hydrophobic surface on the outside of the heat pipe minimizes the area required for condensation and evaporation, thus reducing the barrier for heat transfer.

The heat conduction barrier is also minimized by using a very thin metal foil 380 instead of the solid metal tube of most heat pipes. Mechanical support for the metal foil must be sufficient to sustain moderate vacuum and is provided by a metal screen 385, which provides additional functionality by increasing the internal surface area required for providing the necessary heat of condensation/evaporation.

An improved distribution of working fluid is achieved by orienting the wick 360 toward the axis of the heat, pipe, thus reducing the thermal interference of condensate with heat transfer across the wall of the heat pipe. The wick material can be any hydrophilic porous medium that can transfer working fluid by capillary action, such as metallic oxides, some ceramics, surface-treated cellulosic materials, and the like.

Embodiments of high performance heat pipes can include any one, several, or all of the above features.

### Materials of Construction

The materials of construction for the evaporation chambers, condenser chambers, degassers, demisters, preheaters, and other vessels and piping can be any material that resists corrosion in saline, industrial waste water, chemical, or pure-water environments. In one embodiment, the evaporation chambers and preheaters are manufactured using titanium or a titanium alloy, such as Ti-CP1 or Ti-CP2, which is known to resist corrosion of hot saline solutions. Alternatively, stainless steel alloys, nickel alloys, copper alloys or other corrosion resistant alloys can be used. Alternatively, conventional carbon steel or other metal alloys can be used when coated with specific chlorofluorocarbon polymers (e.g., Teflon®), or a variety of polymer materials that resist boiling temperatures and saline or chemical environments. In addition, metal, ceramic, or metal-ceramic composite coatings, or both can be deposited on the walls of the vessels to protect them against corrosion. These materials of construction are exemplary and are not intended as limitations on the scope of the invention. Those skilled in the art may consider alternative materials and coatings, such as other metals, alloys, and polymers, which are encompassed within the spirit of the invention and are defined by the scope of the disclosure.

### Piping, Flows, and Configurations

The system can have pipes that carry fluids into the system, out of the system or between different parts of the system. Fluids can be moved by the action of pumps, hydrostatic pressure or taking advantage of pressure differentials created by boiling aqueous solutions at different temperatures. As an example, feedwater can be pumped into a pretreatment step, then into a degasser, next into a preheater, afterwards into one evaporator, then through a sequence of evaporators, and finally out of the system through a heat recovery unit. Purified water can be discharged or pumped from the condenser chambers, or it can be fed from one condenser chamber to another to take advantage of the energy stored in it due to its elevated temperature.

### Control System

The overall system can be controlled manually, controlled by the operator using control panel inputs, or controlled automatically based on feedback to the control system from various sensor inputs during operation. Such control can include valve settings, feedwater flow settings, energy input settings (e.g., for steam, electrical, heat or other), etc. The feedback control can be based upon, for example, feedwater flow rate, feedwater quality, feedwater temperature, feedwater pressure, temperature in an evaporation chamber or chambers, temperature in a condenser chamber or chambers, pressure in an evaporation chamber or chambers, pressure in a condenser chamber or chambers, feedwater level in an evaporation chamber or chambers, purified water level in a condenser chamber or chambers, purified water quality or qualities (e.g. total dissolved solids, conductivity, pH, temperature, pressure), concentrate quality (e.g. total dissolved solids, conductivity, pH, temperature, pressure), purified water flow rate or rates, concentrate flow rate or rates, flow rate or rates between evaporation chambers, flow rates between condenser chambers (steam or purified water, or both), amount of purified in a purified water collection tank, amount of concentrate in a final concentrate collection tank, time of feedwater or concentrate flows, time of no feed water or concentrate flows, pressure differentials between evaporation chambers or condenser chambers, temperature differentials between evaporation chambers or condenser chambers, pressure or temperature drops through piping, leak detection and the like.

In a further aspect, the system can include a shutdown control. In a further aspect, the control system can control the shutdown based upon feedback from the system or from another system sending feedwater to the system. The shutdown control can be selected from the group consisting of a manual control, a leak detector, a tank capacity control, an evaporation chamber capacity control, a condenser chamber capacity control, a feedwater quality, concentrate quality, temperature or pressure sensor, or similar control device.

In a further aspect, the system can include a flow controller for the feedwater into the system and between evaporation chambers. The flow controllers can include mechanisms selected from the group consisting of pressure regulators, pumps, solenoids, valves, apertures, and the like. In a further aspect, the pressure regulators can maintain inlet and vessel pressures between about 0 kPa and 1,000 kPa (0 to 150 psi), or more above the pressure in the vessel into which the feedwater is injected. In a further aspect, the flow controllers can maintain flows at rates of between 0.5 and 35,000 gallons/min or more.

In a further aspect, the flow regulators are controlled by the control system. Such control can provide on/off signals to the flow regulators or it can provide continuously variable flow control signals.

In a further aspect, the control system can control the feedwater flows based upon at least one of feedwater quality, feedwater temperature, feedwater pressure, temperature in an evaporation chamber or chambers, temperature in a condenser chamber or chambers, pressure in an evaporation chamber or chambers, pressure in a condenser chamber or chambers, feedwater level in an evaporation chamber or chambers, purified water level in a condenser chamber or chambers, purified water quality or qualities (e.g. total dissolved solids, conductivity, pH, temperature, pressure), concentrate quality (e.g. total dissolved solids, conductivity, pH, temperature, pressure), purified water flow rate or rates, concentrate flow rate or rates, flow rate or rates between evaporation chambers, flow rates between condenser chambers (steam and/or purified water), amount of purified in a purified water collection tank, amount of concentrate in a concentrate collection tank, time of feedwater or concentrate flows, time of no feedwater or concentrate flows, pressure differentials between evaporation chambers or condenser chambers, temperature differentials between evaporation chambers or condenser chambers, pressure or temperature drops through piping, leak detection.

The control system can permit operation of the overall system continuously or in batch mode.

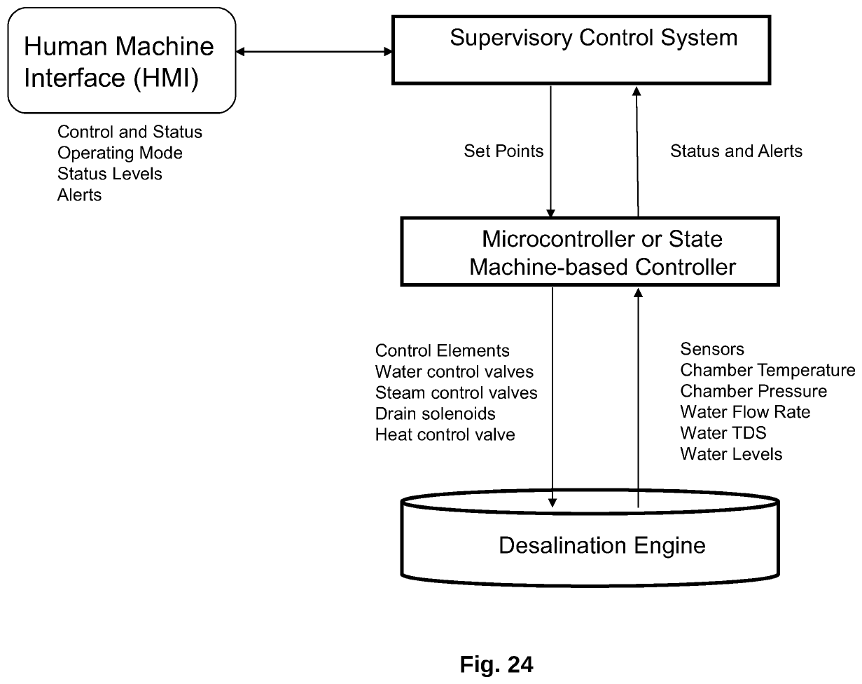

One embodiment of a control system is shown in FIG. 24. For example, the system can include a human machine interface (HMI) that can involve control and status, operating mode, status levels and alerts. The HMI can be associated with a supervisory control system that can involve set points. The supervisory control system can be associated with a microcontroller or state machine-based computer that can involve one or more control elements, water control valves, steam control valves, drain solenoids, and/or heat control valves. The microcontroller or state machine-based computer can associate with a desalination engine. The engine and the controller can involve sensors, chamber temperature, chamber pressure, water flow rate, water TDS, water levels, etc. The microcontroller and the supervisory control system can involve statuses and alerts.

### Sensors

The system can have multiple sensors, including temperature sensors, pressure sensors, liquid level sensors, flow sensors, conductivity probes, ion selective electrodes, colorimetric sensors, spectroscopic sensors, weight scales, viscosity sensors and other typical sensors in chemical plants. The system can have valves and pumps that are manually or automatically operated. The system can have sampling ports. The system's control unit can operate the pumps and valves, turn power on or off to devices in the system, send alarms to operators, and provide feedback to the operator about the system's status. The control system can also record data automatically.

The following discussion is aided by reference to FIG. 24 which is an example of a control system and operation mode for a water purification or feedwater concentration system. Control systems for this and other embodiments can be tailored to the specific needs of the application at hand.

In this example, when the main power switch is energized, the control circuitry determines start-up procedures and, subsequently, continuous operation. Initially, power is delivered to the intake pump that begins to send feedwater to the entire system at a constant flow rate. The user inputs include “start,” “pause/hold,” stop, and maintenance mode, and the user status can show the operating mode and sensor status either via a display, a remote terminal, or via the Internet. The sensor inputs include preheater temperatures, evaporation chamber temperatures, degasser temperatures, demister temperatures, inlet feedwater turbidity (total dissolved solids), purified water turbidity (total dissolved solids), concentrate quality (e.g. total dissolved solids), purified water tank level, and leak detection. At startup, a temperature sensor at the preheater detects temperatures lower than necessary for effective degassing, which activates solenoid valves that divert the output of all condenser chambers to a waste drain. Simultaneously, the same temperature sensor activates an energy-input switch that activates energy input into the energy input vessel. Depending on what heat source is being used, the input switch can turn on power to electric coils, turn on fuel supplies, open steam valves, ignite burners, or switch on a waste heat supply, or any combination of these actions, etc.

As the system comes up to temperature, the sensor in the preheater reaches effective degassing temperature, at which point the control system activates a solenoid valve that closes the drainage of all condenser chambers and allows the collection and eventual delivery of purified water.

The control circuitry includes a number of safety features, all of which can turn power off to the system while activating a warning lights or audible signals. Conductivity sensors located at the purified water outlet continuously monitor water quality and alert or turn off the system if such quality deteriorates past a pre-determined point. Operation states can include water quality alerts, water quality errors, and operating modes such as startup, normal, maintenance, and off. External system control can be enabled by source feedwater flow or by evaporation chamber heat. Similarly, in one embodiment, a temperature sensor at the energy input vessel prevents overheating of the system. A conductivity probe located at the waste drain stream measures the concentration of the waste concentrate and shuts off the system if such concentration exceeds the solubility limit of solutes so as to prevent crystallization problems inside the system. Similar control systems could be developed for use with brine/solution concentration systems where the final concentration of the concentrate output provides one of the primary control parameters.

### Stage Description

In some embodiments, only one water-producing or feedwater concentrating stage is necessary. In other embodiments, multiple stages of boiling and condensation can be provided, thus recycling heat for multiple stages of distillation. Each stage can include an evaporation chamber, a demister, a condenser chamber, and multiple heat pipes, all identical to those described above. Other embodiments can have no demisters. Other embodiments can have a single heat pipe. Other embodiments can have a different number of heat pipes or different types of heat pipes in the different stages, or a combination of a different number and different types.

In a further aspect, the system includes heat pipes for cooling a condenser chamber product.

In a further aspect, purified water exits a condenser chamber through the purified water outlet.

In a further aspect, concentrate exits the system through the concentrate outlet.

In a further aspect, the control system diverts purified water to waste drainage until the system reaches stable operating temperatures, pressures and purified water or concentrate quality.

### Energy Input Vessel

To get energy into the system, an energy input vessel is used. Energy supplied to this vessel can be in the form of electrical energy, steam, solar energy, the energy from chemical reactions, geothermal energy, molten salts, the energy from the combustion of fuels such as natural gas, petroleum, or other hydrocarbon fuels, other sources of heat, including waste heat from industrial, chemical, power generation, or commercial operations.

In a further aspect, the energy input vessel further includes electric heating elements, fuel burners, and/or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, and/or the combustion of oil, hydrocarbons, biofuels, alcohols, or natural gas, and wherein the energy input vessel is connected thermally to an evaporation chamber by the heat pipes.

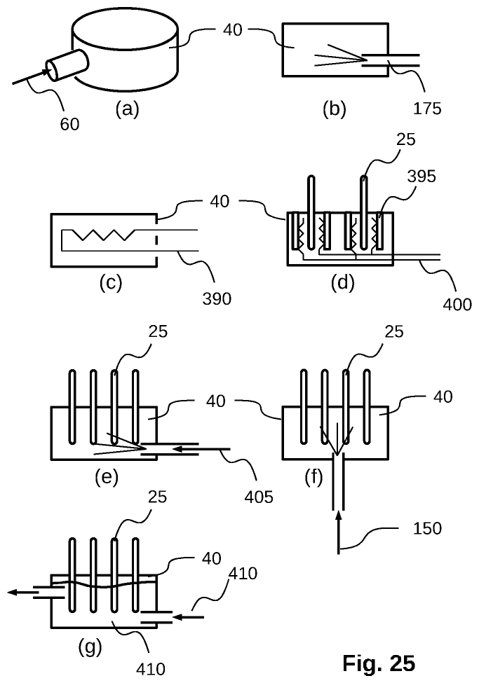

Several embodiments are shown in FIG. 25 illustrating various different configurations for providing energy. Energy for distillation is provided by an energy input vessel 40 positioned proximate to an evaporation chamber FIG. 25(a) illustrates the fact that the subject of this invention is energy agnostic. The proposed system for desalination or feedwater concentration can use any form of energy as energy source 60, including electricity, natural gas, oil or hydrocarbons, steam, flue gas, solar, geothermal, chemical and chemical reaction energy, waste heat, thermal fluid or other industrial heat sources. FIG. 25(b) illustrates the simplest configuration, consisting of either an oil or a gas burner 175. Heat is transferred into a proximate evaporation chamber by thermal conduction FIG. 25(c) depicts an electric heater, provided with a power supply and a resistive heater 390. Heat is transferred into a proximate evaporation chamber by thermal conduction. FIG. 25(d) illustrates resistive heating, using resistive heaters 390 surrounded by an insulating sleeve 395 and connected to a power source 400, and heat pipes 25 that subsequently transfer the heat into an evaporation chamber. And FIG. 25(e) illustrates the utilization of waste heat or other heat sources 405 by using heat pipes 25 to transfer the heat into an evaporation chamber. FIG. 25(f) illustrates the use of a source of steam 140 along with heat pipes 25 to transfer the heat into an evaporation chamber. FIG. 25(g) illustrates the use of a thermal fluid 410 along with heat pipes 25 to transfer the heat into an evaporation chamber.

### Exemplary Methods

In some embodiments, the present disclosure relates to methods of purifying, desalinating and/or concentrating feedwater. While this section of this disclosure is labeled “Exemplary Methods” and sets forth to describe certain methods of applying the concepts disclosed throughout this document, it is explicitly stated that the various methods and steps disclosed in this section are not limiting on the invention or what may be encompassed in one or more method claims. The exemplary methods of certain embodiments of the invention can include the steps of: providing a source of inlet feedwater including at least one contaminant in a first concentration; passing the inlet feedwater through a preheater capable of raising a temperature of the inlet feedwater above that required for efficient degassing; stripping the inlet feedwater of essentially all organics, volatiles, and gasses by counter flowing the inlet feedwater against an opposite directional flow of a gas in a degasser; maintaining the water in an evaporation chamber for an average residence time of between less than one minute to 90 minutes, or longer under conditions permitting formation of steam; discharging steam from the evaporation chamber to a demister, separating clean steam from contaminant-containing waste mist droplets in the demister such that yield of clean steam is at least about 2 times greater than the yield of waste from the demister; condensing the clean steam to yield purified water, having the at least one contaminant in a second concentration; and recovering and transferring heat from a condenser chamber into an evaporation chamber or preheater, such that the amount of heat recovered is at least 20% to 95% or more of the heat of condensation.

### Contaminants

In some embodiments, the feed water contains at least one contaminant selected from the group consisting of: microorganism, radionuclide, salt, and organic, and wherein the second concentration is not more than a concentration shown in Table 4, and wherein the first concentration is at least about 10 times the second concentration.

TABLE 4
EXEMPLARY CONTAMINANTS FOR SYSTEM VERIFICATION

| | MCLG¹ | |
|---|---|---|
| 1. Metals & Inorganics | | |
| Asbestos | <7 | MFL² |
| Free Cyanide | <0.2 | ppm |
| Metals - Al, Sb, Be, B, Fe, Mn, Mo, Ni, Ag, Tl, V, Zn | 0.0005 | ppm |
| Anions - N0₃- N, NO₂- N, Cl, SO₄, | <1 | ppm |
| Total Nitrate/Nitrite | | |
| Turbidity | <0.3 | NTU |
| 2. Organics | | |
| Volatile Organics - VOASDWA list + Nitrozbenzene | | |
| EDB & DBCP | 0 | ppm |
| Semivolatile Organics - ML525 list + EPTC | <0.001 | ppm |
| Pesticides and PCBs | <0.2 | ppb |
| Herbicides - Regulated/Unregulated compounds | <0.007 | ppm |
| Glyphosate | <0.7 | ppm |
| Diquat | <0.02 | ppm |
| Dioxin | 0 | ppm |
| 3. Radiologicals | | |
| Gross Alpha & Beta | <5 | pCi/l³ |
| Radium 226 | 0 | pCi/l³ |
| Uranium | <3 | ppb |
| 4. Disinfection By-Products | | |
| Chloramines | 4 | ppm |
| Cyanogen Chloride | 0.1 | ppm |

| | |
|---|---|
| 5. Biolosicals | |
| Cryptosporidium | O [symbol] |
| Giardia Lamblia | O [symbol] |
| Total coliforms | O⁴ |

¹MCLG = maximum concentration limit guidance
²MFL = million fibers per liter
³pCi/l = pico Curies per liter
⁴Substantially no detectable biological contaminants [symbol]
indicates data missing or illegible when filed

In a further aspect, the first concentration is at least about 25-fold greater than the second concentration.

In a further aspect, the second concentration is less than the amount permissible by the EPA or other industry specifications for the industry in which the system is operating.

In a further aspect, the gas is selected from the group consisting of: steam, air, methane, CO2, argon, helium, nitrogen, natural gas, flue gas, and flare gas and mixtures thereof.

### Self Cleaning

In some embodiments, the process steps are repeated automatically for at least about one day with no required cleaning or maintenance. In a further aspect, the process steps are repeated automatically for at least one week with no required cleaning or maintenance. In a further aspect, the process steps are repeated automatically for at least one month with no required cleaning or maintenance. In a further aspect, the process steps are repeated automatically for at least three months with no required cleaning or maintenance. In a further aspect, the process steps are repeated automatically for at least about one year with no required cleaning or maintenance. In a further aspect, the system can be cleaned, one stage at a time, or multiple stages at a time, in such a manner that the entire water treatment system does not have to be shut down for the maintenance.

### Arrangement of Chambers

In some embodiments, a stacked arrangement of the evaporation chambers, condenser chambers, and preheater is enclosed in a metal shell, with perforated plates that separate evaporation chambers and condenser chambers.

In a further aspect, the perforated plates allow the passage of heat pipes, degassers, demisters, concentrate overflow tubes, and waste stream tubes.

In a further aspect, a stacked arrangement of the evaporations chambers, condenser chambers, and preheater is constructed of separate stages, each stage consisting of: an evaporation chamber, perforated plate with heat pipes, and a condenser chamber; or an evaporation chamber, a perforated plate with heat pipes and an energy input vessel, or a condenser chamber, a perforated plate with heat pipes, and a preheater.

In a further aspect, the arrangement is vertical, horizontal or at an angle between vertical and horizontal.

### Materials of Construction

In some embodiments, the materials of construction of evaporation chambers, preheaters, and heat pipes are made from a non-corroding titanium alloy.

In a further aspect, the non-corroding titanium alloy is Ti-CP1 alloy.

In a further aspect, the evaporation chambers, preheaters, and heat pipes are fabricated from one or more of: common steel, stainless steel alloys, nickel alloys, copper alloys, titanium alloys, or other corrosion resistant alloys or other metal or metal alloys coated with non-corroding chlorofluorocarbon or other non-corroding polymers.

### Operating Under Vacuum

In some embodiments, the system can beneficially function under nonstandard environmental conditions such as, for example, with some or all of the stage pressures under vacuum. At less than atmospheric pressure, the boiling point of water, including saline water or seawater is less than 100° C. This lower temperature has two basic effects. The first is that scale formation is much reduced at the lower temperature. The second is that the heat of vaporization/condensation of the solution is greater, which means that more energy can be transferred from condenser chamber to boiler for the same amount of steam. In such embodiments, it is evident that preheat temperatures can also be affected. Given lower evaporation chamber temperatures and lower condenser chamber temperatures, preheating to a desired temperature can be achieved by permitting shorter residence time of water in the preheater such as, for example, by configuring the preheater to have a smaller volume with an identical flow rate, or a higher flow rate with an identical volume. In other cases, because of the lower stage temperatures, minimal or no preheating would be needed.

Combination with Other Devices

In some embodiments, the system for purifying water, embodiments of which are disclosed herein, can be combined with other systems and devices to provide further beneficial features. For example the system can be used in conjunction with solar alignment systems and devices. For example, the system can be used in conjunction with any of the devices or methods disclosed in U.S. Provisional Patent Application No.: 60/676870 entitled, SOLAR ALIGNMENT DEVICE, filed May 2, 2005; U S Provisional Patent Application No.: 60/697104 entitled, VISUAL WATER FLOW INDICATOR, filed Jul. 6, 2005; U.S. Provisional Patent Application No.: 60/697106 entitled, APPARATUS FOR RESTORING THE MINERAL CONTENT OF DRINKING WATER, filed Jul. 6, 2005; U.S. Provisional Patent Application No. 60/697107 entitled, IMPROVED CYCLONE DEMISTER, fried Jul. 6, 2005; PCT Application No: US2004/039993, filed Dec. 1, 2004; PCT Application No: US2004/039991, filed Dec. 1, 2004; PCT Application No US06/40103, filed Oct. 13, 2006, PCT Application No. US06/40553, filed Oct. 16, 2006; PCT Application No. US2007/005270, filed Mar. 2, 2007, PCT Application No. US2008/003744, filed Mar. 21, 2008, U.S. Provisional Patent Application No.: 60/526,580, filed Dec. 2, 2003; and U.S. Provisional Patent Application No.: 62/456,064, filed Feb. 7, 2017; each of the foregoing applications is hereby incorporated by reference in its entirety.

One skilled in the art will appreciate that these methods and devices are and may be adapted to carry out the objects and obtain the ends and advantages mentioned, as well as various other advantages and benefits. The methods, procedures, and devices described herein are presently representative of some embodiments and are exemplary and are not intended as limitations on the scope of the invention. Changes therein and other uses will occur to those skilled in the art which are encompassed within the spirit of the invention and are defined by the scope of the disclosure.

### Outside Configurations

System with Vacuum

In some embodiments, it may be desirable to run the system with one or more of the evaporation chambers at a temperature such that scale does not form in the chamber as a result of the evaporation of the feedwater in the chamber. The temperatures for the prevention of scale formation are usually below the standard boiling point of water, i.e. 212° F. (100° C.). One way to achieve the lower temperatures and still have boiling in the evaporation chambers is to create a vacuum in the chambers. By selecting the proper vacuum levels, the boiling temperatures in the chambers can controlled to stay below the temperature at which scale formation occurs.

For such systems, the top brine/concentrate temperature of all stages under vacuum will be <212° F., or less than the temperature at which scale formation occurs for the particular feedwater being treated.

Another benefit of using vacuum is that is allows for more stages in the system at the same top brine/concentrate temperature.

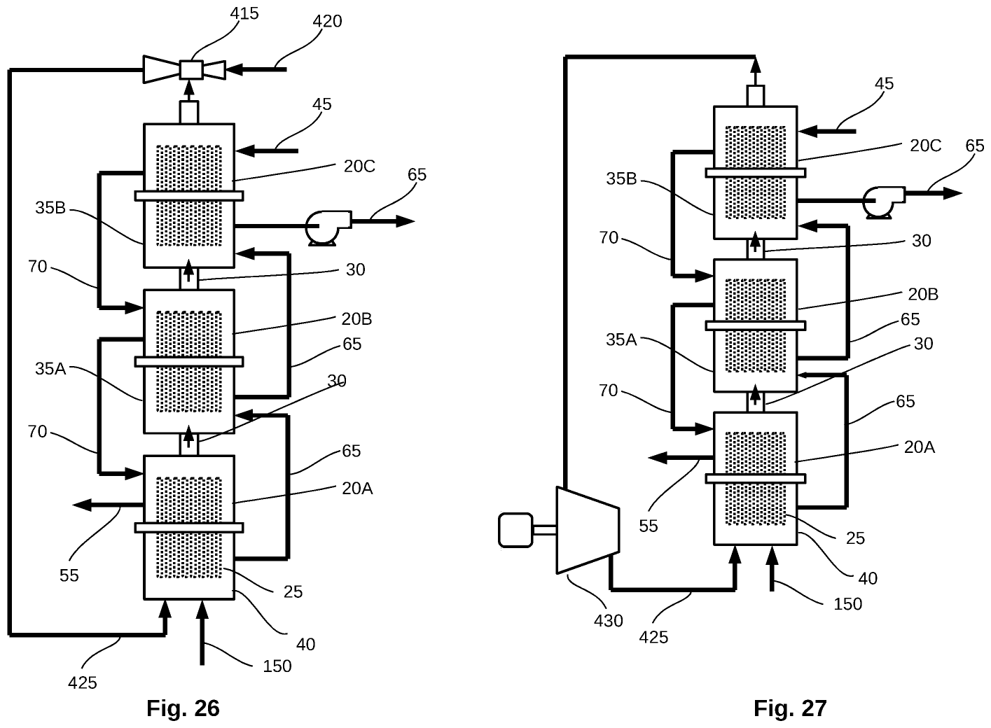

Vacuum generation can be implemented using vacuum pumps, vacuum ejectors, or condenser chambers or a combination of these components. FIG. 26 shows one embodiment of a system operating under vacuum. In this embodiment, the evaporation chamber at the top of the stack 20C generates steam which is fed to a steam ejector 415. In the ejector the steam from the evaporation chamber mixes with motive steam 420, which is at a higher temperature and pressure, which creates steam 425 at a high enough temperature and pressure to feed energy input vessel 40. This “recompressed” steam 425 combines with steam 150 from another source to provide enough energy to the condenser chamber 40 to drive the system. The steam ejector 415, creates a vacuum condition in the evaporation chamber 20C. Boiling occurs, but at a temperature that is low enough to avoid scale formation. The lower temperature of the top evaporation chamber results in lower temperatures in all of the evaporation chambers and condenser chambers of the system. The steam ejector system is a Thermal Vapor Compression (TVC) system.

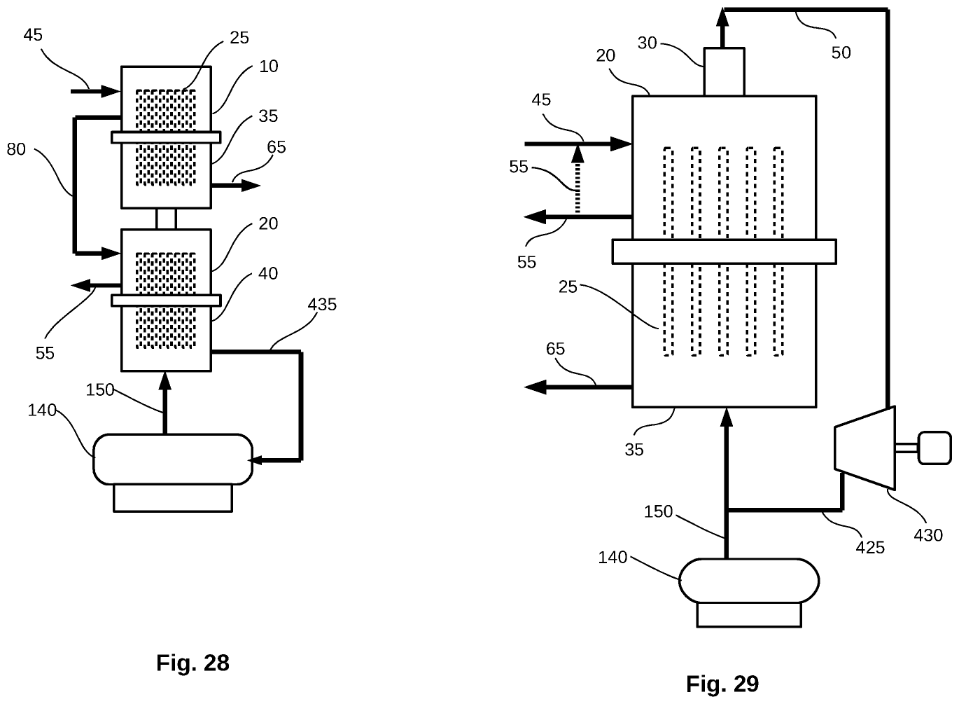

FIG. 27 shows an embodiment similar to FIG. 28, except instead of using TVC, Mechanical Vapor Compression (MVC) 430 is used to compress the steam for reuse. The MVC again creates a vacuum in the evaporation chamber 20C, creating lower temperatures throughout the system and helping to prevent scale formation.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or the concentrate or both from stage to stage.

In a further aspect, feedwater, or concentrate, or both is moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating comes from the lowest temperature evaporation chamber.

In a further aspect, the steam for recompression or reheating comes from one or more of the intermediate temperature evaporation chambers.

In a further aspect the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and a condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has a pretreatment system.

In a further aspect, the system has no pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feed water or concentrate is sprayed onto the beat pipes in one or more of the evaporation chambers.

In a further aspect, steam is the source of energy for the energy input vessel.

In a further aspect, the energy input vessel includes electric heating elements, fuel burners, or heat pipes that transfer heat from electricity, solar energy, chemical reactions, nuclear reactions, geothermal sources, molten salts, waste heat from industrial and other processes, flue gases, solid waste energy, heated thermal fluids, microwaves, or the combustion of oil hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flow exiting the system or both.

In a further aspect, a portion of the final concentrate exiting the system is cycled back into the system with the feed water to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g. Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with Steam Recompression

In certain embodiments of the invention, steam is taken from a stage and its pressure increased so that it can be re-injected back into a previous stage and used again to drive the system. Alternatively some steam from the system can be “reheated” to increase its temperature and pressure and again, re-injected back into a previous stage and used again. Such steam “recompression” or “reheating” is done because recompressing steam or reheating steam takes less energy to reach a certain temperature and pressure than creating new steam from liquid water. The energy of the steam still needs to be increased to reach the desired temperature and pressure, but the energy of vaporization does not have to be added on top of that. FIG. 26 shows such a system using thermal vapor compression. FIG. 27 shows such a system using mechanical vapor compression. These can be operated with the compression systems creating vacuums as described previously, or with all of some of the system's evaporation chambers and condenser chambers operating above atmospheric pressure.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chamber and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the steam recompression system is mechanical vapor compression (MVC) or thermal vapor compression (TVC).

In a further aspect, the steam for recompression/reheating comes from the lowest temperature evaporation chamber.

In a further aspect, the steam for recompression/reheating comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flow exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with a Single Water Producing Condenser Chamber

One embodiment of the system includes a single purified water producing condenser chamber. In this configuration, the capital costs of the system can be minimized. The top brine/concentrate/solution temperature is also minimized. FIG. 28 shows one such embodiment in which a steam generator 140 is used to drive the system through the energy input vessel 40. Feedwater 45 is fed into the preheater 10. The preheated feedwater 80 is then fed to the evaporation chamber 20. The condenser chamber 35 produces the purified water. Condensate 435 from the energy input vessel 40 is feed back to the steam generator 140 to save water and energy. In this embodiment, heat pipes or other phase change heat transfer devices are used in all of the stages and in the energy input vessel.

A single-stage feedwater concentrator could also be designed. In such a system, feedwater would be sent directly to the evaporation chamber of the energy input vessel. No purified water would be produced. However a concentrate would be produced as the evaporation chamber boiled the feedwater using energy from the energy input vessel. This energy would be transferred into the evaporator using heat pipes or other phase change heat transfer devices.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both.

In a further aspect, feedwater or concentrate or both are moved from by gravity.

In a further aspect, feedwater or concentrate or both are moved using the pressure differential between the stage and the ambient atmosphere caused by the difference in their temperatures.

In a further aspect, the system includes a device for steam recompression or steam reheating or both.

In a further aspect, the steam recompression system is mechanical vapor compression (MVC) or thermal vapor compression (TVC).

In a further aspect, condensate from the energy input vessel is recycled to a steam generator.

In a further aspect, condensate from the energy input vessel is combined with the purified water from the water producing condenser chamber.

In a further aspect, the stages are stacked vertically.

In a further aspect, the stages are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feedwater.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, the condenser is below the corresponding evaporation chamber.

In a further aspect, the condenser is above the corresponding evaporation chambers.

In a further aspect, some of the condenser chambers are below and some of the condenser chambers are above their corresponding evaporation chambers.

In a further aspect, the condenser includes a steam jet or jets.

In a further aspect, the condenser does not include a steam jet or jets.

In a further aspect, the steam jet or jets rotate.

In a further aspect, the evaporation chamber operates with pool boiling.

In a further aspect, feed water or concentrate is sprayed onto the heat pipes in the evaporation chamber.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal ceramic, or metal-ceramic composite coatings deposited on the walls of the vessels to protect the vessels from corrosion.

In a further aspect, heat plates form some or all of the walls of the system.

### Heat Pipes in a Vapor Compression Evaporator

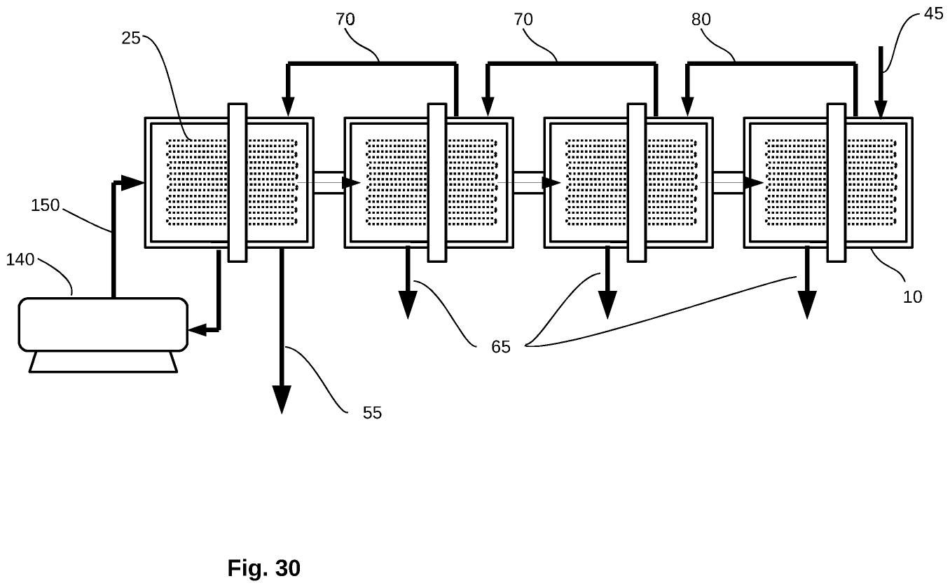

One embodiment of the system includes a variation of a vapor compression evaporator in which the heat transfer is done using heat pipes rather than the standard falling or rising films and tubes. This system has a single stage with steam recompression and often includes concentrate recycling. FIG. 29 shows such as system. Feedwater 45 is fed into the evaporation chamber 20 where steam is produced. After going through the demister, the clean steam 50 is sent to the mechanical vapor compressor 430 where its temperature and pressure are raised. This recompressed steam is combined with steam 150 from a steam generator 140 or from another steam source. Purified water is condensed in the condenser 35 and exits the system. Concentrate 55 exits the evaporation chamber. Some of the concentrate can be recycled to join the feedwater in order to enable the system to produce a more concentrated final concentrate 55.

In a further aspect, the system operates with the vessel pressures at atmospheric pressure or above.

In a further aspect, the system operates with the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both

In a further aspect, feedwater or concentrate or both are moved from by gravity.

In a further aspect, feedwater or concentrate or both are moved using the pressure differential between vessels caused by the differences in vessel temperatures.

In a further aspect, the system includes a device for steam recompression or steam reheating or both.

In a further aspect, the steam recompression system is mechanical vapor compression (MVC) or thermal vapor compression (TVC).

In a further aspect, condensate from the energy input vessel is recycled to a steam generator.

In a further aspect, the system is in a horizontal orientation.

In a further aspect, the system is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to reheat feedwater.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, the condenser is below its corresponding evaporation chamber.

In a further aspect, the condenser is above its corresponding evaporation chamber.

In a further aspect, the condenser includes a steam jet or jets.

In a further aspect, the condenser does not include a steam jet or jets.

In a further aspect, the steam jet or jets rotate.

In a further aspect, the evaporation chamber operates with pool boiling.

In a further aspect, feed water or concentrate is sprayed onto the heat pipes in the evaporation chamber.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g. Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

In a further aspect, the feed water can be “seeded” to create scale onto which additional scale formed during the evaporation process will attach.

### System in Horizontal Configuration

FIG. 30 shows an embodiment in which the stages are arranged with the heat pipes 25 (or other heat transfer devices), evaporation chambers, and condenser chambers in a horizontal position. Feedwater 45 is introduced into the preheater, sprayed onto the heat pipes, and passed from evaporation chamber to evaporation chamber as preheated feedwater 80, and intermediate concentrate 70. Purified water 65 is removed from the condenser of each stage and final concentrate 55 is removed from the final evaporation chamber. A steam generator 140 supplies energy to the system in the form of steam 150. Condensate from the energy input vessel returns to the steam generator.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feed water or concentrate or both from stage to stage.

In a further aspect, feedwater or concentrate or both are moved from evaporation chamber to evaporation chamber by gravity.

In a further aspect, feedwater or concentrate or both are moved from evaporation chamber to evaporation chamber using the pressure differential between evaporation chambers caused by the differences in evaporation chamber temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted the same distance from the heat pipe end to the perforated plate.

In a further aspect, the heat pipes are mounted at different distances from the heat pipe end to the perforated plate.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

### Inside Configurations

System with Water Spray/Film Boiling

Feedwater or intermediate concentrate can be sprayed onto heat pipes, thermosiphons, loop heat pipes, etc. instead of having those elements sit in a pool of the feedwater or intermediate concentrate. In these embodiments, the spray of feedwater or intermediate concentrate is directed onto the heat pipes in the evaporation chamber to create a film boiling or an evaporation condition.

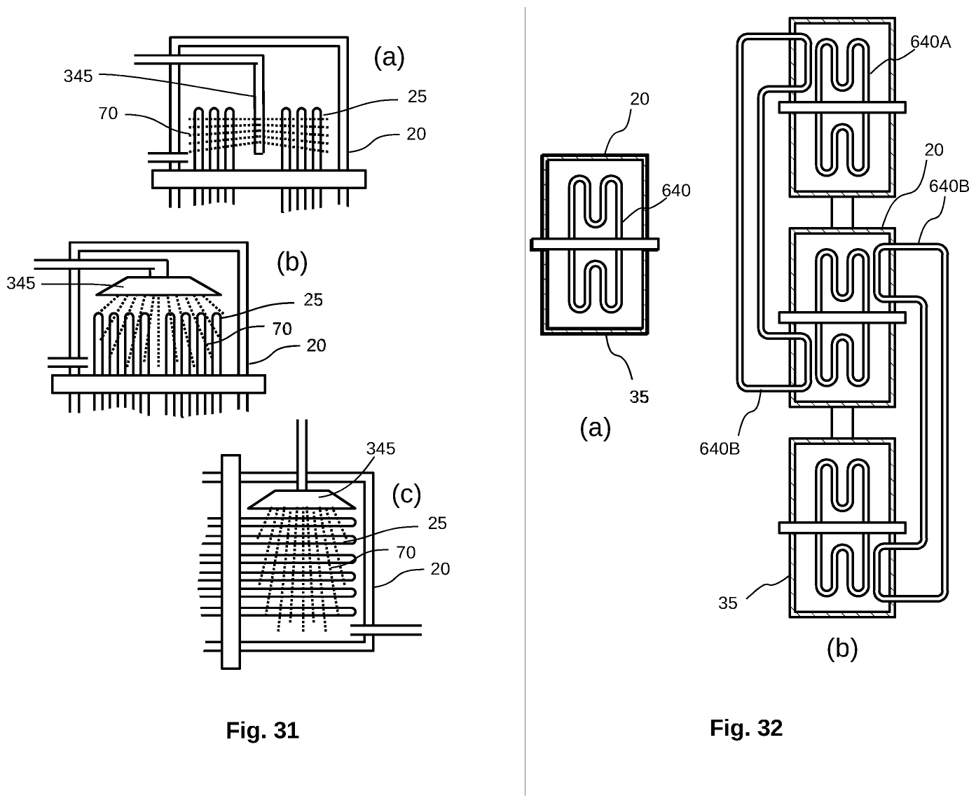

FIG. 31(a) shows an embodiment in which a spray of intermediate concentrate 70 inside an evaporation chamber 20 is directed horizontally onto the heat pipes 25 through a sprayer 345. FIG. 31(b) shows an embodiment in which a “shower head” type of spreader 345 is used to spray the feedwater or intermediate concentrate 70 over the array of heat pipes 25. FIG. 31(c) shows a similar configuration with a horizontal arrangement of evaporation chamber and condenser.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the condenser chambers.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with Loop Heat Pipes

FIG. 32(a) shows an embodiment of the invention in which loop heat pipes 640 are arranged, one per stage, running between the stage condenser chamber 35 and the stage evaporation chamber 20.

FIG. 32(b) shows a second embodiment of the invention in which loop heat pipes not only run from condenser chambers 35 to their corresponding evaporation chambers 20, but also from condenser chambers 35 to one of the previous evaporation chambers 20 in order to make water production at all stages more alike. Note: These embodiments are exemplary and not meant to limit the spirit of the invention.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from evaporation chamber to evaporation chamber using the pressure differential between evaporation chambers caused by the differences in evaporation chamber temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one vessel.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with Angled Heat Pipes

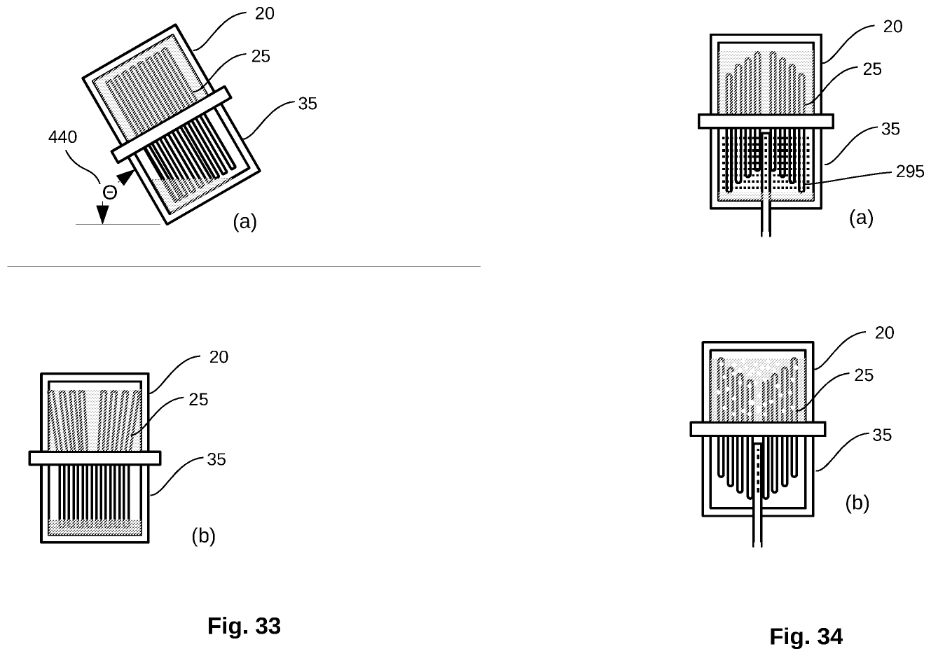

In some embodiments, some forms of heat pipes work more effectively when they are at an angle that is somewhat off of vertical. FIG. 33(a) shows one such embodiment of the invention. In this embodiment, heat pipes 25 are arranged at an angle off of the vertical by tilting the entire stage (evaporation chamber 20 and condenser 35) at an angle θ 440. In another embodiment, the heat pipes in the stage are mounted at an angle off of vertical. In another embodiment. FIG. 33(b), the heat pipes are formed into a splayed arrangement in the evaporation chamber 20 or preheater.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the stages individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature stages.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back, into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with Heat Pipes at Different Heights

In some embodiments of the system, heat pipes can be arranged so that they are at different heights in the evaporation chamber, either with the center heat pipes higher or lower, or at some random arrangement, or in an ordered arrangement, e.g. alternating rows. FIG. 34(a) shows the heat pipes 25 mounted with the ones in the center being higher in the evaporation chamber 20 than those further out. In this configuration, the steam spray 295 from the steam jet can more easily reach the outer rows of heat pipes in the condenser 35. FIG. 34(b) shows a configuration with the heat pipes 25 in the center lower than those further out. With the heat pipes lower in the center of the evaporation chamber 35, bubbles formed in the central section of the chamber can more easily float to the top without drying out adjacent heat pipes.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are of different lengths.

In a further aspect, the heat pipes are all the same length.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

System with Alternate Steam Injector

In some embodiments of the system, steam injectors or jets direct the steam towards the heat pipes in the condenser chambers in order to increase the heat transfer between the steam and the heat pipes.

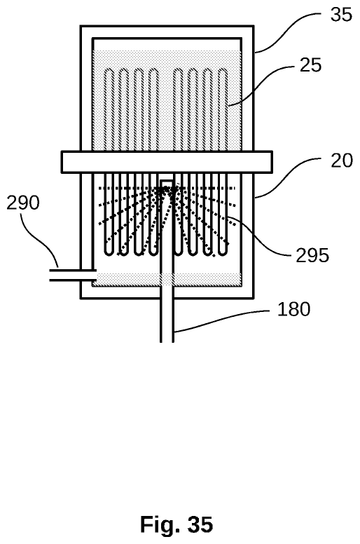

In one embodiment (see FIG. 35), the jet 180 is located at the top of condenser 20 and directs the steam spray 295 across and down the heat pipes 25 to help move the condensate drops off of the heat pipes, making more surface available for heat transfer. In other embodiments, there can be multiple steam jets to help distribute the steam throughout the condenser. In other embodiments, there can be multiple outlets from the jets to spread steam across the heat pipes.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feed water or concentrate or both are moved from stage to stage using the pressure differential between stages caused by the differences in stage temperatures.

In a further aspect, purified water is sent from condenser chamber to condenser one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, only some of the condenser chambers include a steam jet or jets.

In a further aspect, the steam jet or jets rotate.

In a further aspect, the evaporation chambers operate with pool boiling.

In a further aspect, feedwater or concentrate is sprayed onto the heat pipes in one or more evaporation chambers.

In a further aspect, steam is the source of energy for the energy input vessel.

In a further aspect, the energy input vessel includes electric heating elements, fuel burners, or heat pipes that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat pipes.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat pipe or pipes are mounted perpendicular to the perforated plate.

In a further aspect, the heat pipe or heat pipes are mounted at a non-ninety degree angle to the perforated plate.

In a further aspect, the heat pipes are splayed.

In a further aspect, the heat pipes are all mounted at the same height.

In a further aspect, the heat pipes are mounted at different heights.

In a further aspect, the heat pipes are of different lengths.

In a further aspect, the heat pipes are all the same length.

In a further aspect, the system includes loop heat pipes of different lengths.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

### Designs for Mounting Heat Pipes in a Process Containment Enclosure

In some embodiments, heat pipes and/or thermosiphons can be used in applications where the heat pipe must pass through the wall of a process vessel or enclosure. The wall separates fluids, liquids, vapors or combinations of liquids and vapors at different temperatures and pressures.

In one embodiment, the enclosure is a pressure vessel. The pressure vessel can be fabricated with metallic or non-metallic elements, or a combination of the two. The pressure vessel can be characterized as fired or unfired, depending on operating conditions. The pressure vessel may contain a fluid, vapor, or a combination of the two phases. The temperatures and pressures inside the pressure vessel are different from the ambient temperature and pressure.

In another aspect, the process enclosure is a metallic or non-metallic fluid duct. The fluid can be liquid, gaseous, or a mixture of the two phases.

In another aspect, the wall can be skin of an aircraft fuselage, or the hull of a ship.

Heat pipe mounting hardware serves several functions, including but not limited to—

1. Mechanical support.

2. A liquid-tight or vapor-tight environmental seal between opposing sides of the enclosure wall.

3. Preventing the contact between dissimilar metals or alloys.

Mounting methods are shown in cross section views in figures.

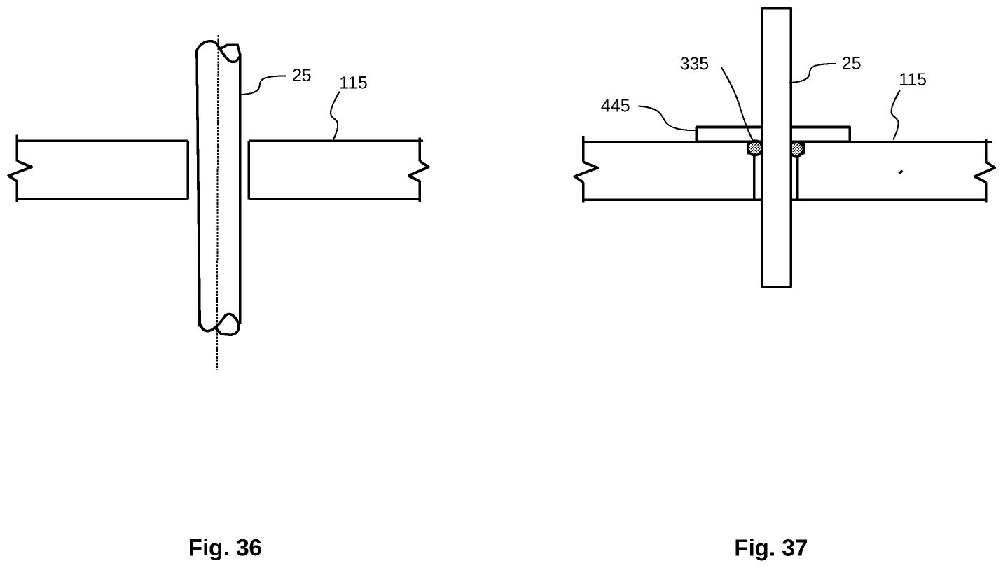

FIG. 36 shows the heat pipe 25 and a perforated plate 115. The heat pipe can have a circular or non-circular cross section.

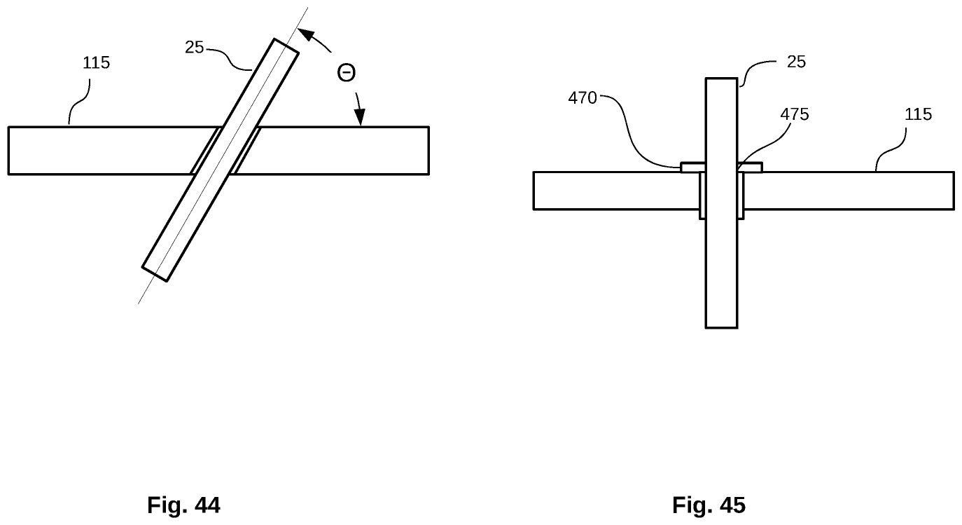

The heat pipe 25 can be mounted perpendicular to the mounting surface (perforated plate 115) as shown in FIG. 43, or at any angle θ to the mounting surface (perforated plate 115) as shown m FIG. 44.

FIG. 37 shows the heat pipe 25, the wall or perforated plate 115 with a machined recess to hold a compliant seal 335 held in place by a retainer 445.

In another aspect the compliant seal is held in place by a machined groove.

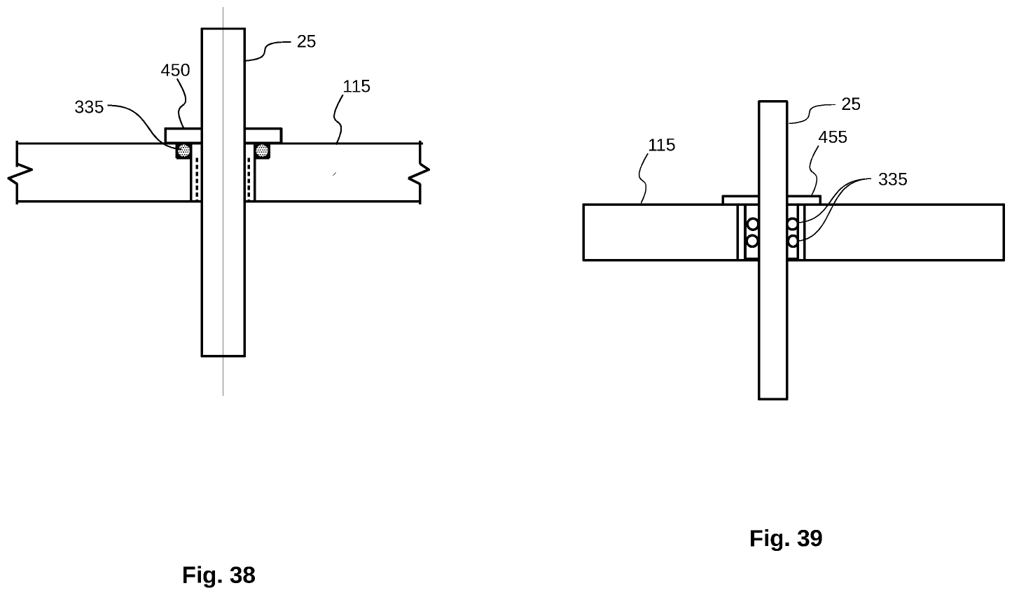

FIG. 38 shows the heat pipe 25 held by a threaded insert 450 assembled into the threaded wall or perforated plate 115. The threaded insert 450 holds the compliant seal 335.

In another aspect the threaded insert 450 is welded or brazed to the heat pipe 25.

In another aspect the threaded insert 450 is injection molded around the heat pipe 25.

In another aspect the threaded insert 450 is fabricated from a non-conductive material to electrically isolate the heat pipe 25 from the wall or perforated plate 115.

In another aspect the threads on the threaded insert 450 forms the liquid- and gas-tight seal.

FIG. 39 shows the heat pipe 25 electrically isolated from the perforated plate 115 by an insulating sleeve 455. The heat pipe 25 is sealed by one or a multiplicity of compliant seals 335.

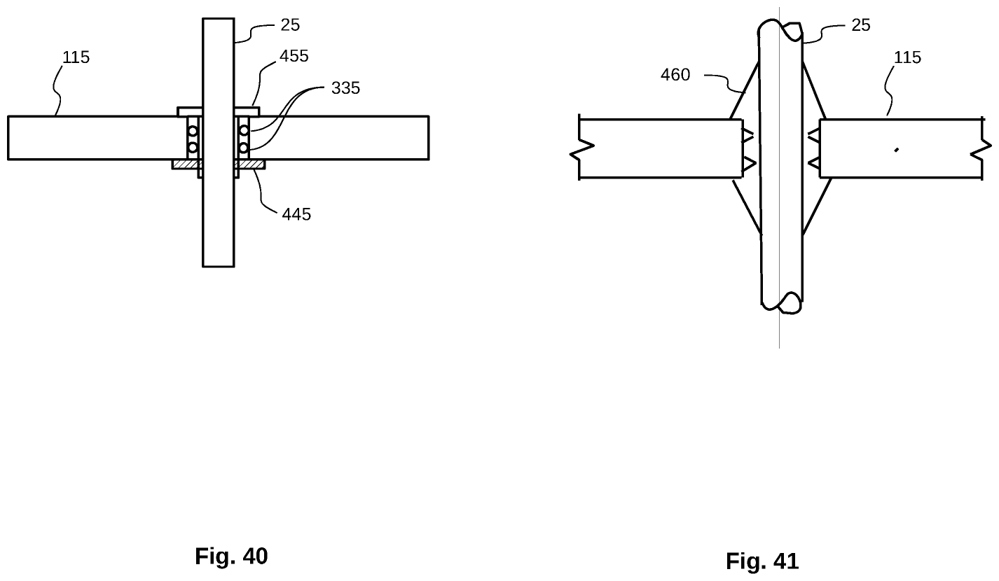

FIG. 40 shows another aspect where the heat pipe 25 is held by the insulating sleeve 455. The insulating sleeve 455 is sealed by one or a multiplicity of compliant seals 335. The insulating sleeve 455 is held in place by retainer 445 by means of a friction fit.

In another aspect, the insulating sleeve 455 is threaded, and held in place by a threaded retainer 445.

FIG. 41 shows heat pipe 25 held, sealed and insulated by a sleeve 460 inserted into perforated plate 115 or wall.

In another aspect, sleeve 460 is molded around heat pipe 25.

In another aspect, sleeve 460 is molded into the openings in wall or perforated plate 115.

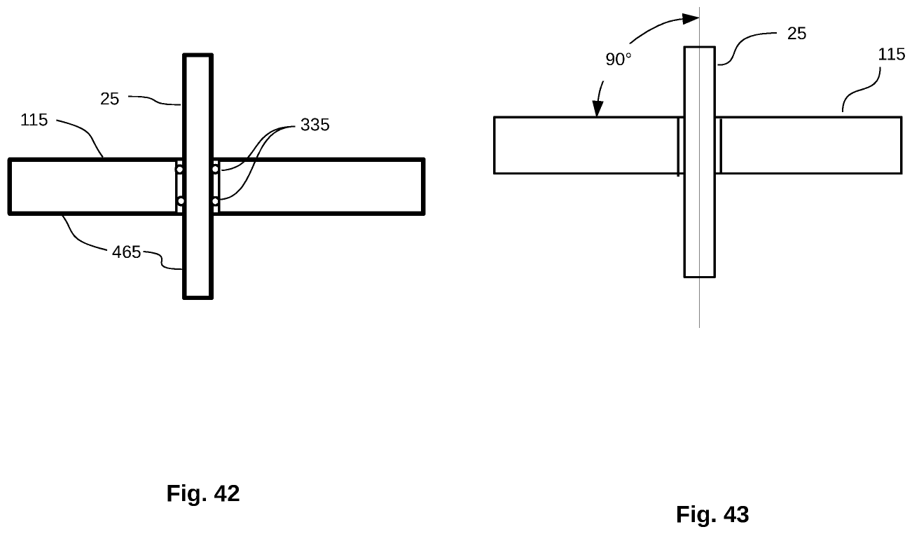

FIG. 42 shows the heat pipe 25 and the perforated plate 115 or wall coated with the same coating material 465 to eliminate the corrosion potential of an electro-chemical cell. The coating material 465 can be applied by a multiplicity of processes, including, but not limited to, electroplating, painting, flame spraying, and vapor deposition.

FIG. 45 shows a sleeve 470 fixed to the heat pipe 25 by a metallic connection including, but not limited to, welding, brazing, or soldering with various metals, alloys, or combinations of metals and alloys.

In another aspect, the sleeve 470 is fixed to the heat pipe 25 by a dimensional interference press fit.

In another aspect, the sleeve 470 is fixed to the heat pipe 475 by a non-metallic material or mixture.

The sleeve 470 is fixed to the wall or perforated plate 115 by a metallic or non-metallic connection, or dimensional interference press fit as noted above.

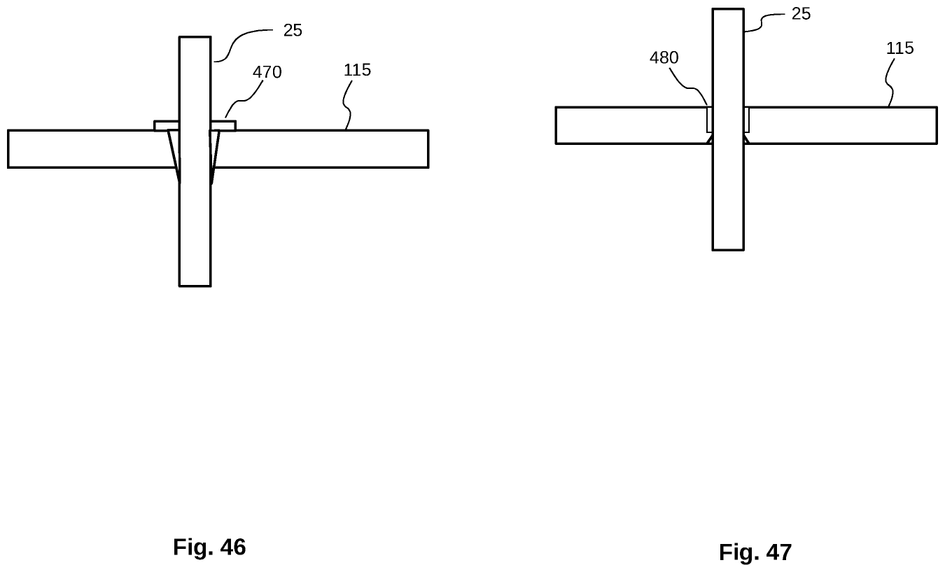

FIG. 46 shows the sleeve 470 with a conical shaped or tapered outer surface, fixed to a similar conical receptacle or taper in the wall or perforated plate 115 by a friction fit.

In another aspect, the conical sleeve 470 is fixed to the perforated plate 115 or wall by a metallic or non-metallic connection.

The heat pipe 25 is fixed to the sleeve 470 by any of the multiplicity of methods listed as part of FIG. 45.

FIG. 47 shows heat pipe 25 fixed to the perforated plate or wall 115 by local deformation 480 of perforated plate or wall 115.

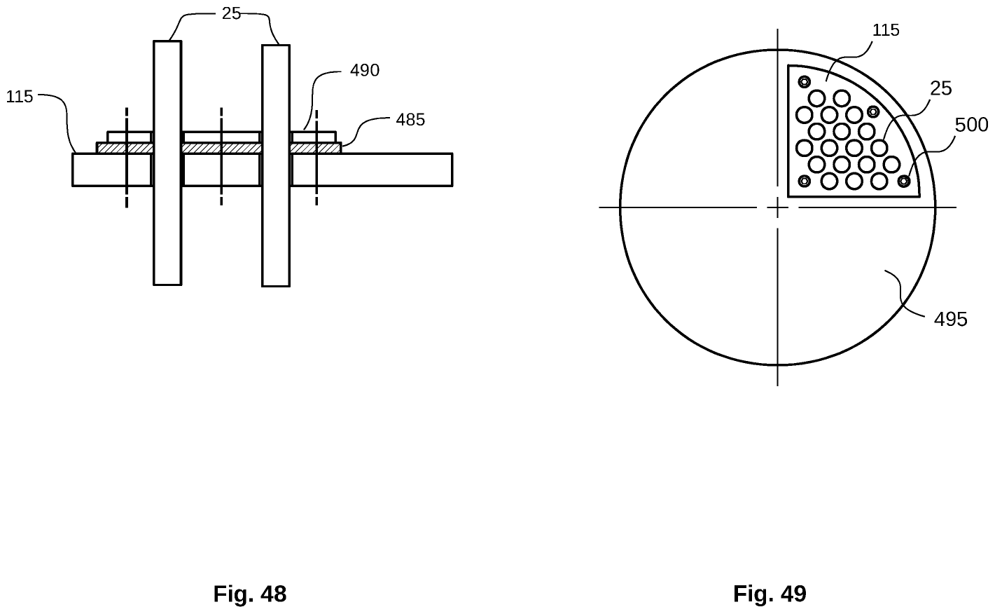

FIG. 48 shows a method of mounting a multiplicity of heat pipes 25 in a perforated plate or wall 115. The perforated plate or wall 115, a sheet of compliant material 485, and a retaining plate 490 are formed with coaxial holes. The heat pipes 25 are held by the compliant material 485 when the retaining plate 490 is fastened to the perforated plate or wall 115, compressing the compliant material.

In another aspect, FIG. 49 shows a configuration for mounting a multiplicity of heat pipes 25 on a mounting plate or tube sheet 495. The mounting plate or tube sheet includes one or several individual perforated plate segments 115, each segment 115 containing one or a multiplicity of heat pipes. Each individual segment can be independently assembled or disassembled from the complete mounting plate assembly using fasteners 500. An advantage of this geometry is that the entire mounting plate or tube sheet does not have to be removed to access an individual or group of heat pipes for service or replacement.

In another aspect, the individual mounting plate segment can have a non-circular form factor, for example, rectangular, hexagonal, or elliptical as required by the complete assembly.

System with Heat Plates

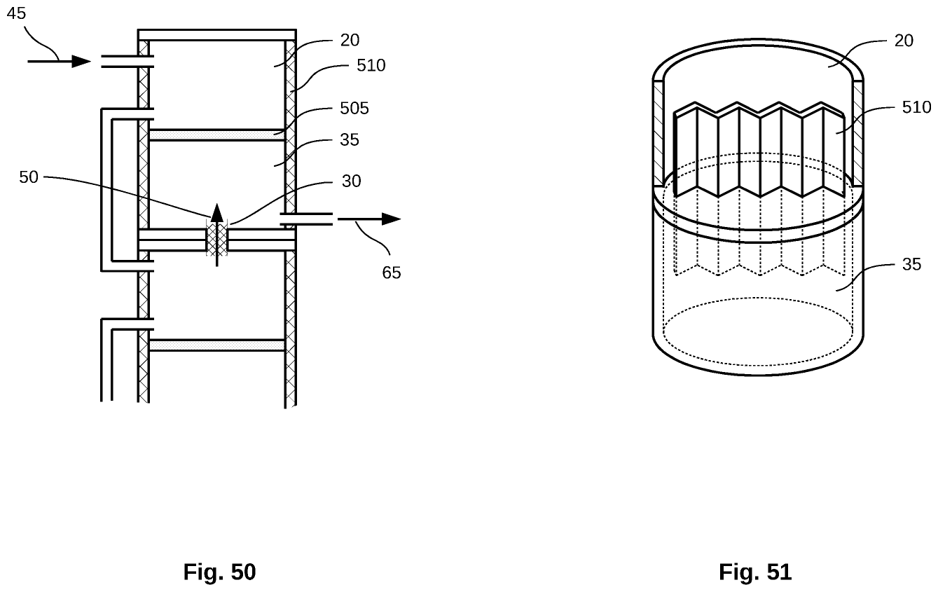

FIG. 50 shows an embodiment of the system in which heat plates are used as the heat transfer devices. Heat plates are heat pipes with cross sections that are not cylindrical or rectangular. Cylindrical heat plates having a doughnut-like cross section can replace the wall of a stage vessel, thus obviating the need for individual heat pipes, and also making cleaning easier. Feedwater 45 enters an evaporation chamber 20 and is heated by energy coming through the heat plate walls 510. That energy is supplied by steam 50 from the demister 30 of a previous evaporation chamber condensing on the heat plate walls of the condenser chamber 35. Purified water 65 exits the condenser chamber. A plate 505 separates the condenser chamber 35 from the evaporation chamber 20.

In a further aspect, a single heat plate forms the condenser chamber and extends into a corresponding evaporation chamber. An external wall of the heat plate is made of an insulating material while the inner wall of the heat plate is made of thermally conducting material.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature compression chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feedwater.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feed water or concentrate is sprayed onto the heat plates in one or more evaporators.

In a further aspect, steam is the source of energy for the energy input vessel.

In a further aspect, the energy input vessel includes electric heating elements, fuel burners, or heat plates that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat plates.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, the system contains both heat plates and heat pipes as thermal transfer devices.

In another embodiment, heat plates can be used as the walls of a nested configuration.

### Heat Plates Used for Increasing Turbulence in Evaporation Chambers

FIG. 51 shows an embodiment of the system in which heat plates are used to increase the turbulence in the evaporation chambers of the system. Boiling efficiency increases with turbulence (higher Reynolds' number). This embodiment uses heat plates 510 that are corrugated to increase the Reynold's number in the evaporation chamber 20, thus increasing boiling efficiency. Flat or corrugated heat plates can also be stacked closer together than circular heat pipes, further increasing turbulence and Reynolds' number. The heat plates extend into the condenser 35 to capture the heat from condensing steam.

In a further aspect, grooves are incorporated in the heat plates to increase surface area and, thus, heat transfer efficiency.

In a further aspect, sintered wicks are used in the external side of the heat plate to increase surface area and Reynold's number.

In a further aspect, the system operates with some or all of the vessel pressures at atmospheric pressure or above.

In a further aspect, the system operates with some or all of the vessel pressures in a vacuum (less than atmospheric pressure) condition.

In a further aspect, the system operates with one or more of the vessels below atmospheric pressure and one or more of the vessels at or above atmospheric pressure.

In a further aspect, the system has a degasser.

In a further aspect, the system has no degasser.

In a further aspect, the system has one or more demisters.

In a further aspect, the system has no demisters.

In a further aspect, pumps move the feedwater or concentrate or both from stage to stage.

In a further aspect, feedwater or concentrate or both are moved from stage to stage by gravity.

In a further aspect, feedwater or concentrate or both are moved from stage to stage using the pressure differential between stages caused by the differences in stage temperatures.

In a further aspect, purified water is sent from condenser chamber to condenser chamber one or more times.

In a further aspect, purified water exits each condenser chamber separately.

In a further aspect, purified water is sent from condenser chamber to condenser chamber in some condenser chambers and exits other condenser chambers directly.

In a further aspect, feedwater is fed first into the lowest temperature evaporation chamber.

In a further aspect, feedwater is fed first into the highest temperature evaporation chamber.

In a further aspect, feedwater is fed separately into one or all of the evaporation chambers individually.

In a further aspect, the system includes a device for steam recompression or steam reheating or both.

In a further aspect, the steam recompression system is mechanical vapor compression (MVC) or thermal vapor compression (TVC).

In a further aspect, the steam for recompression or reheating or both comes from the lowest temperature evaporation chamber.

In a further aspect, the steam for recompression or reheating or both comes from one or more of the intermediate temperature evaporation chambers.

In a further aspect, the recompressed or reheated steam is sent to the highest temperature condenser chamber.

In a further aspect, the recompressed or reheated steam is sent to one or more intermediate condenser chambers.

In a further aspect, the system includes one or more steam recompressors or reheaters between an evaporation chamber and condenser chamber.

In a further aspect, the system has one purified water-producing condenser chamber.

In a further aspect, the system has multiple purified water-producing condenser chambers.

In a further aspect, condensate from the energy input vessel is recycled to a steam generator.

In a further aspect, condensate from the energy input vessel is combined with the purified water from one or more of the other stages.

In a further aspect, the stages are stacked vertically.

In a further aspect, the stages are arranged side-by-side.

In a further aspect, some of the stages are stacked vertically and some are arranged side-by-side.

In a further aspect, one or more of the stages is in a horizontal orientation.

In a further aspect, one or more of the stages is oriented at an angle from the horizontal.

In a further aspect, one or more of the vessels are in the shape of a cylinder, or a sphere, or a cube or cuboid or a conic solid or a pyramid.

In a further aspect, the purified water or concentrate or both are used to preheat feed water.

In a further aspect, the system has no pretreatment system.

In a further aspect, the system has a pretreatment system.

In a further aspect, the system has a post-treatment system.

In a further aspect, the system has no post-treatment system.

In a further aspect, purified water or concentrate is flashed and the steam sent to the degasser.

In a further aspect, the system includes an air-cooled, water-cooled, or other chemical-cooled condenser for purified water or concentrate or both.

In a further aspect, one or more of the condenser chambers are below their corresponding evaporation chambers.

In a further aspect, one or more of the condenser chambers are above their corresponding evaporation chambers.

In a further aspect, some of the condenser chambers are below and some of the condenser chambers are above their corresponding evaporation chambers.

In a further aspect, one or more of the condenser chambers includes a steam jet or jets.

In a further aspect, none of the condenser chambers includes a steam jet or jets.

In a further aspect, the steam jet or jets rotate.

In a further aspect, the evaporation chambers operate with pool boiling.

In a further aspect, feedwater or concentrate is sprayed onto the heat plates in one or more evaporators.

In a further aspect, steam is the source of energy for the energy input vessel.

In a further aspect, the energy input vessel includes electric heating elements, fuel burners, or heat plates that transfer heat from electricity, steam, solar energy, chemical reactions, nuclear reactions, geothermal sources, molten salts, waste heat from industrial and other processes, flue gases, solid waste energy, heated thermal fluids, microwaves, or the combustion of oil, hydrocarbons, biofuels, alcohols, or natural gas, and wherein the energy input vessel is adjacent, or in proximity, to an evaporation chamber and the two are connected thermally by the heat plates.

In a further aspect, a combination of the above energy sources can be used together.

In a further aspect, the system includes only one stage.

In a further aspect, the system includes heat exchangers to capture the energy in intermediate flows or the flows exiting the system or both.

In a further aspect, a portion of the final concentrate exiting the system is cycled back into the system with the feedwater to increase its concentration further.

In a further aspect, some or all of the concentrate exiting an evaporation chamber is cycled back into that evaporation chamber to help reduce the formation of scale.

In a further aspect, the heat plate or plates are mounted perpendicular to the perforated plate.

In a further aspect, the heat plate or heat plates are mounted at a non-ninety degree angle to the perforated plate.

In a further aspect, the heat plates are splayed.

In a further aspect, the heat plates are all mounted at the same height.

In a further aspect, the heat plates are mounted at different heights.

In a further aspect, the heat plates are of different lengths.

In a further aspect, the heat plates are all the same length.

In a further aspect, the some or all of the system is constructed from titanium or a titanium alloy, such as Ti-CP1 or Ti-CP2.

In a further aspect, some of all of the system is constructed from stainless steel alloys, nickel alloys, copper alloys or other corrosion resistant alloys.

In a further aspect, some or all of the system is constructed from conventional carbon steel or other metal alloys coated with specific chlorofluorocarbon polymers (e.g., Teflon®), or a variety of polymer materials that resist boiling temperatures and saline or chemical environments.

In a further aspect, some or all of the system is constructed from metal, ceramic, or metal-ceramic composite coatings deposited on the walls of the vessels to protect the vessels from corrosion.

In a further aspect, heat plates form some or all of the walls of the system.

### Scale Inhibition, Reduction, or Removal

### A Design for Using Ultra Filtration (UF) or Nanofiltration (NF) to Reduce Water Hardness

In some embodiments, this invention can use waste heat from the water purification or concentration systems previously described to warm the feedwater stream to the optimal membrane process temperature, which depends on the membrane temperature specifications, and then to further raise the temperature of the reduced hardness processed feedwater stream before it enters the water purification or concentration system.

Embodiments include using NF to reduce or eliminate the addition of pretreatment water softening chemicals to the feedwater stream.

Embodiments include a method to capture water purification or concentration system waste heat to improve water purification system purified water output or concentration system efficiency.

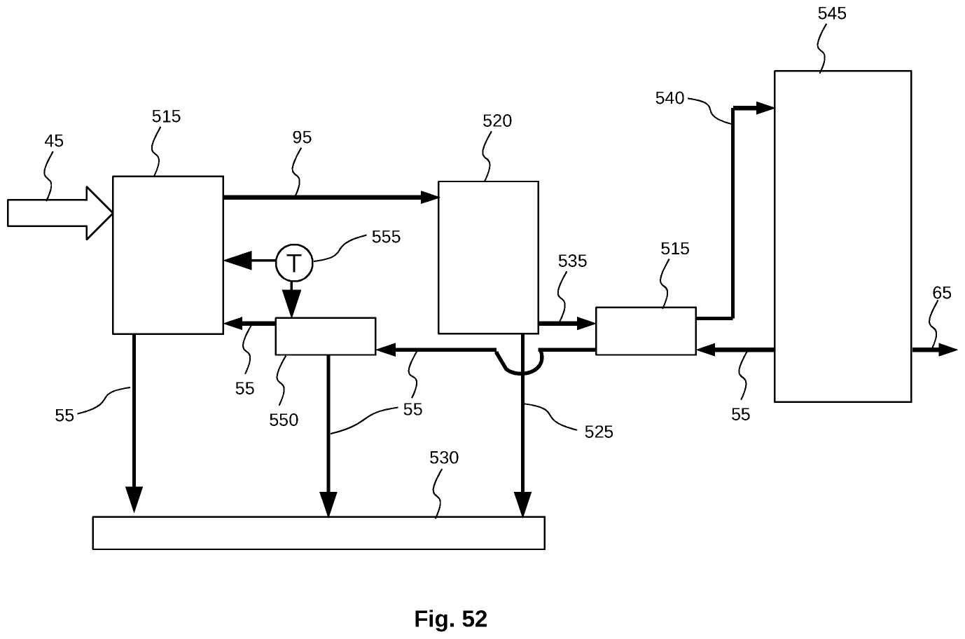

One embodiment is shown in FIG. 52. In this embodiment, the temperature of the feed water stream 45 is below 40° C. when it flows or is pumped into the inlet heat exchanger 515.

The heated feedwater stream 95 leaves the inlet heat exchanger 515 at the optimal operating temperature for a given filter or process, then enters the UF or NF system 520 at the optimum operating temperature. Hardness ions are captured in the UF/NF system, and eliminated in the concentrate reject stream 525 which flows to the waste concentrate drain 530.

The reduced hardness processed feedwater 535 stream enters the waste concentrate heat exchanger 515 where the processed feedwater temperature is further raised by energy transfer from the water purification or feedwater concentration system or final concentrate flow 55.

The elevated temperature UF/NF processed feedwater stream 540 enters the water purification or concentrate system 545. The system output is comprised of a final concentrate stream 55 and a purified water stream 65.

In a second embodiment, the final concentrate stream 55 from the water purification or concentration system 545 is pumped or flows through the waste concentrate heat exchanger 515 and to the temperature bypass control valve 550. The setting of the temperature bypass control valve 550 is controlled by a temperature probe 555 in the inlet heat exchanger 515 to divert the hot concentrate stream 55 through the inlet heat exchanger 515 to achieve the optimal temperature (35-40° C.) of the feedwater stream 45. Once the concentrate stream 55 has passed through the inlet heat exchanger 515 the stream is directed to the concentrate outlet 530. Any concentrate that does not flow through the inlet heat exchanger 515 is sent to the concentrate outlet 530.

In another aspect, an alternative method uses the waste heat in the purified water stream 65 in place of the final concentrate stream 55. In another aspect, the UF/NF filtration system is located between the water purification or concentration system preheater and the degasser, if there is a degasser, or the next stage, if there is no degasser.

In another aspect, where the temperature of the influent stream is 40° C. or greater than 40° C., a heat exchanger, or other heat transfer mechanism, is employed to reduce the temperature of the feedwater stream to 40° C. or less. Once the feedwater stream has passed through the UF/NF filtration system 520, the processed feedwater 535 passes through a heat exchanger 515 to raise the temperature of the processed feedwater before the processed feedwater stream 540 enters the water purification or concentration system 545.

In another aspect, the energy input to the inlet heat exchanger 515 could be provided by other energy sources, for example, solar, geothermal, and other sources of waste heat.

### Self-Cleaning and Clean-In-Place Methods

### Self-Cleaning Media

The evaporation chamber can also include a self-cleaning medium including a plurality of particles. In such an embodiment, the intermediate concentrate has an opening or openings of a size that does not permit the particles to pass through the intermediate concentrate outlet. The opening can further have a shape that is not complementary to a shape of the particles. The particles can be substantially spherical, or can be other shapes selected for optimum cleaning efficiency. The particles can also include a characteristic permitting substantially continuous agitation of the particles by boiling of water in the evaporation chamber. The characteristic can be, for example, specific gravity, size, morphology, population number, and the like. The particles can have a selected hardness, so that the hardness permits scouring of the evaporation chamber and the heat transfer devices by the particles without substantially eroding the particles or the evaporation chamber or heat transfer devices. Furthermore, the particles can be composed of ceramic, metal, glass, or stone. The particles can have a specific gravity greater than about 1.0 and less than about 8.0.

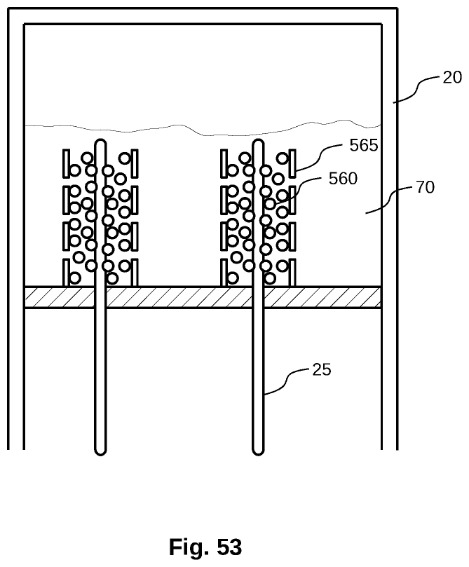

FIG. 53 shows one embodiment using such particles in which the particles 560 are enclosed within a concentric perforated cylinder 565 surrounding each heat pipe 25. The heat pipes extend into the intermediate concentrate 70 in the evaporation chamber 20.

In a further aspect, an evaporation chamber includes a self-cleaning medium for interfering with accumulation of precipitates at least in an area proximate to the heat pipes in the evaporation chamber.

In a further aspect, the medium includes a plurality of particles. In a further aspect, the particles are substantially spherical. In a further aspect, the particles include a characteristic permitting substantially continuous agitation of the particles by boiling of water in the evaporation chamber. In a further aspect, the characteristic is selected from the group consisting of specific gravity, size, morphology, population number and composition. In a further aspect, the particles have a selected hardness, wherein the hardness permits scouring of the evaporation chamber by the particles without substantially eroding the particles or the evaporation chamber. In a further aspect, the particles are composed of ceramic, metal, glass, stone or a combination of these materials. In a further aspect, the particles have a specific gravity greater than about 1.0 and less than about 8.0. In a further aspect, the particles have a specific gravity between about 2.0 and about 5.0.

The self-cleaning medium can be selected from any of a number of suitable alternatives. Such alternatives include glass or ceramic beads or balls, stones, synthetic structures of any of a variety of shapes, and the like. In every case, the properties of the self-cleaning medium will be selected such that agitation by boiling water will displace individual particles of the sell-cleaning medium, but that such displacement will be overcome by the physical properties of the self-cleaning medium causing each particle to fall again to the side of each heat pipe and to the bottom of the evaporation chamber, striking and dislodging any deposits or scale. For example, a self-cleaning medium with a relatively high specific gravity but with a relatively small surface to volume ratio can function in a way that is roughly comparable to a second self-cleaning medium with a lower specific gravity but a relatively higher surface to volume ratio. In each case, a skilled artisan is able to select the combination of morphology, and composition to achieve the desired result. In some embodiments, an alternative approach to self-cleaning is employed, such as, for example, application of ultrasonic energy.

Another consideration in the design choice of the self-cleaning medium is the hardness thereof. In general, the hardness should be roughly comparable to the hardness of the material of which the evaporation chamber is composed. This permits continued use of the self-cleaning medium over long periods of time without significant erosion of the medium or of the walls or bottom of the evaporation chamber. In some embodiments in which the heating element of the evaporation chamber is internal to the chamber, such as the case with heat pipes, hardness and other properties of the self-cleaning medium can be selected so as to avoid erosion or other damage to the heating element as well as to the evaporation chamber itself.

Some embodiments provide broad spectrum water purification that is fully automated and that does not require cleaning or user intervention over very long periods of time. For example, systems disclosed herein can run without user control or intervention for 1, 2, 4, 6, 8, 10, or 12 months, or longer. In some embodiments, the systems can run automatically for 1, 2, 3, 4, 5, 6, 7, 8, 9, 10, 11,12,13,14, or 13 years, or more. In other cases the system can be cleaned, one stage at a time, or multiple stages at a time, in such a manner that the entire water treatment system does not have to be shut down for the maintenance.

In a further aspect, the system does not require cleaning through at least about two months of use. In a further aspect, the system does not require cleaning through at least about one year of use or longer. Alternatively the system can be cleaned relatively frequently, one or more stages at a time, in such a manner that the entire water treatment system does not have to be shut down for the maintenance.

Take One or More Stages out of Service and Clean in Place while Others are Still Operating

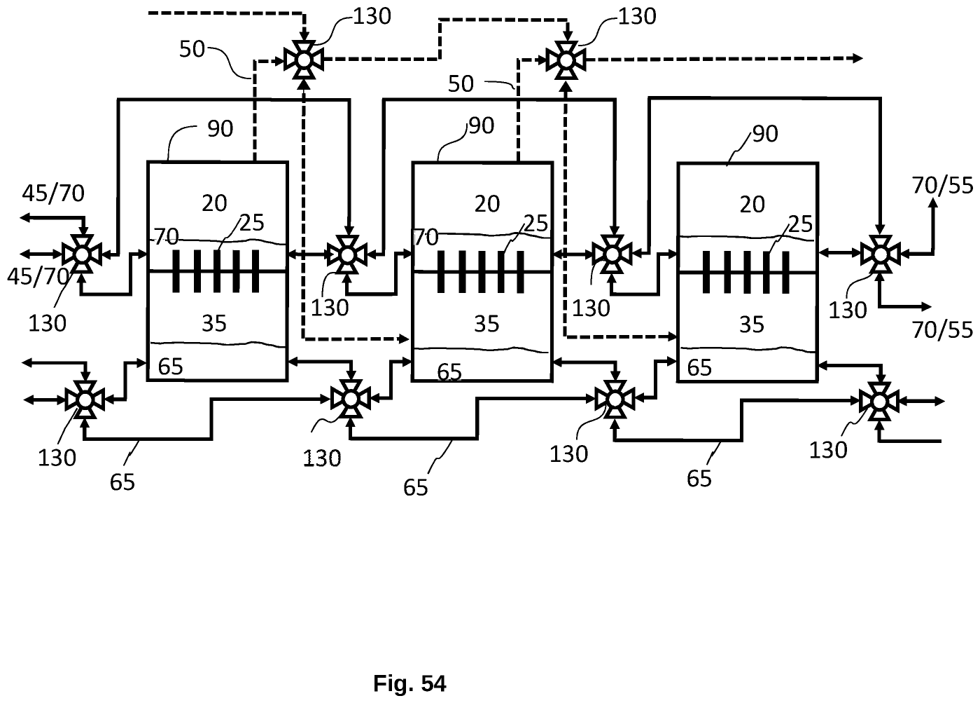

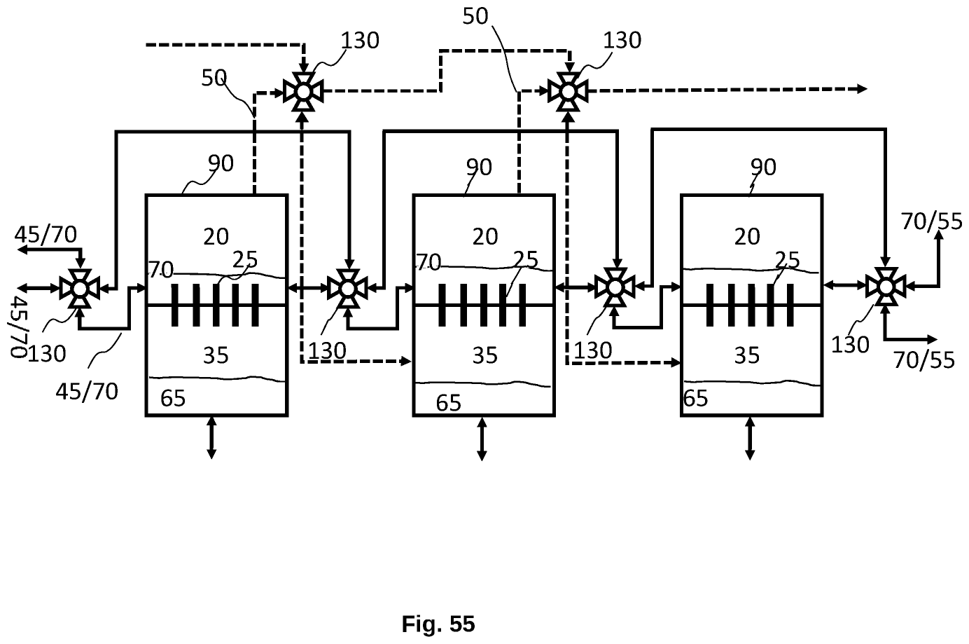

Some embodiments are illustrated in FIGS. 54 and 55. In a multi-stage evaporation system, the stages have different temperatures or different concentrations of chemicals or both. High concentration of salts in water may increase the rate at which scales, such as calcium carbonate, calcium sulfate or magnesium silicate are formed. Different temperatures may change the type of chemical precipitating, the particular polymorph of a crystal or the level of hydration of a compound. Different temperatures and chemical compositions may result in different corrosion rates of parts of the system. As a consequence, the frequency and type of maintenance is potentially different in each stage.

Embodiments of the invention provide systems and methods for multi-stage water purification or feedwater concentration systems in which a single chamber, or multiple chambers, can be taken out of commission while the others are still operating. In one embodiment, the water purification or feedwater concentration system includes two or more stages 90, each stage containing a condenser chamber 35 and an evaporation chamber 20, one or more heat transfer devices including but not limited to a heat pipe 25, tube, rod, plate or heat exchanger, pipes to transfer fluids between stages, optional pumps to pump fluids between stages, a series of valves to direct the flow of fluids to different locations in the system, a set of sensors including but not limited sensors for temperature, pressure, liquid level, electrical conductivity, and a control system to operate pumps, valves and other actuated devices commonly found in chemical plants. A single stage, or multiple stages, can be taken out of commission by redirecting the flow of any vapors supplied to the condenser chamber of said stage, or stages, into the condenser chamber of a different stage, or stages, and redirecting the flow of any liquids supplied to said stage, or stages, into either the condenser chamber or the evaporation chamber of a different stage, or stages.

In some embodiments, the redirection of flows can be accomplished by manually operating valves 130. In other embodiments, the redirection of flows can be accomplished by valves operated by a control system.

### Conditioning and Clean-In-Place

As mentioned previously, water purification or feedwater concentration technologies are hindered in their performance by the formation of scale. In membrane-based processes, this scale can result in fouling of membranes. In thermal-based water purification or feedwater concentration methods, the formation of scale results in additional resistance to heat flow across heat transfer devices such as heat exchangers, heat plates, heat pipes amongst others. The most common scales are inorganic salts of calcium and magnesium that are deposited on the internal surfaces of the apparatuses. The formation of such scales may be enhanced due to increase in concentration of the constituent ions when water is evaporated, or such formation may be enhanced due to the change in solubility of some chemical species when temperature of an aqueous solution changes, or both of these effects. Two common scales found in industrial aqueous streams are calcium sulfate and calcium carbonate. In order to avoid the problems associated with scale formation, pretreatment steps are required that include one or more of the following steps: flocculation, sedimentation, filtration, ion-exchange resins and nanofiltration, centrifugation, amongst others. Alternatively, reduction of scaling rate can be achieved by addition of complexing agents, such as EDTA, or crystal growth modifiers, such as polyacids. These steps increase capital and operating costs in wastewater treatment operations. Water purification technologies that reduce or eliminate pretreatment steps are highly desirable.

Embodiments of the present invention provide an improved method for operating water purification or feedwater concentration systems without pretreatment even with feedwater streams that are prone to scale formation, such as those with high content of ions such as calcium, magnesium, carbonate, bicarbonate, silicate and sulfate.

Embodiments of the present invention provide methods for the removal of scales from the surface of heat transfer devices, including but not limited to a heat pipe, tube, rod, plate or heat exchanger, without having to physically reach said surfaces, therefore eliminating the need for opening the vessel that contains the devices.

In some embodiments, a method includes a conditioning step in which a thin layer is purposely formed on the surface of heat transfer devices such as heat pipes, tubes or plates, the method also includes a step of regular operation of said heat transfer device or devices, in which scale can be formed on top said thin layer, the method also includes a clean-in-place step in which the thin layer is chemically removed, resulting in the detachment of any scale formed on top of the thin layer.

In some embodiments, a method includes mechanically weakening the scale using thermal management. The heat transfer device and the scale often have different coefficient of thermal expansion. If, for example, a cold mixture is added to the system, the heat transfer device and the scale contract at different fractions of their original volume. The scale adhesion to the surface of the heat transfer device is weakened, and mechanical stresses develop in the scale, resulting in breakage of the scale and re-exposure of the surface of the heat transfer device. Mechanical energy can be applied to the heat transfer device in order to enhance scale breakage. A hot fluid can be supplied to the condenser side of the heat transfer device to increase thermal gradient along the device.

In some embodiments, a method includes combinations of a conditioning step, weakening of the scale by thermal management and a clean-in-place step.

Embodiments of the present invention provide a water purification or feedwater concentration system that can include a pretreatment, a degasser, a preheater, one or multiple evaporation chambers and demisters, one or multiple product condenser chambers, inlets and outlets for liquid and gas streams, a control system, one or more heat recovery units, equipment for conditioning and clean-in-place procedures, and equipment for removal of solids.

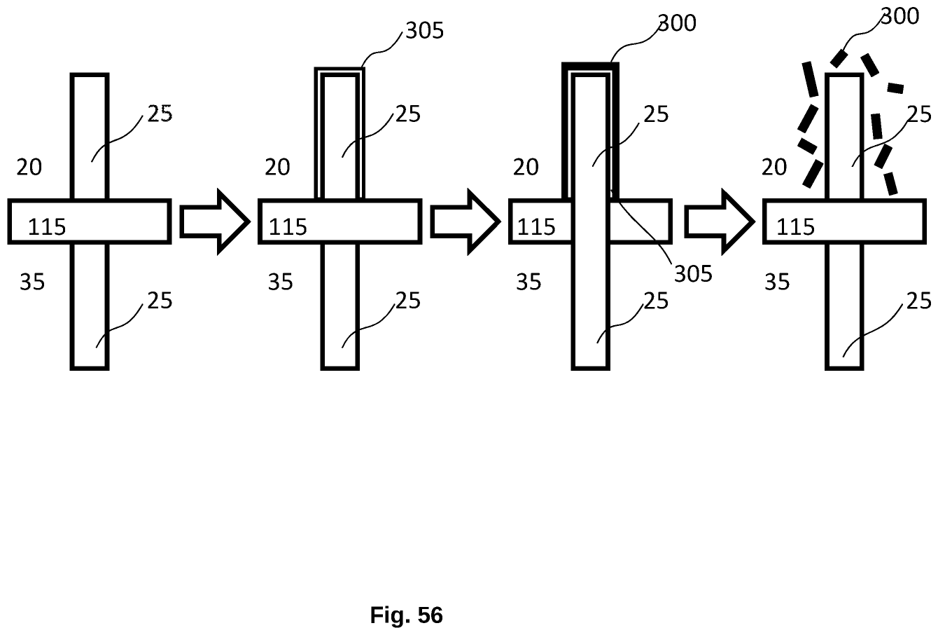

FIG. 56 is a diagram of the conditioning, scaling and clean-in-place steps on heat transfer devices in water purification and feedwater concentration systems.

In a first aspect, as shown in FIG. 56, the method begins by purposely forming a thin layer 305 of calcium carbonate on the evaporation chamber 20 side surface of the heat transfer devices 25 (heat pipes, heat exchangers, heat plates and others) in water purification systems. This is called the conditioning step. In some embodiments, the method can be used on the elements susceptible to scale formation, such as parts of preheaters, degassers, demisters and heat exchangers. The layer 305 is thin enough that is adds only a small resistance to heat flow in and out of the heat transfer devices 25. In one aspect, the thickness of the layer 305 is less than one nanometer. In a further aspect, the thickness of the layer 305 is less than 10 nanometers In a further aspect, it is less than 100 nanometers. In a further aspect, it is less than 1 micrometer. In a further aspect it is less than 10 micrometers. In a further aspect, it is less than 100 micrometers. In a further aspect it is less than 1 millimeter. In a further aspect, it is less than 1 centimeter.

The layer 305 can be formed by adding an aqueous solution containing calcium and carbonate ions and evaporating water from this solution, so the product of molar concentrations of calcium and sulfate ions becomes higher than the solubility product and the formation of a solid phase takes place. Evaporation of water can be done by supplying heat to the aqueous solution, for example—but not limited to—by feeding steam to the condenser side 35 of the heat transfer element 25. In a further aspect, other heat transfer mechanisms may be used, or heat transfer fluids, or combinations of fluids including, but not limited to, hot air, water, oils, silicones, flue gases and molten salts. In another aspect, evaporation can be achieved by applying vacuum to the evaporation chamber side of the stage. In a further aspect, evaporation can be achieved by combination of heat and vacuum.

In another aspect, the calcium carbonate layer 305 can be formed by precipitation from an aqueous solution in the evaporation chamber side of the heat transfer element 25, which takes place when the product of molar concentrations of calcium and sulfate ions becomes higher than the solubility product. This can be achieved by a combination of adding a calcium-containing chemical species to said solution, adding a carbonate-containing chemical species to the solution, adding a bicarbonate-containing chemical species to the solution and a base so as to increase the pH of the solution to the range where the carbonate-bicarbonate equilibrium begins to shift towards carbonate, adding a base so as to increase the pH and feed carbon dioxide gas to the chamber so it is absorbed in the solution. In another aspect, the thin calcium carbonate layer 305 can be formed by combination of the two methods: precipitation after adding chemicals, and evaporation to form a solid.

After the thin layer 305 of calcium carbonate is formed, the process of water treatment or feedwater concentration can proceed normally (regular operation) until the formation of a scale 300 reaches the maximum allowable thickness for the process, which can be determined by a techno-economic analysis for each water purification technique, or until scale removal is desired for other reasons. In order to remove the scale, an aqueous acidic solution is supplied to the evaporation chamber. This solution percolates through pores and cracks in the scale 300 and reacts with the calcium carbonate thin layer 305. After the thin layer 305 is dissolved, the scale 300 is physically separated from the surface of the heat transfer device, typically in fragments, so it no longer provides resistance to heat flow. The scale 300 fragments can be collected at the bottom of the vessel or left as a suspension in the liquid. The acidic solution can contain one or more of the following acids: citric acid, acetic acid, hydrochloric acid, nitric acid, formic acid, hydrobromic acid, and other acids that are stronger than carbonic acid. In one aspect, the pH of the acidic solution is lower than 7. In another aspect, it is lower than 6. In another aspect, it is lower than 5. In another aspect, it is lower than 4. In another aspect, it is lower than 3. In another aspect, it is lower than 2. In another aspect, it is lower than 1. In another aspect, the selected acid, or mixture of acids, is slowly dosed into the aqueous solution while the evaporation chamber is full of feed solution during normal operation. Alternatively, the feedwater can be partially or fully drained from the vessel prior to addition of the clean-in-place solution. In some aspects, the heat transfer devices can be dried before adding the clean-in-place solution.

In another aspect of the invention, a similar thin layer 305 can be formed from one or more carbonates that have low solubility in water, such as magnesium carbonate, strontium carbonate, barium carbonate, and other carbonates. As described above for the calcium carbonate layer, this layer 305 can be formed by evaporation and crystallization, precipitation or a combination of both. After regular operation, the scale 300 can be removed by the same clean-in-place process described above.

In another aspect of the invention, a source of carbonate ions is added to the feedwater containing sulfate anions to promote the formation of carbonate-based scale rather than sulfate-based scales. The source of carbonates can be a carbonate salt such as sodium carbonate (soda ash). In another aspect, a combination of a bicarbonate salt such as sodium bicarbonate (baking soda) and a base can be added, so as to achieve a pH high enough to convert a significant fraction of the bicarbonate ions to carbonate ions. The addition of carbonate may result in the formation of solid carbonates, such as calcium carbonate, magnesium carbonate, strontium carbonate, and others. In this case, the resulting solids can be separated from the feedwater by means of filtration, sedimentation, centrifugation or any other standard separation technique. The resulting aqueous solution can then be fed to the water treatment system, for example an evaporation chamber. When the solution is concentrated due to evaporation of water, the precipitation of carbonate scales (magnesium carbonate, calcium carbonate and strontium carbonate) will take place before any of the corresponding sulfate scales precipitate. The scale can be removed by the action of an aqueous acidic solution supplied to the evaporation chamber, as explained above.

In another aspect of the invention, a feedwater stream containing sulfate anions is treated with a source of carbonate ions inside the distillation system before starting to remove water by evaporation. The resulting carbonate precipitates are not separated from the aqueous solution. Instead, said solids are suspended with the feedwater that circulates through the stage or stages in the distillation system, and exit the system with the concentrate stream. In one embodiment, excess carbonate ions are added so all the precipitates are formed at the beginning of the distillation system, and therefore the formation of scale on the surface of the heat transfer devices is avoided. In another aspect, the minimum amount of carbonate ions are added so that when water is evaporated in the system there is preferential formation of carbonate scales instead of sulfate scales. Said carbonate scales can be removed by treatment with an acidic solution as explained above. In another aspect, only a small amount of carbonate ions are added so that the scale formed has calcium carbonate domains embedded in the scale (mainly composed of sulfate), said carbonate domains can act as breaking points when treated with an acid solution as described above. In another aspect, carbonate ions are present in the feedwater stream. In another aspect, bicarbonate ions are present in the feedwater stream and the pH is increased to shift the bicarbonate/carbonate equilibrium towards the second species.

The method presented in this section can be applied to systems where the heat transfer devices are heat pipes, as shown in the above description. However, this method can also be applied to other types of heat transfer devices such as loop heat pipes, thermosiphons, heat plates, heat exchangers, falling film evaporators, rising film evaporators, crystallizers, multi-effect distillation systems, multi-stage flash distillation systems, reverse osmosis systems with feedwater preheating, etc.

### Multiple Degassers—Take One or More Out at a Time for Cleaning

Water purification and feedwater concentration technologies based on evaporation separate clean water from contaminated water by evolving vapor from feedwater by addition of thermal or mechanical energy. The feedwater to be treated can contain chemical species with relatively low vapor pressures, such as ammonia or volatile organic compounds that can evaporate from the feedwater simultaneously with the steam vapors, and therefore may end up contaminating the product water produced by condensation of the gases.

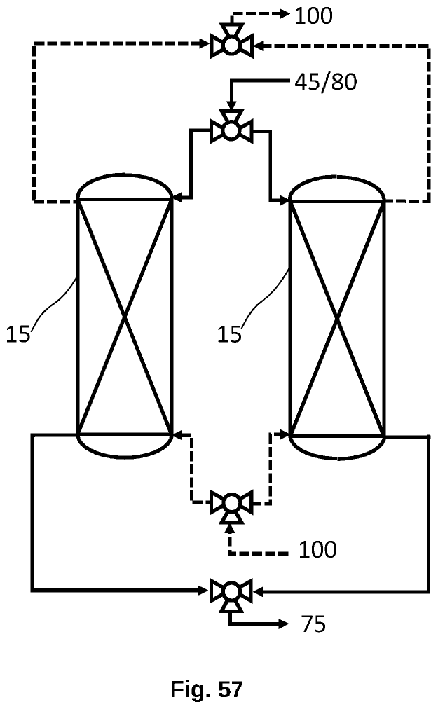

Referring to FIG. 57, embodiments of the present invention provide systems and methods to eliminate volatile species from water feeds before they are purified by a thermal process.

In a first aspect, the feedwater 45 or pretreated feedwater 80 is passed through the first of two degasser chambers 15 located in parallel in the process flow, while the second degasser chamber is idle. In another aspect, there can be more than two degasser chambers 15 in parallel or in series. At least one chamber sits idle or is removed from the process flow for cleaning while another or others remain in the system to perform the degassing function. The chambers 15 can be packed columns, a column with multiple discrete plates, one of the stages in a multi-stage evaporator, an empty column with a showerhead or any other vessel in which a liquid stream enters in contact with a gas stream. The water to be treated 45/80 is fed into the vessel at one location, and a gas stream 100 is fed into the vessel at the same or another location. The gas 100 can be water vapor (steam), air, nitrogen, argon, methane, mixtures of these gases or any other non-condensable gas that won't condense with the product water in the evaporation chambers downstream of the degasser.

In one aspect, the gas 100 is fed at room temperature. In another aspect, the gas 100 is preheated to a temperature above ambient. In another aspect, the gas 100 is preheated to a temperature above the boiling point of the feedwater 45/80.

The feedwater 45 or pretreated feedwater 80 and the gas 100 are in contact as they flow through the degasser chamber 15, at least for part of their path inside the degasser. In one aspect, the gas 100 and the feedwater 45/80 follow parallel paths. In another aspect. they flow counter-current in one aspect, the liquid is first in contact with one or more gases (e.g. air to remove volatile organic compounds) and then the liquid is in contact with another gas (e.g. steam to deaerate the liquid). In one aspect each of the two or more gases is used in a different section of one degasser. In another aspect, each of the two or more gases is used in a different degasser. In another aspect, only one gas is used in all degassers.

The flow of feedwater 45 or pretreated feed water 80 and gas 100 can be switched at any time from the first chamber to the second or additional chambers, so the first chamber is idle for cleaning or maintenance. As operations continue, the flow of feedwater and gas can be directed to any of the two or more degasser chambers so the other degasser chamber is idle for cleaning or maintenance.

In another aspect, the first chamber and the second chamber or additional chambers are different in size or design, so the system is better suited to treat a variety of feedwaters with different types or concentrations of volatile compounds.

In another aspect, the injection points in the degassers can be changed as a function of the type and concentrations of volatile compounds in the feedwater. This can be done, for instance, to reduce the energy consumption of the degasser step.

### Thermal and Mechanical Shock Cleaning

As previously discussed, water purification and feedwater concentration technologies are hindered in their performance by the formation of scale. In membrane-based processes, it can result in fouling of membranes. In thermal-based processes, the formation of scale results in additional resistance to heat flow across heat transfer devices such as heat exchangers, heat plates, heat pipes amongst others. Removing scales is costly and slow.

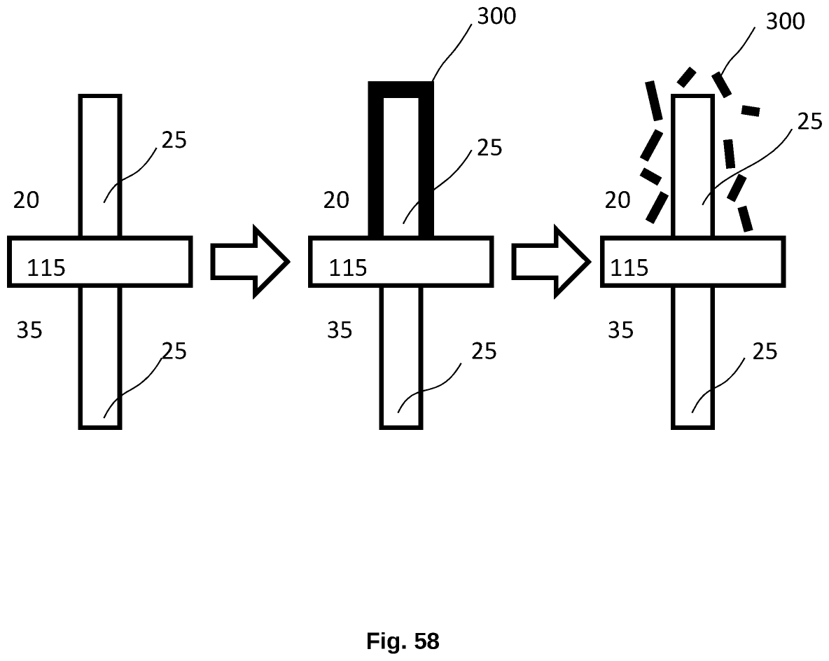

Referring to FIG. 58, embodiments of the present invention provide methods for the removal of scales from the surface of heat transfer devices, including but not limited to a heat pipe, tube, rod, plate or heat exchanger, without having to physically reach said surfaces, therefore eliminating the need for opening the vessel that contains the devices.

The heat transfer device 25 and the scale 300 often have different coefficients of thermal expansion and, when the cold mixture is added to the system, they contract different fractions of their original volume. The scale 300 adhesion to the surface of the heat transfer device 25 is weakened, and mechanical stresses develop in the scale, resulting in breakage of the scale and re-exposure of the surface of the heat transfer device.

A first method, see FIG. 58, begins by feeding a liquid, a mixture of liquids, or a mixture of solids and liquids, to the chamber 20 that contains the heat transfer devices 25 with scale 300, in a manner such that the added liquid or mixture is in contact with the surface of the scale 300. The temperature of said liquid or mixture is lower than the temperature of the heat transfer device 25 and the scale 300. In one aspect, the temperature is lower than 10° C. In another aspect, the temperature is lower than 0° C. In another aspect, the temperature is lower than −40° C. In another aspect, the temperature is lower than −75° C. The table below lists several possible mixtures and their temperature.

In another aspect, after creating the thermal shock described above, mechanical energy is applied to the heat transfer device 25 in order to enhance scale 300 breakage. Energy is applied in the form of vibration, tapping or using any other suitable process, such as sound to create resonance (close to natural vibration frequency of the scale).

In another aspect, the cold liquid or mixture is added as described above, while simultaneously heat is provided to the condenser 35 side of the heat transfer device 25. This promotes fast evaporation of the mixture creating localized fast pressure swings that provide mechanical energy to break the scale 300.

In another aspect, the cold liquid or mixture is added to the condenser 35 side of the heat transfer device 25.

In another aspect, the cold liquid or mixture is added to the condenser 35 side of the heat transfer device 25 while a hot fluid is fed to the evaporation chamber 20 side of the heat transfer device 25.

In other embodiments of the invention, scale is removed by combinations of conditioning, clean-in-place, as described in ‘Conditioning and Clean-in-Place’ section and shown in FIG. 56 and thermal and mechanical treatment, both as described above.

TABLE 7
Typical Cooling Mixtures

| First Component | Second Component | Temp (° C.) |
|---|---|---|
| Dry ice | p-xylene | +13 |
| Dry ice | Dioxane | +12 |
| Dry ice | Cyclohexane | +6 |
| Dry ice | Benzene | +5 |
| Dry ice | Formamide | +2 |
| Ice | Salts (see: above) | 0 to −40 |
| Liquid N2 | Cycloheptane | −12 |
| Dry ice | Benzyl alcohol | −15 |
| Dry ice | Tetrachloroethylene | −22 |
| Dry ice | Carbon tetrachloride | −23 |
| Dry ice | 1,3-Dichlorobenzene | −25 |
| Dry ice | o-Xylene | −29 |
| Dry ice | m-Toluidine | −32 |
| Dry ice | Acetonitrile | −41 |
| Dry ice | Pyridine | −42 |
| Dry ice | m-Xylene | −47 |
| Dry ice | n-Octane | −56 |
| Dry ice | Isopropyl ether | −60 |
| Dry ice | Acetone | −78 |
| Liquid N2 | Ethyl acetate | −84 |
| Liquid N2 | n-Butanol | −89 |
| Liquid N2 | Hexane | −94 |
| Liquid N2 | Acetone | −94 |
| Liquid N2 | Toluene | −95 |
| Liquid N2 | Methanol | −98 |
| Liquid N2 | Cyclohexene | −104 |
| Liquid N2 | Ethanol | −116 |
| Liquid N2 | n-Pentane | −131 |
| Liquid N2 | Isopentane | −160 |
| Liquid N2 | (none) | −196 |

### Robot Cleaner

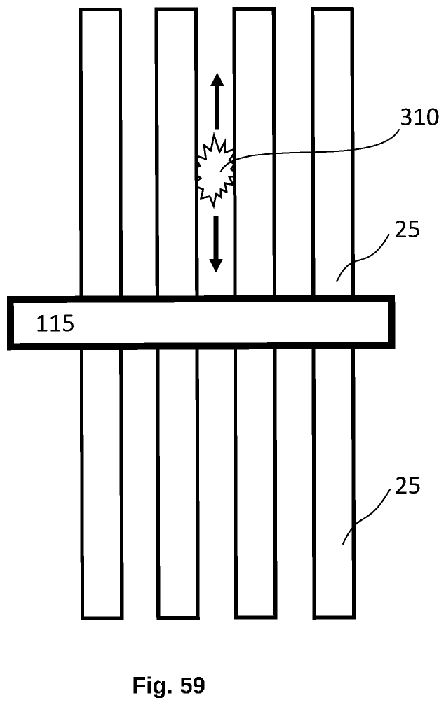

Referring to FIG. 59, embodiments of the present invention provide methods for the removal of scale from the surface of heat transfer devices, including but not limited to a heat pipe 25, tube, rod, plate or heat exchanger, without having to open the vessel that contains the devices.

In a first aspect, a device for scale removal 310 circulates in between the heat transfer devices 25, including but not limited to a heat pipe, tube, rod, plate or heat exchanger. The device 310 is in physical contact with the scale. In one aspect, the device 310 possesses accessories for transferring mechanical energy to the scaled surface, for example, but not limited to, rotating brushes, vibrating motors, ultrasonic horns, speakers to produce sound at a frequency close to natural vibration frequency of the scale, or combination of those.

In another aspect, a device 310 moves along the surface of the heat transfer device dragging one or more sharp tips that are in contact with the scale. In one aspect, the tips are made of a material that is softer than the surface of the heat transfer device 25, so as not to scratch it. In another aspect, the device 310 applies pressure to the tips by means of a spring, a hydraulic piston or a similar device. In another aspect, the applied pressure can be controlled, for example by varying the pressure of the hydraulic fluid.

In another aspect, the device 310 moves autonomously inside the vessel where the heat transfer devices 25 are located, following pre-programmed paths. In another aspect, external signals are sent to the device to control its trajectory.

In another aspect, the device is physically connected to a moving mechanism such as a rod, cable, or similar umbilical and said mechanism is actuated by one or more motors that can be located inside or outside the vessel.

In another aspect, a plate with orifices moves along the heat transfer devices, which are inside the orifices. In one aspect, the perimeter of the orifices has brushes, tips or other structures that can disrupt the mechanical integrity of the scale. In another aspect, the plate vibrates.

### Coatings

Heat pipes are very effective heat transfer devices that can be used in thermal-based water purification systems. Heat pipes are also very effective heat transfer devices when used to improve performance in non-thermal based water purification systems such as filtration systems, osmosis systems and other membrane-based system. The material of construction of commercial heat pipes is selected based on heat transfer properties and ease of manufacturing, but often it does not meet performance requirements for water purification, such as corrosion resistance or anti-scaling capability.

Embodiments of the present invention provide systems and methods to modify the surface of heat pipes to be used in water purification.

In a first aspect, a coating is deposited on the surface of the whole heat pipe. In one aspect, the function of the coating can be to increase corrosion resistance in aqueous solutions with high concentration of salts, high pH, low pH, high oxidation potential or any combination of those. In another aspect, the function of the coating can be to promote the formation of bubbles during boiling. In another aspect, the function of the coating can be to increase hydrophobicity of the surface to enhance condensation of steam into the surface. In another aspect, the function of the coating can be to avoid the formation of scale, for instance if the nature of the coating is such that solids do not stick to it. In another aspect, the coating can have more than one function of the listed above. The coatings can be deposited by electroplating, vapor deposition, thermal or plasma spray, spray painting, painting or any other suitable method.

In another aspect, only a fraction of the heat pipe surface is coated. The purpose of the coating can be one or more from the above-mentioned functions. As an example, the evaporation chamber section of a heat pipe in a water purification or feedwater concentration system can be coated to increase corrosion resistance. As another example, the condenser section of a heat pipe in a water purification system can be coated to increase condensation rate.

In another aspect, different areas of the heat pipes can be coated with different materials for different purposes. As an example, the evaporation chamber section of a heat pipe in a water purification or feedwater concentration system can be coated to increase corrosion resistance, and the condenser section of the same heat pipe can be coated to increase condensation rate.

In another aspect, coatings can be applied to the vessel walls, one or more surfaces of the heat pipes mounting plates, inserts or any other parts used for mounting the heat pipes onto the plate, baffles, screens or any other parts that are in contact with the feedwater or the product water in a water purification or feedwater concentration system.

In another aspect, the coatings could be applied to other heat transfer devices including heat spreaders, loop heat pipes, flat heat pipes, pulsed heat pipes and others.

### Electrical Bias on Heat Pipes

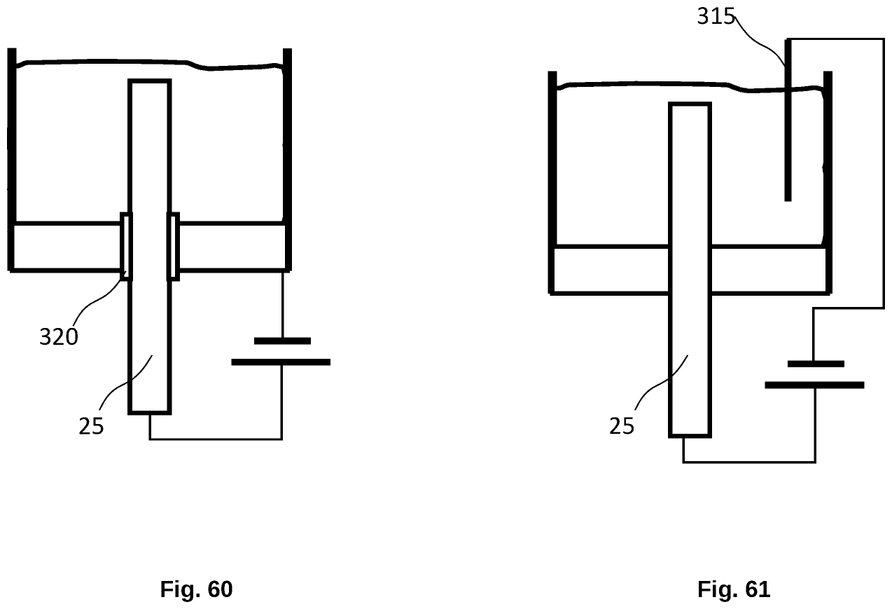

Referring to FIG. 60 and FIG. 61, embodiments of the present invention are shown which provide systems and methods for heat pipe-based water purification or feedwater concentration systems in which the formation of scale on the surface of heat pipes is slowed down or stopped by applying electrical bias on the surface of the heat pipes.

In one aspect, a positive voltage is created between the surface of the heat pipes 25 and another point in the system, such as the walls of the vessel or one or more electrodes 315 placed inside the aqueous solution that is being purified (feedwater). An electrical insulator 320 can be used to mount the heat pipes. The positive charge on the heat pipes surface attracts negatively-charged ions in the solution, resulting in an anion-rich layer around the heat pipe. When cations arrive at the vicinity of the heat pipe, due to the high density of anions there is a high probability of homogeneous precipitation (formation of crystals in suspension) rather than heterogeneous precipitation of scale on the surface of the heat pipe.

In a further aspect, different ranges of voltages can be used depending on the characteristics of the feedwater and the materials of construction of the vessels.

In a further aspect, different configurations for the electrodes can be used.

In a further aspect, a positive voltage can be applied to some heat pipes to attract anions and a negative voltage applied to other heat pipes to attract cations.

In a further aspect, voltages can be applied to systems that use other types of thermal devices including heat plates, loop heat pipes, pulsed heat pipes, flat heat pipes, and heat spreaders.

### Heat Pipe Based Systems

### Use of Heat Pipes in MSF And MED in Alternative Configurations

Conventional MSF and MED designs use hollow tubes for heat transfer, with one fluid flowing inside the tube(s), and the other fluid surrounding the tube(s), often sprayed onto the collection of tubes (a tube bundle). The heat pipe, being a sealed system, can operate more efficiently with a different means of dispersing fluid around the heat pipe or heat pipe bundle.

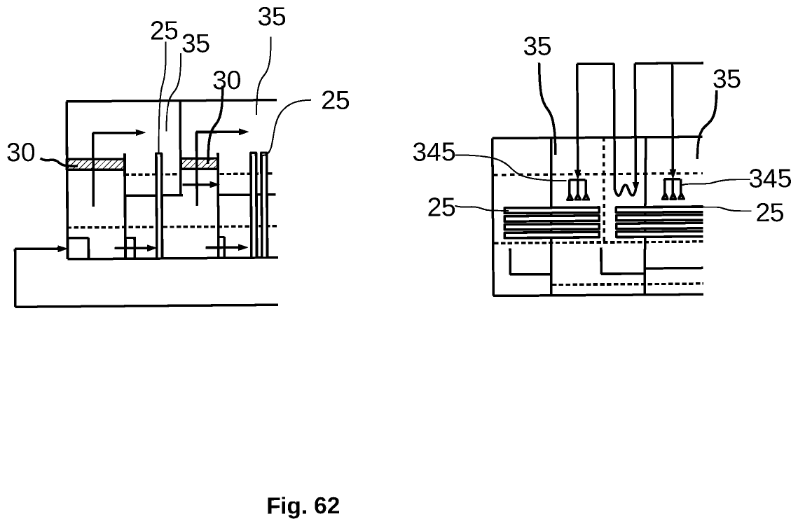

Referring to FIG. 62, the left figure is a partial reproduction of a figure from MSF U.S. Pat. No. 9,393,502 B1, which is hereby incorporated by reference in its entirety, with notes on alternative configurations described below.

The right figure is a partial reproduction of a figure from MED U.S. Pat. No. 9,309,129 B1 with notes on alternative configurations described below.

An embodiment relates to the use of steam jets or an array of jets from the demister 30 to direct steam flow in the condenser chamber 35 and into the array of heat pipes 25. The improvement is to direct the flow of steam into the heat pipe 25 bundle to improve heat transfer coefficient from the vapor to the metal, for instance by decreasing the gas boundary layer at high vapor linear flow velocities.

Embodiments relate to configurations of a condenser chamber to improve steam condensation in tube bundle (circular, non-rectangular).

Embodiments relate to a cylindrical shaped condenser chamber surrounding a heat pipe bundle will be more efficient than the rectangular chamber as shown in the existing patents.

Referring to FIG. 62 (left), embodiments relate to non-submergcd evaporation chamber 35 in vertical heat pipe 25 configurations, including film boiling over a vertical bundle of heat pipes 25 with a spray nozzle 345.

Other embodiments include systems made using heat spreaders, loop heat pipes, pulsed heat pipes, and flat heat pipes.

### Freeze Purification

When a water solution freezes at a slow rate, the dissolved species and suspended solids stay preferentially in solution. As a result, the ice layer formed can be separated and re-melted to obtain clean water. Embodiments of the present invention provide a system and methods to separate water from a mixture by freezing, where heat pipes act as the heat transfer device.

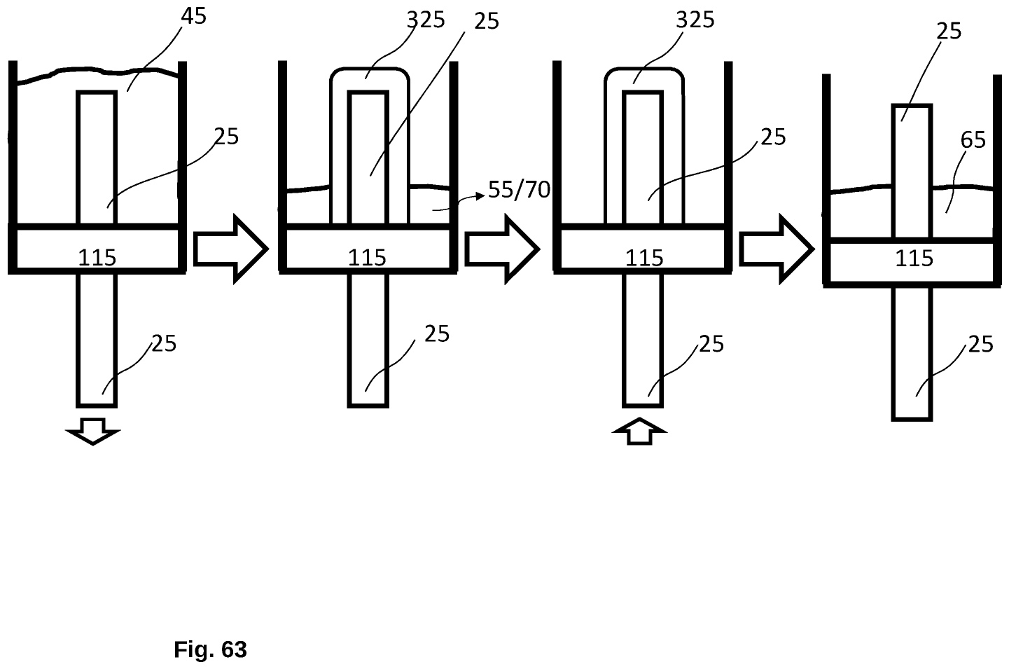

In a first aspect, in reference to FIG. 63, a mixture of water 45 and other chemical species is slowly frozen using heat pipes 25 as the heat transfer device. One end of the heat pipes is in contact with the water mixture 45, and the other end of the heat pipes is in contact with a fluid or surface at temperature below the melting point of water with the solute concentration in the mixture, which is lower than the melting point of pure water. Both ends are separated by a plate 115.

In one aspect, the cold end of the heat pipe is kept cold by means of a vapor-based refrigerator, a thermoelectric refrigerator, the use of ice, and the use of any other fluid, such as cold air.

In another aspect, the water mixture is periodically drained and the ice 325 on the heat pipes is allowed to melt to recover the purified water 65. In another aspect, melting of the purified water is expedited by applying heat to the other end of the heat pipe. In another aspect, the ice is only partially molten to detach it from the heat pipes, and then it is collected as a liquid-solid mixture. In another aspect, the ice is periodically scraped mechanically from the heat pipe. In another aspect, the ice is continuously scraped from the heat pipe.

In another aspect, the hot end of the heat pipes are in close contact or welded to a flat or circular surface where the ice crust is formed. In another aspect, the plate is continuously moved, for example rotated.

In one aspect, the aqueous solution is wastewater. In another aspect, it is sea water. In another aspect, it is the mixture resulting from fermentation of biomass.

### Using Heat Pipes to Preheat Water for Ultrafiltration and Nanofiltration

Ultrafiltration (UF) and Nanofiltration (NF) membrane filtration processes are proven water hardness reduction processes (see, e.g., Izadpaneh/Javidnia, Water 2012, 4, 283-294).

Both membrane filtration processes are most efficient removing water hardness ions (such as Ca++ and S04-) at slightly elevated temperatures, between 35-40° C.

This invention can use heat pipes to capture heat from a single source or from a plurality of sources, and transfer the heat to warm the liquid influent stream to the optimal membrane process temperature (approximately 15° C. to 80° C. depending on the membrane temperature specifications),

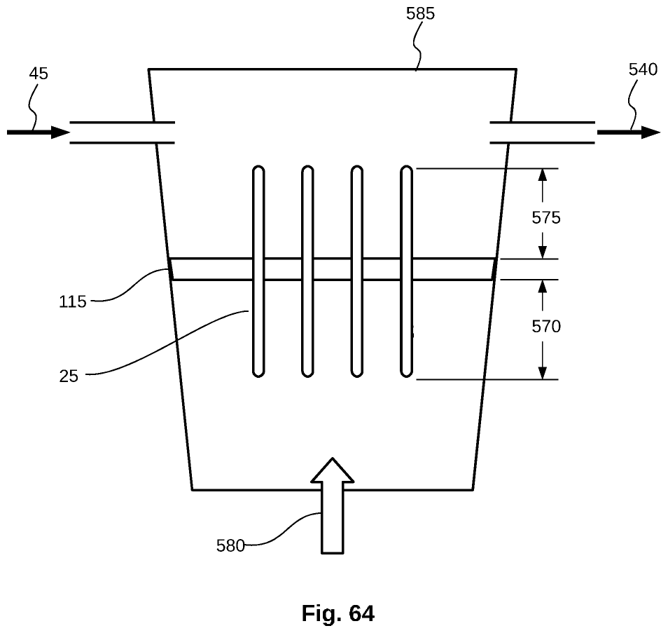

Referring to FIG. 64, in some embodiments, one or a plurality of heat pipes 25 has a fraction (hot section) of their length 570 exposed to a heat source and a different fraction (cold section) of their length 575 exposed to the colder feedwater 45 stream. Heat is transferred from the heat source 580 (hot section) to the feedwater 45 stream (cold section) to create a preheated feedwater stream 540 to be fed to a nanofiltration or ultrafiltration system.

The heat pipes are mounted on a perforated plate 115 which is part of an enclosure 585. The heat pipes 25 can be mounted in any orientation- vertical, horizontal, or any other angle. The lengths of the heat pipes can vary. The length of the heat pipes in the hot section can vary. The lengths of the heat pipes in the cold section can vary. The mounting orientation of the heat pipes in the hot section can be the same or different from the mounting orientation of the heat pipes in the cold section. The enclosure can be closed and pressurized or open to the atmosphere on the hot section or the cold section or both. The cold section can be adjacent to the hot section or the two sections can be separate.

Heat can be provided from a single or plurality of sources—hot fluids or gases, steam, hot water, flue gas, exhaust gases, thermal fluids, geothermal fluids or gases, molten salts, electrical heat sources, solar heating via radiation or photovoltaic capture or a combination of these sources.

### Using Heat Pipes to Preheat Water for Reverse Osmosis (RO) Systems

The Reverse Osmosis membrane filtration process is a proven water hardness reduction process (see, e.g., Izadpaneh/Javidnia, Water 2012. 4, 283-294).

The RO membrane filtration process is most efficient removing water hardness ions (such as Ca+ and S04−) at slightly elevated temperatures, between 35-40° C. This invention can use heat pipes to capture heat from a single source or from a plurality of sources, and transfer the heat to warm the liquid feedwater stream to the optimal membrane process temperature (approximately 15° C. to 80° C., depending on the membrane temperature specifications).

Again, referring to FIG. 64, in some embodiments, one or a plurality of heat pipes 25 has a fraction (hot section) of their length 570 exposed to a heat source and a different fraction (cold section) of their length 575 exposed to the colder feedwater 45 stream. Heat is transferred from the heat source 580 (hot section) to the feedwater 45 stream (cold section) to create a preheated feedwater stream 540 to be fed to a reverse osmosis system.

The heat pipes are mounted on a perforated plate 115 which is part of an enclosure 585. The heat pipes 25 can be mounted in any orientation—vertical, horizontal, or any other angle The lengths of the heat pipes can vary. The length of the heat pipes in the hot section 570 can vary. The lengths of the heat pipes in the cold section 575 can vary. The mounting orientation of the heat pipes in the hot section can be the same or different from the mounting orientation of the heat pipes in the cold section. The cold section can be adjacent to the hot section or the two sections can be separate.

Heat can be provided from a single or plurality of sources—hot fluids or gases, steam, hot water, flue gas, exhaust gases, thermal fluids, geothermal fluids and/or gases, molten salts, electrical heat sources, solar heating via radiation or photovoltaic capture.

### Loop Heat Pipes for Flue-Gas Type Water Purification or Feedwater Concentration System

It is well-known that flue gas, such as that produced by combustion of fossil fuels or by industrial exothermic reactions, contains significant heat energy. Flue gas temperatures can range from 20° C. or lower to 300° C. or higher. It is often desirable to lower the flue gas temperature. A typical scheme to cool the flue gas is to insert a length of metal tubing into the flue gas duct, where the flue gas will transfer heat energy through the tubing wall to raise the temperature of the fluid flowing through the tubing. In one aspect of the present invention, loop heat pipes can be used instead of tubing to recover heat from a flue duct. The recovered heat can then be applied elsewhere.

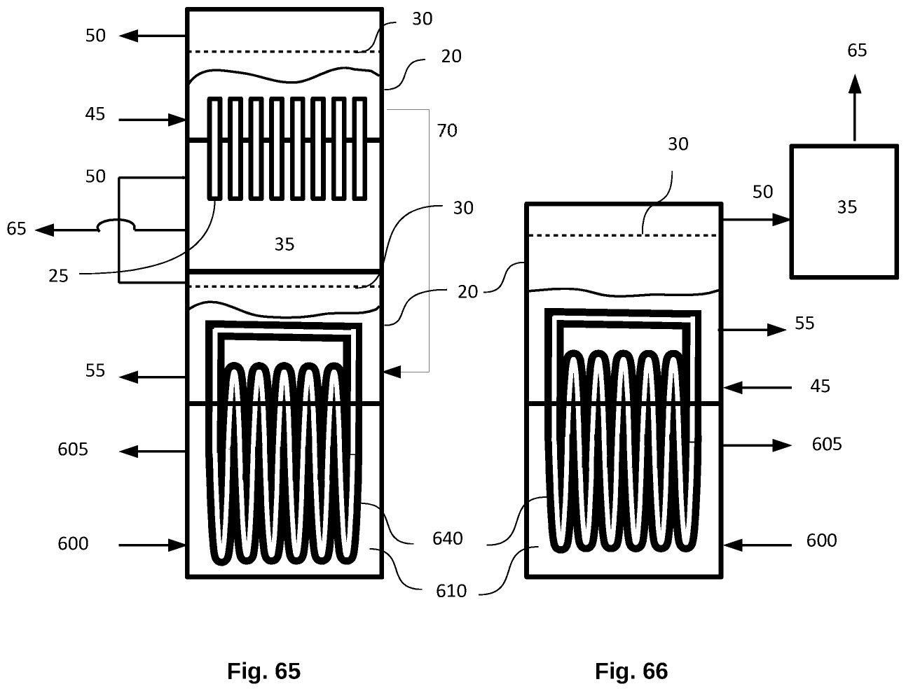

In some embodiments where the recovered heat is used to provide heat energy to a water purification system (as shown in FIG. 65), one or more loop heat pipes 640 have a fraction of their length (hot section) in the flue gas duct 610. Another fraction of the loop heat pipe 640 length (cold section) is inside an evaporation chamber 20 in contact with feedwater 45 as described elsewhere in this invention. The evaporation chamber 20 pressure can be set such that boiling occurs at the temperature of the cold section of the loop heat pipe. The steam 50 produced in the evaporation chamber 20 can be directed to another stage or stages consisting of a condenser chamber 35, heat pipe 25 assembly, and evaporation chamber 20 as described elsewhere in this invention (FIG. 65). In other aspects, other types of heat pipes are used. In another aspect of the invention (FIG. 66), the steam 50 produced in the evaporation chamber 20 can be directed to a demister 30 and condenser chamber 35, or directly to condenser chamber 35, such that the steam condenses to produce purified water 65. In another aspect, the steam from the evaporation chamber 20 (with or without a demister 30) can be used directly for applications such as heating, in chemistry industries or other industrial applications where steam is required.

### Loop Heat Pipes for Geothermal Energy Capture

In one aspect of the present invention, loop heat pipes can be used as heat transfer devices to transfer heat from a geothermal heat source to a location sonic distance away (including the earth surface) such that the recovered heat can be applied to other processes. The efficiency of the loop heat pipe enables more energy to be transferred over a longer distance than conventional geothermal heat capture technologies. Loop heat pipes enable heat transfer with minimal loss over distances ranging from less than 2m to greater than 20 km. In one embodiment, one or more loop heat pipes have a fraction of their length (hot section ) in contact with a geothermal heat source. Another fraction of the loop heat pipe length (cold section) is inside an evaporation chamber in contact with feed water as described elsewhere in this invention. The feedwater can be boiler feedwater to create steam for beneficial use, or feedwater for a water purification system as described elsewhere in this invention. In another embodiment, the cold section of the loop heat pipe can be in a vessel containing thermal oil, such that the geothermal heat is transferred to the thermal oil for storage or for use in other processes requiring heat energy.

### Loop Heat Pipes for Low-Grade, Long Distance Heat Capture for Water Purification or Feedwater Concentration System

In another aspect of the present invention, the system for water purification can be operated from heat energy located some distance away using loop heat pipes. The efficiency of the loop heat pipe enables more energy to be transferred over a longer distance than conventional heat, energy transfer technologies. Loop heat pipes enable heat transfer with minimal loss over distances ranging from less than 2m to greater than 20 km. In one embodiment, one or more loop heat pipes have a fraction of their length (hot section) in contact with a thermal heat source. The heat source can be steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes or other waste heat from industrial or other processes. The hot section can be inside a first chamber, underground or inside a container open to the atmosphere. Another fraction of the loop heat pipe length (cold section) is inside the first evaporation chamber of the water purification system in contact with feedwater as described elsewhere in this invention.

### Heat Pipes in Once-Through Steam Generators

In one aspect of the present invention, heat pipes are used as heat transfer devices in once-through steam generators. In one embodiment, one or more heat pipes have a fraction of their length (hot section) in contact with a heat source. The heat source can be steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes, alcohol burners, and waste heat from industrial or other processes. The hot section can be inside a first chamber, underground or inside a container open to the atmosphere. Another fraction of the heat pipe length (cold section) is inside an evaporation chamber in contact with water. This section can be in any orientation (vertical, horizontal or at an angle). The orientation of heat pipes in the evaporation chamber does not need to be the same of the orientation in the hot zone. If multiple heat pipes are used, they can have different orientations. The cold section can be submerged in a water pool, or water can be sprayed on the cold section, or a film of water can flow through the surface of the cold section. Water from spraying or falling films can be recovered and re-used again for spraying or to form falling films. Heat is transferred from the hot section to the cold section. At the cold section, the heat is transferred to the water resulting in evaporation of water and formation of steam. Water can be fed continuously or at intervals to maintain the water level in the evaporation chamber within specified values. Fluids other than water can be used in the evaporation chamber. In addition to the hot and cold sections, the heat pipes can have one or more intermediate section, for example a section that runs through the walls of the evaporation chamber, or insulated sections that communicate hot and cold zones that are not in direct contact to each other, so heat sources can be used that are far away from the evaporation chamber.

### Heat Pipes in Single-Stage Boilers for Driving Distillation Towers and Heat Pipes in Reboilers

In one aspect of the present invention, heat pipes are used as heat transfer devices in reboilers to supply heat to distillation towers. In one embodiment, one or more heat pipes have a fraction of their length (hot section) in contact with a heat source. The heat source can be steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes, alcohol burners, and waste heat from industrial or other processes. The hot section can be inside a first chamber, underground or inside a container open to the atmosphere. Another fraction of the heat pipe length (cold section) is inside an evaporation chamber in contact with the fluid at the bottom of a distillation tower. In one aspect, the hot section is inside the bottom of the distillation tower. Due to the high efficiency of heat transfer associated with heat pipes, a small column size is less likely to be a limiting factor than in the case of reboilers using conventional heat exchangers. In another aspect, the hot section is in a chamber adjacent to the bottom of the distillation tower with at least two pipes that connect both vessels, one to transfer distillation bottoms to the evaporation chamber, and another to transfer vapor or vapor-liquid mixtures from the evaporation chamber to the distillation column. The cold section can be submerged in a liquid pool of distillation bottoms, or the liquid can be sprayed on the cold section, or a film of liquid can flow through the surface of the cold section. Liquid from spraying or falling films can be recovered and re-used again for spraying or to form falling films. Heat is transferred from the hot section to the cold section of the heat pipes. At the cold section, the heat is transferred to the distillation bottoms liquid, resulting in evaporation. Liquid can be fed continuously or at intervals to maintain liquid level in the evaporation chamber within specified values. In addition to the hot and cold sections, the heat pipes can have one or more intermediate section, for example a section that runs through the walls of the evaporation chamber, or insulated sections that communicate hot and cold zones that are not in direct contact to each other, so heat sources can be used that are far away from the evaporation chamber.

### Heat Pipes for Ammonia Removal Systems

In another aspect of the present invention, the system for water purification can be operated without passing the feedwater through evaporation chambers. The system can include pretreatment, a preheater and a degasser. The function of the degasser can be to separate volatile species from the feedwater. In one aspect, the volatile species can be ammonia, volatile organic compounds or mixtures of those. The pretreatment can include the same steps described in other embodiments of the present invention. The preheater can include heat pipes, heat plates, a heat exchanger or other heat transfer devices. As an example, the preheater can include a vessel with heat pipes, where a fraction of each heat pipe can be in contact with the feedwater and the rest of the heat pipe is outside the vessel, in contact with a heat source including, but not limited to steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes, alcohol burners, other waste heat from industrial or other processes. The degasser can include one or more vessels such as the ones described in other embodiments of the present applications, including packed columns, vessels with plates, empty vessels with showerheads or other gas-liquid contactors. A gas stream is used to separate the species to be removed from the water and to carry them out of the degasser. The gas can be steam, air, an inert gas, CO2, methane, natural, flue gas and mixtures of those. The gas can be injected in one or multiple locations of the degasser chambers.

### Heat Pipes for Juice and Other Concentrators

In some embodiments of the present invention, a system to concentrate a liquid feed can include a pretreatment, a degasser, a preheater, one or multiple evaporation chambers and demisters, one or multiple product condenser chambers, inlets and outlets for liquid and gas streams, a control system and one or more heat recovery units. These components can be used in the same configurations as described in the system for water purification. Other embodiments of the invention do not have to include all of the components listed, and the components to omit will be dictated by the nature of the purification undertaken, including the nature of the feed water, the intended use of the product and the concentrate, and the like. The liquid feed is passed through one or more evaporation chambers to separate a fraction—or the totality—of one or more species as a gas; as a result, the concentration of other species in the feed increases and a fluid product is obtained that can be taken out of the system by gravity, by the action of a pump, by the action of hydrostatic pressure, or by any other suitable process. As an example, fruit juice can be the liquid feed and fruit juice concentrate the product. As another example, milk can be the feed and concentrated milk the product.

### Heat Pipes in Crystallizers

Crystallizers are units in which mass transfer of a solute from the liquid solution to a solid crystalline phase occurs. In some applications, crystallizers separate solutes from brines/concentrates through evaporation of water, so the resulting wet solids can be easily disposed of (with or without further drying) in zero-liquid-discharge (ZLD) applications. Feed water concentrators and evaporators are units that concentrate feedwaters by evaporating a fraction of the solute. Crystallizers, feedwater concentrators and evaporators can operate with several energy sources, including steam re-compression, steam from other units, electrically driven heaters or a conventional heat exchanger.

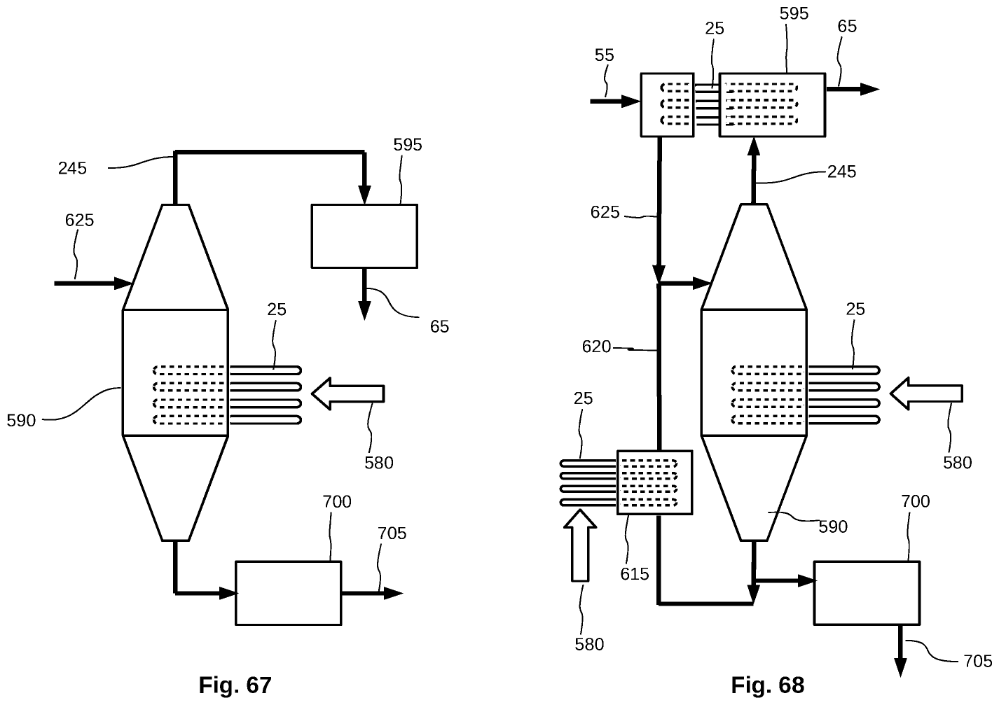

In one embodiment shown in FIG. 67, the heat required to evaporate the solvent and induce crystallization is provided by heat pipes 25 that have a fraction of their length (hot section) in contact with a heat source 580. The heat source 580 can be steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes, alcohol burners, and waste heat from industrial or other processes. The hot section can be inside a first chamber, underground or inside a container open to the atmosphere. Another fraction of the heat pipe length (cold section) is inside the crystallizer 590. The cold section can be placed in a recirculation loop in the crystallizer, or in the main crystallization chamber, or both. Crystallizer feed 625 is fed into the crystallizer where it is further concentrated through evaporation. The steam 245 produced is sent to a condenser 595 which produces purified water 65. The slurry exiting the crystallizer is fed to a filter 700 where more water is removed forming a more easily disposable filter cake 705. In other embodiments, the slurry can be centrifuged, dried in ponds, re-used for other applications or processed in any other conventional way. In other embodiments, the heat recovered in the condenser 595 can be used to preheat the crystallizer feed 625 by means of heat pipes, heat exchangers or other heat transfer devices. In other embodiments, the solution or suspension in the crystallizer can be recirculated through heat exchangers or heat pipes heat exchangers. In other embodiments, baffles and draft tubes can be used to control crystal growth rate and crystal size distribution.

A crystallizer can also be used as a part of a water purification system. In this case the concentrated brine/solution fed to the crystallizer is the final concentrate from the water purification system as described earlier. The output streams of the crystallizer are steam to be converted to purified water and solids. The crystallizer can have heat pipes, a heat exchanger or vapor recompression,

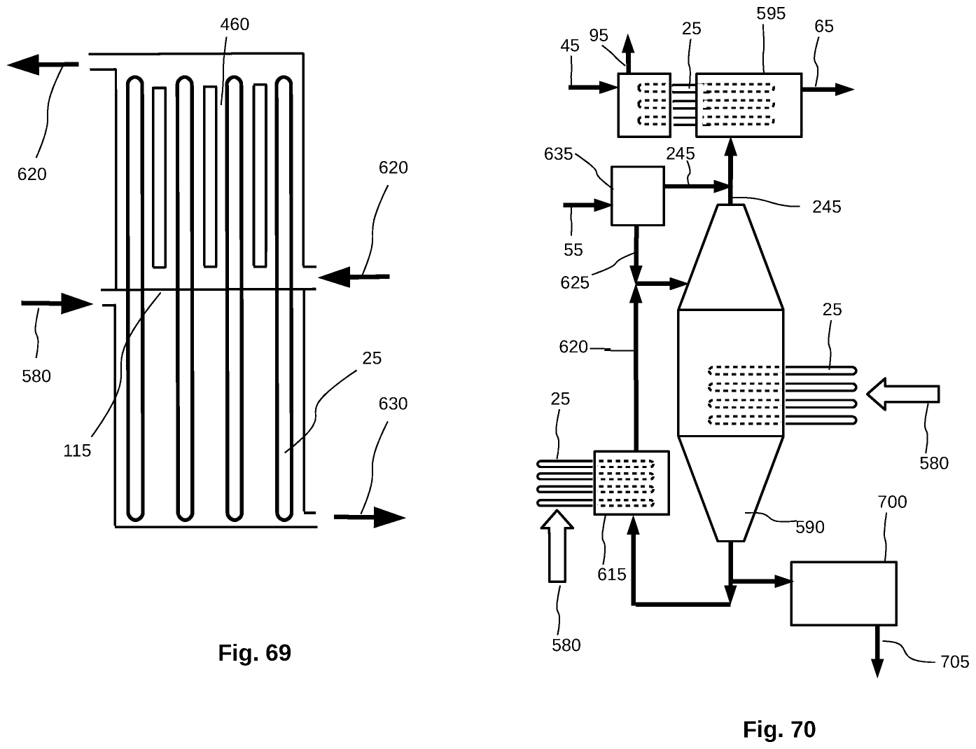

In another embodiment shown in FIG. 68, heat pipes 25 are used in a condenser 595 to recover the heat of vaporization of the steam 245 evolving from the crystallizer 590 to preheat the final concentrate 55 from a water purification system before it enters the crystallizer 590 as crystallizer feed 625. Again, the condensed water 65 can be used as a product. In the embodiment shown, some of the solution or suspension out of the crystallizer 590 is recycled through recirculation loop 620 to the input to the crystallizer 590. Heat pipes can be present in the main body of the crystallizer 590, in a heat pipe heat exchanger 615 in the recirculation loop 620 and in the condenser 595. They can also be present only in some of these locations. The heat source 580 can be any of the ones listed in the description of FIG. 69.

FIG. 69 shows the heat pipe heat exchanger 615 in more detail. The heat pipe heat exchanger 615 has two sections that are separated by a perforated plate 115 and heat pipes 25 that run through the perforated plate 115 in such a way that they fill the orifices in the perforated plate, the gaps are sealed and there is no fluid communication between the two sections. In one section of the heat pipe heat exchanger 615 a heat source 580 gets in contact with the heat pipes 25. The heat source 580 can be any of the ones listed in the description of FIG. 69. The heat pipes 25 transfer heat to the fluid circulating in the other section of the heat pipe heat exchanger 615, which carries some of the solution or suspension out of the crystallizer 590 that is recycled through recirculation loop 620. This section of the heat pipe heat exchanger 615 has sleeves 460 around the heat pipes 25. The sleeves 460 reduce the cross-sectional area for the fluid flow, resulting in a higher linear flow velocity of the fluid, a thinner boundary layer in the fluid, a higher Reynolds number in the fluid, a better heat transfer coefficient from the heat pipes 25 to the fluid, and a lower rate of scale formation on the surface of the heat pipes 25. A typical distance between the outer surface of a heat pipe 25 and the inner surface of the sleeve 460 can be less than 1 mm. In other embodiments, it can be less than 1 cm. In other embodiments, it can be less than 5 cm.

In another embodiment shown in FIG. 70, the final concentrate 55 from a water purification system is fed into a flash chamber 635, where it flashes. The steam 245 generated in the flash chamber 635 is separated from the final concentrate 55. Heat pipes 25 are used in a condenser 595 to recover the heat of vaporization of the steam 245 evolving from the crystallizer 590 and the flash chamber 635, and the heat is used to preheat a feedwater 245. Preheated feedwater 95 is sent to the water purification system. The condensed water 65 can be used as a product. The final concentrate 55 is further concentrated in the flash chamber 635 and exits as the crystallizer feed 625 which can be a solution (in some cases supersaturated) or a suspension. In the embodiment shown, some of the solution or suspension out of the crystallizer 590 is recycled through recirculation loop 620 to the input to the crystallizer 590. Heat pipes can be present in the main body of the crystallizer 590, in a heat pipe heat exchanger 615 in the recirculation loop 620 and in the condenser 595. They can also be present only in some of these locations. The heat source 580 can be any of the ones listed in the description of FIG. 69.

### Membrane Distillation

Heating the feedwater in a membrane distillation system can improve the overall efficiency of the distillation process. In addition, controlling the temperature along the membrane can also improve efficiency by keeping the feedwater at the optimum temperature throughout the system.

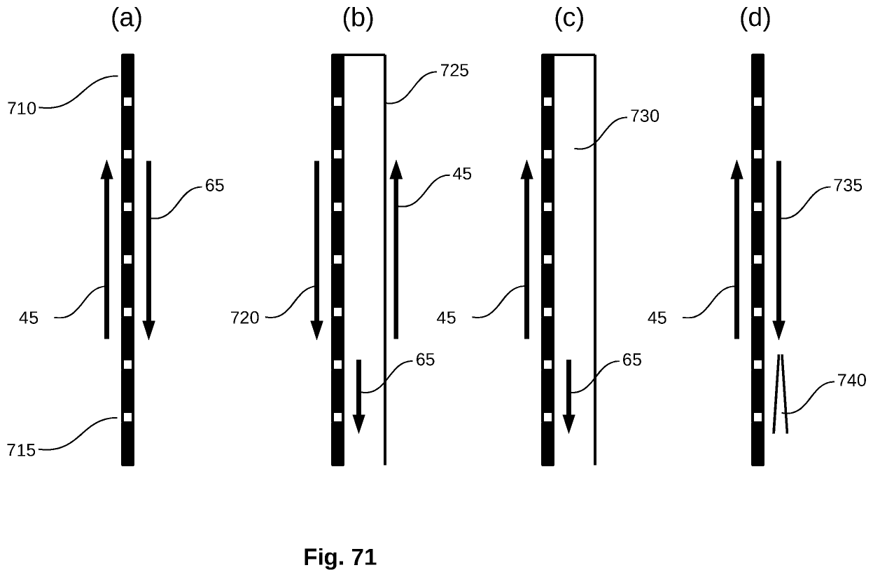

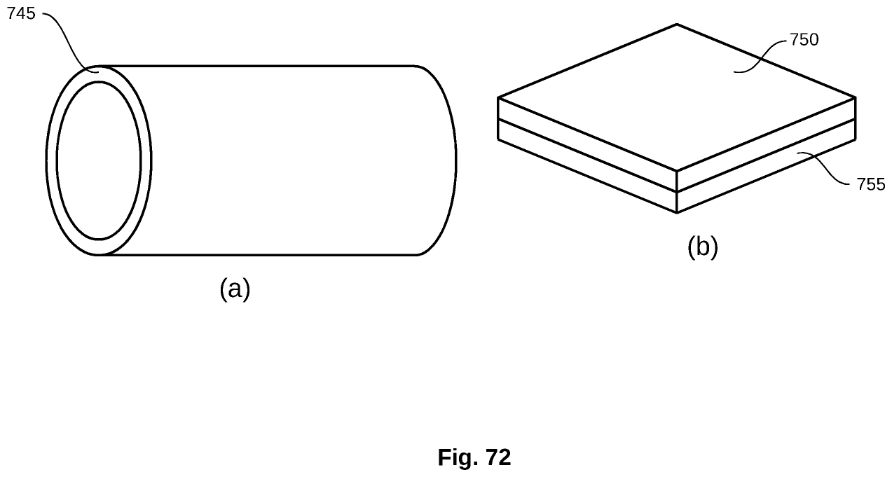

FIG. 71 (Source: “Advances in Membrane Distillation for Water Desalination and Purification Applications”, Camacho et al.) shows a variety of different types of membrane distillation configurations that can be used in embodiments of the invention. Configuration (a) is direct contact membrane distillation, where 590 is the membrane, 715 are the membrane pores, 45 is the feedwater and 654 is the purified water. Configuration (b) is Gor-Tex membrane distillation where 720 is hot feedwater, 45 is cold feedwater, 725 is a cooling plate and 65 is purified water. Configuration (c) is vacuum membrane distillation where 45 is feedwater, 730 is a vacuum environment, and 65 is purified water. Configuration (d) is sweep gas membrane distillation where 45 is feedwater, 735 is a sweep gas and 740 is purified water vapor.

Standard membrane distillation configurations assume that the feedwater is hotter than the purified water. A greater temperature difference yields efficiency improvements.

FIG. 71 shows two types of membrane configurations that can be used in some embodiments of the invention, a hollow fiber (a) and a flat sheet (b). The membrane in the hollow fiber configuration is the cylinder wall 745. The flat sheet configuration has two elements, an active layer 750 and a support layer 755. The flat sheet can also be rolled into a coil for compactness.

Two basic ways of using heat pipes with membrane distillation can be the following:
i) Replacing conventional heat exchangers with a heat pipe heat exchanger for heating of the feedwater.
ii) Using a heat pipe or pipes in rolled membranes to better distribute heated liquid.

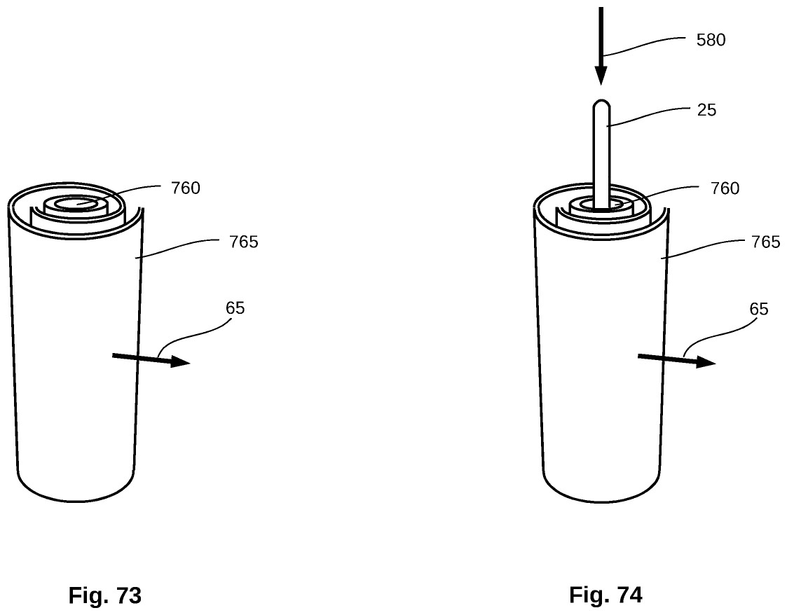

FIG. 73 shows a typical membrane coil 765 with a feedwater tube 760 and purified water 65 stream out of the coil that can be used in some embodiments of the invention. FIG. 74 shows this type of arrangement where one or more heat pipes 25 are placed in the membrane coil 765 to maintain a relatively constant temperature along the axis of the coil. FIG. 74 shows a similar arrangement except with a heat pipe 25 inserted into the feed water tube 760. Heat 580 is applied to the heat pipe 25 so that the heat pipe can raise the temperature of the feed water to improve efficiency of the membrane coil 765.

Heat plates can also be used with membrane distillation systems to maintain a relatively constant temperature across a sheet membrane or to preheat the feedwater. Because heat pipes and heat plates can also be used to remove heat, a heat pipe or pipes, or a heat plate or heat plates could be implemented as the cool plate 725 or to cool the cool plate (see FIG. 71).

The configurations described above can be used with either single membrane systems or with multi-effect membrane distillation systems. Heat pipes, pulsed heat pipes, heat plates, heat spreaders, thermosiphons, and heat rods are all candidates for these embodiments.

The heat for the heat pipes and heat plates can come from a variety of sources, including steam, electricity, natural gas burners, oil burners, coal burners, chemicals, chemical reactions, solar energy, nuclear energy, geothermal energy, molten salts, thermal fluids, biomasses, composting, fermentation, microwaves, flue gases, solid wastes or other waste heat from industrial or other processes. Cooling can come from forced air, water evaporation, refrigeration and other sources.

### Heat Pipes Used in Electrodialysis Systems

Electrodialysis efficiency improves with an increase in the feedwater temperature. High temperature electrodialysis is well-researched area. Electrodialysis can be done with a single set of cells or with multiple cell groups. Electrodialysis can also be done in a process where a gas is injected into the cells to help prevent scale buildup on the membranes (see for example U.S. Pat. No. 4,311,575).

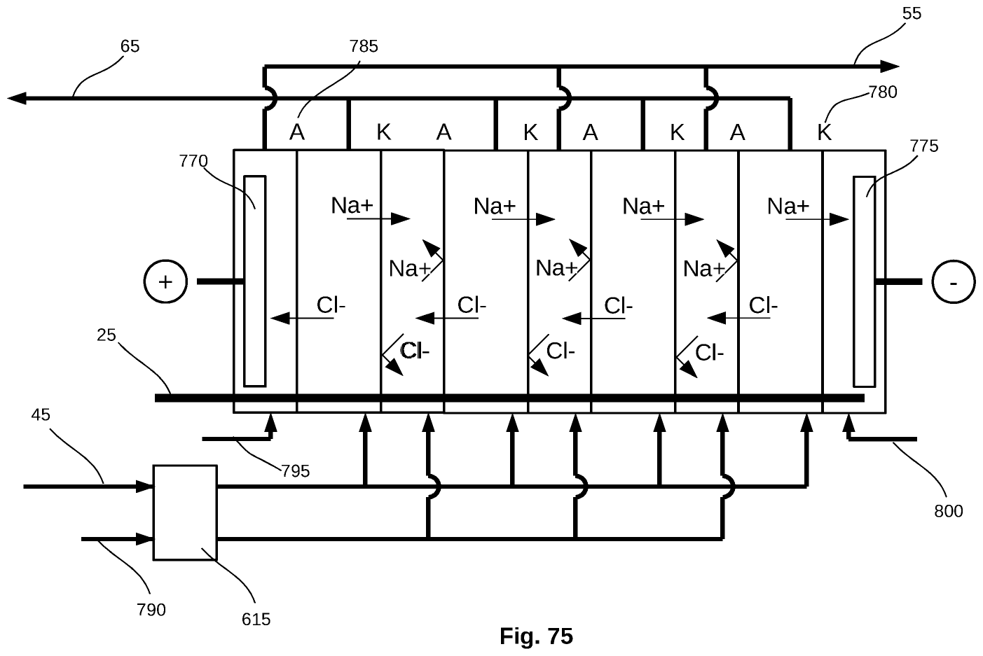

In some embodiments of the invention, heat pipes and heat plates can be used in various ways in electrodialysis systems. FIG. 75 shows an electrodialysis including an anode 770, a cathode 775, purified water 65, final concentrate 55, anolyte 795, catholyte 800, feedwater 45, concentrate solution 790, anion exchange membrane 785 and cation exchange membrane 780. In this embodiment, a heat pipe (or heat plate) heat exchanger 615 has replaced a standard heat exchanger for heating the solutions 45 and 790 prior to their injection into the cells. Another embodiment, also shown in FIG. 75, includes heat plates (or heat pipes) inside the cells to maintain a relatively constant temperature throughout the cell to improve overall efficiency. These embodiments can be used together or separately.

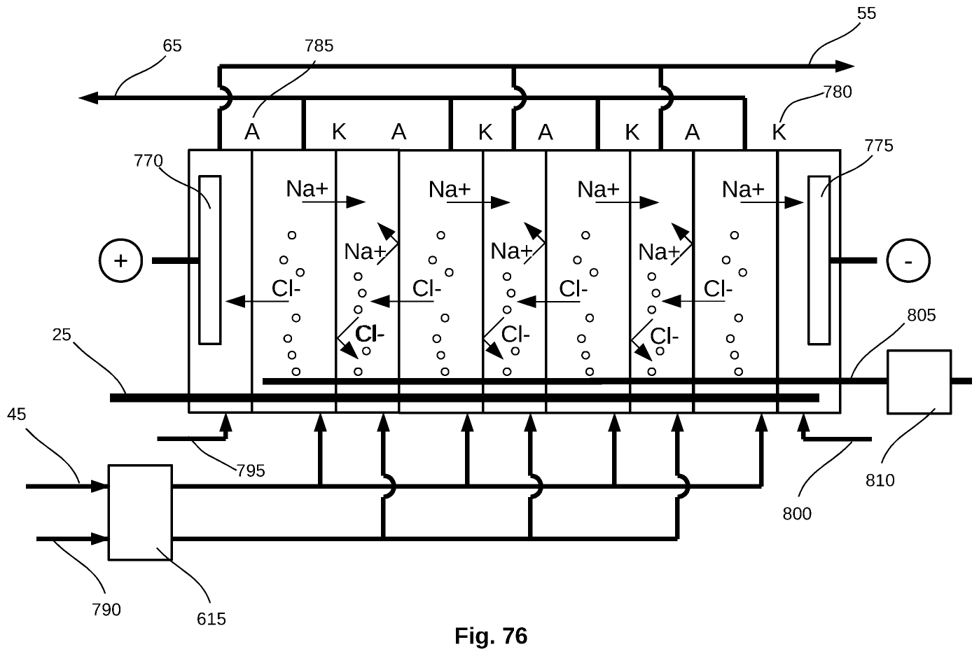

FIG. 76 shows another embodiment of an electrodialysis system, one in which gas 805 is injected into the cells to reduce scale formation. In this embodiment a heat pipe (or heat plate) heat exchanger 615 is used to heat the gas 805 prior to its injection into the cells. Heat plates (or heat pipes) 25 are also shown inside the cells to maintain a relative constant temperature throughout the cells. Again, the heat pipe heat exchanger 615 and the heat plates 25 can be used together in one embodiment or either could be used separately in other embodiments. Heat pipes, heat plates, heat spreaders, or heat rods are all candidates for these embodiments.

### Heat Plates in Dewvaporation

The process of dewvaporation uses air as a carrier gas that transfers water vapor from ascending evaporative channels to adjacent, descending dew-forming channels. Heat flowing through the barrier allows the evaporative energy requirement to be fully satisfied by the heat released by condensation on the dew forming side. A small pressure difference is held so that the condensing cooler air is kept on the cool side.

This Invention uses heat plates in dewvaporation systems. Details of dewvaporation systems can be found, for example, in U.S. Pat. No. 8,444,829 B2 “Systems, Processes and Methodologies for Producing Clean Water,” which is hereby incorporated by reference.

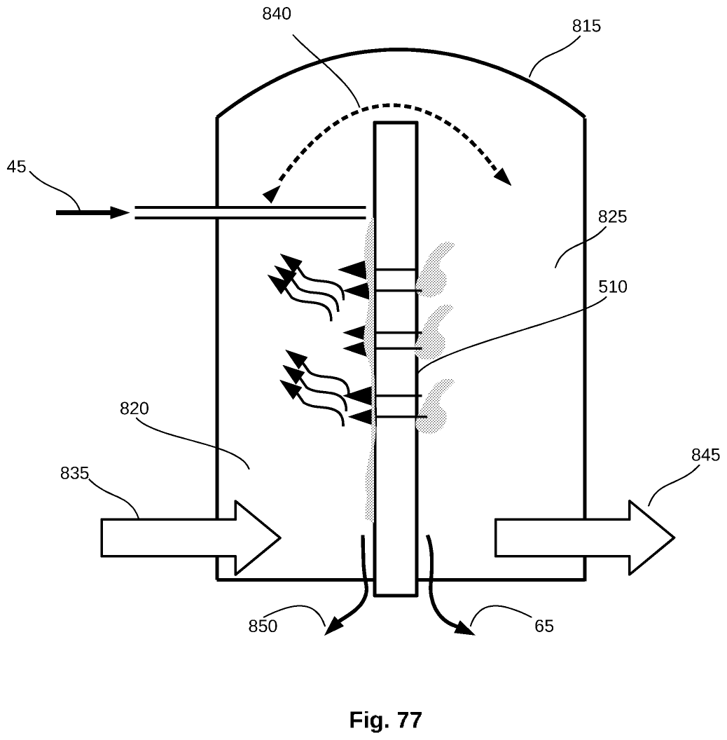

FIG. 77 shows one possible embodiment of the invention. The dewvaporation enclosure 815 is divided into an evaporation section 820 and a condensing section 825 by a heat plate 510. The heat plate is composed of a single or a plurality of heat transfer elements of sealed metallic construction. The metallic enclosure can be plated or unplated, as corrosion resistance requires. Each element is sealed to contain a partial vacuum, a single or a plurality of wick structures, and a working fluid. The heat plate can be mounted vertically or at an alternate angle.

Hot air 835 or a mixture of air and other gasses or gaseous mixtures enter the enclosure 815. The inlet air stream can be heated by steam, electricity, natural gas burners, oil burners, coal burners, alcohol burners, chemicals, chemical reactions, solar energy, nuclear energy, geothermal energy, molten salts, thermal fluids, biomasses, composting, fermentation, microwaves, flue gases, solid wastes or other waste heat from industrial or other processes.

As the hot air stream rises, it contacts the feedwater 45 falling film on the evaporation face of the heat plate 510. The feedwater can also be heated by one or more of the same sources listed above. The feedwater temperature can vary between 20° C. and 99° C. Some fraction of the falling film water will be evaporated by the hot air stream, and the resultant humidified air stream 840 will be carried over the top of the heat plate/heat transfer wall 510. As the humidified air stream flows down on the condensation side 825 of the heat plate, some fraction of the water vapor will condense on the condensation face of the heat plate. The enthalpy or heat of condensation will be transferred through the heat plate to the evaporation side 820 of the heat plate 510. The energy transfer mechanism in the heat plate is similar to the energy transfer mechanism in a heat pipe. The energy is then available for evaporation of the feedwater falling film. The cooler air or gas mixture 845 can be reheated and returned to the evaporative side of the enclosure, transferred to an adjacent enclosure, or released to ambient surroundings. The concentrate stream 850 and the purified water 65 are collected from their respective sides of the mounting plate.

### Heat Pipes in DewVaporation

Some embodiments of this invention use heat pipes mounted in a mounting plate providing a heat transfer wall having an evaporation side and a dew-formation side in dewvaporation systems. Details of dewvaporation systems can be found, for example, in U.S. Pat. No. 8,444,829 B2 “Systems, Processes and Methodologies for Producing Clean Water,” which is hereby incorporated by reference.

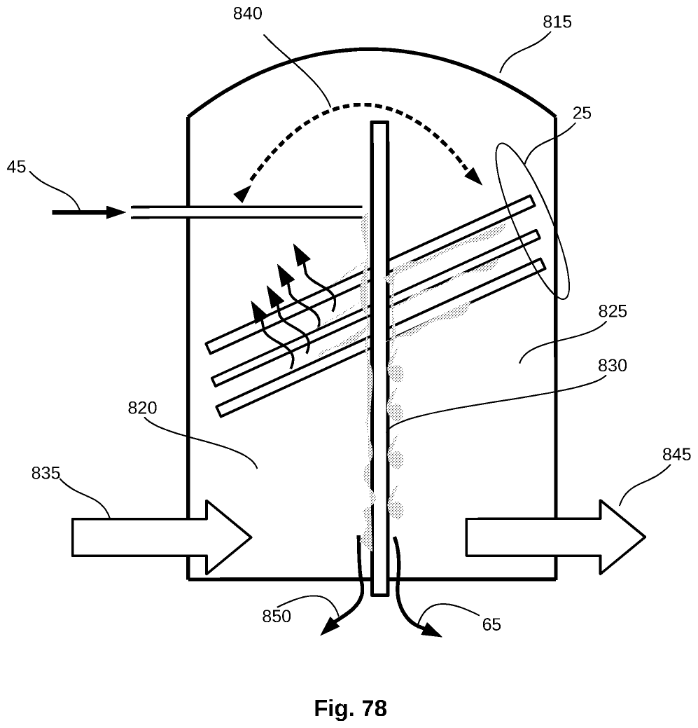

FIG. 78 shows one possible embodiment. The dewvaporation enclosure 815 is divided into an evaporation section 820 and a condensing section 825 by a mounting plate 830. The mounting plate can be fabricated from metallic, non-metallic, or a combination of materials. Heat pipes 25 are mounted in the mounting plate at an angle that can vary from horizontal to vertical. The lengths of the heat pipes can vary. The lengths of the heat pipes in the evaporation section can vary. The lengths of the heat pipes in the condensation section can vary. The diameters of the heat pipes can be equal or the diameters can vary. The mounting plate is formed to direct the falling water film to cover the surface of the heat pipes in the evaporation section.

Hot air 835 or a mixture of air and other gasses or gaseous mixtures enter the enclosure 815. The inlet air stream can be heated by steam, electricity, natural gas burners, oil burners, coal burners, alcohol burners, chemicals, chemical reactions, solar energy, nuclear energy, geothermal energy, molten salts, thermal fluids, biomasses, composting, fermentation, microwaves, flue gases, solid wastes or other waste heat from industrial or other processes.

As the hot air stream rises, it contacts the feedwater falling film on the heat pipe surfaces on the evaporation side of the mounting plate 830. The feedwater 45 can also be heated by one or more of the same sources listed above. The feedwater temperature can vary between 20° C. and 99° C. Some fraction of the falling film water will be evaporated by the rising hot air stream, and the resultant humidified air stream 840 will be carried over the top of the mounting plate 830. As the humidified air stream 840 flows down on the condensation side 825 of the mounting plate, some fraction of the water vapor will condense on the condensation face of the mounting plate, and some fraction will condense on the condensation side of the heat pipes. The enthalpy or heat of condensation will be transferred primarily through the heat pipes to the evaporation side 820 of the heat pipes 25. The energy from condensation is then available for evaporation of the feedwater falling film. The cooler air or gas mixture 845 can be reheated and returned to the evaporative side of the enclosure, transferred to an adjacent enclosure, or released to ambient surroundings. The concentrate stream 850 and the purified water 65 are collected from their respective sides of the mounting plate.

The invention illustratively described herein suitably can be practiced in the absence of any element or elements, limitation or limitations which are not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the disclosure.

Those skilled in the art recognize that the aspects and embodiments of the invention set forth herein can be practiced separate from each other or in conjunction with each other. Therefore, combinations of separate embodiments are within the scope of the invention as disclosed herein.

All patents and publications are herein incorporated by reference to the same extent as if each individual publication was specifically and individually indicated to be incorporated by reference.

### LISTING OF REFERENCE SIGNS IN DRAWINGS

10 Preheater
15 Degasser
20 Chamber, Evaporation
25 Heat Pipe or Thermosiphon
30 Demister, General
35 Condenser
40 Vessel, Energy Input
45 Feedwater
50 Steam, from Evaporation Chamber
55 Concentrate, final
60 Energy Input to System
65 Water, Purified
70 Concentrate, Intermediate
75 Feedwater, Degassed
80 Feedwater, Pretreated
85 Solids
90 Stage
95 Feedwater, Preheated
100 Gas Stream to Degasser
105 Waste, Degasser
110 Device, Heat Transfer
115 Plate, Perforated
120 Solution, Clean-in-Place
125 Pump
130 Valve
135 Path, Tortuous
140 Steam Generator
145 Condensate from Energy Input Vessel
150 Steam from Steam Generator
155 Inlet, Feedwater
160 Mounting Holes for Heat Pipes
165 Tube, Downcomer
170 Outer Shell
175 Oil or Gas Burner
180 Steam Injector
185 Preheated Feedwater Outlet
190 Steam Capture Chamber (FIG. 9)
195 Degasser Particle, Long
200 Degasser Particle, Medium
205 Degasser Particle, Small
210 Degasser Spray Nozzle
215 Discharge Tube for Intermediate Concentrate
220 Demister Waste
225 Demister, Pad
230 Grooves
235 Droplets, Demister
240 Baffle
245 Steam, Contaminated
250 Top, Evaporation Chamber
255 Demister, Cyclone
260 Inlet, Cyclone Demister
265 Cyclone Area
270 Outlet, Demisted Clean Steam
275 Outlet, Demister Waste
280 Heat Flow
285 Inlet, Condenser
290 Outlet, Purified Water
295 Steam Spray
300 Scale
305 Thin Layer (conditioning)
310 Device for scale removal (aka robot cleaner)
315 Electrode
320 Electrical insulator
325 Purified Ice
330 Outlet, Intermediate Concentrate
335 Seal, Compliant
340 Inlet, Intermediate Concentrate
345 Sprayer, Intermediate Concentrate
350 Tube, Sealed, Heat Pipe
355 Fluid, Working, Heat Pipe
360 Wick, Capillary
365 Heat Source, Heat Pipe
370 Vibrational Energy
375 Coating, Hydrophobic
380 Foil, Thin
385 Screen, Metal
390 Heater, Resistive
395 Sleeve, Insulating
400 Power Supply
405 Heat, Waste
410 Fluid, Thermal
415 Ejector, Steam
420 Steam, Motive
425 Steam, From Ejector
430 Mechanical Vapor Compressor
435 Condensate, To Steam Generator
440 Angle, Tilt
445 Retainer
450 Insert, Threaded
455 Sleeve, Compliant, Insulating
460 Sleeve
465 Coating
470 Sleeve, Metal
475 Material, Joining
480 Deformation
485 Material, Compliant
490 Plate, Retaining
495 Plate, Mounting
500 Fastener
505 Plate, Separator
510 Heat Plate
515 Heat Exchanger
520 NF or UF System
525 Concentrate Reject Stream
530 Drain, Waste Concentrate
535 Feedwater, NF/UF Processed
540 Feedwater, NF/UF Preheated
545 Water, Purified, Concentration System
550 Valve, Temperature Bypass Control
555 Probe, Temperature
560 Particles, Cleaning
565 Cylinder, Perforated
570 Length, Exposed to Heat
575 Length, Exposed to Feedwater
580 Heat Source, General
585 Enclosure, Heating
590 Crystallizer
595 Condenser, General
600 Inlet, Flue Gas
605 Outlet, Flue Gas
610 Duct, Flue Gas
615 Heat Exchanger, Heat Pipe
620 Loop, Recirculating
625 Outlet, Heat Input Section
630 chamber, Flash
635 Heat Pipe, Loop type
700 Filter
705 Solids
710 Membrane
715 Pore
720 Feed, MD Preheated
725 Plate, Cooling
730 Vacuum
735 Gas, Sweeping
740 Water Vapor, Purified
745 Wall, Membrane
750 Layer, Active
755 Layer, Support
760 Tube, Feedwater
765 Coil, Membrane
770 Anode
775 Cathode
780 Membrane, Cation Exchange, K
785 Membrane, Anion Exchange, A
790 Concentrate, Electrodialysis
795 Anolyte
800 Catholyte
805 Gas, Injection, ED
810 Heater, Gas, Injection, ED
815 Enclosure, Evaporator, Dewvaporization
820 Section, Evaporator, Dewvaporization
825 Section, Condensor, Dewvaporization
830 Plate, Mounting, Dewvaporization
835 Air, Hot
840 Air, Humidified
845 Air, Cooled
850 Concentrate, Dewvaporization
855 Water, Filtered and De-oiled
860 Pump, Line Booster
865 Vessel, Mixer-Settler
870 Pump, Metering
875 Tank, Caustic
880 Valve, Variable
885 Slurry, Mg(OH)2
890 Cake, Filter, First
895 Mixer, Static
900 Tank CO2
905 Cake, Filter, Second
910 Water, Descaled

What is claimed is:

1. A water purification and desalination system comprising a plurality of fluid-process components, heat-transfer components, in at least one stage, and a control system, wherein:
the fluid-process components of the at least one stage define a fluid-process pathway of fluid flow from a water inlet, or inlets, to at least one outlet for at least one product and at least one product for at least one waste, and wherein each component along the fluid-process pathway is in fluid communication with at least one adjacent fluid-process component, and wherein the fluid-process components comprise, in order of fluid flow: a water inlet, an evaporation chamber, a purified water condenser chamber, and said outlets;
such that, in operation, the heat transfer components provide distillation energy;
wherein the heat transfer components comprise at least one of: heat pipes, heat plates, heat spreaders, loop heat pipes, or pulsed heal pipes, or a combination of these devices, and wherein the heat transfer components define a heat recovery mechanism; and
wherein the system further comprises at least one additional feature selected from (a) a process variation; (b) a hardware configuration in a stage; (c) an adaptation for scale prevention, cleaning or maintenance; (d) an adjunct purification scheme; and (e) any combination thereof.

2. The system of claim 1, wherein the process variation is selected from the group consisting of: application of vacuum, steam recompression, product water feedback, single stage core, vapor compression evaporation, and any combination thereof.

3. The system of claim 1, wherein the hardware configuration is in at least one stage and wherein the configuration is selected from the group consisting of: water spray, loop heat pipes, horizontal orientation, orientation at an angle between horizontal and vertical or along an axis that is distinct from horizontal and vertical axes, heat pipes of unequal heights, heat pipes of unequal placement in at least one chamber of the stage, steam jet variations, heat pipe mounting scheme, heat pipes configured as plates, heat plates as chamber walls, and any combination thereof.
or maintenance is selected from the group consisting of: softening by ultrafiltration or nanofiltration, softening by ion exchange, softening by precipitation, removal from service of one stage, chemical treatment, double degassers, thermal shock, robot cleaning, coatings, electrical bias on heat pipes, and any combination thereof.

5. The system of claim 1, wherein the adjunct purification scheme is selected from the group consisting of multiple-effect distillation (MED), multiple-stage flash distillation (MSF), freezing, membrane distillation, reverse osmosis, forward osmosis, and any combination thereof.

6. The system of claim 1, comprising at least two additional features.

7. The system of claim 6, wherein the at least two additional features are selected from the same group.

8. The system of claim 6, wherein the at least two additional features are selected from different groups.

9. The system of claim 6, comprising at least one additional feature from each group.
